(19) United States
(12) Patent Application Publication
(10) Pub. No.: US 2026/0094155 A1
(43) Pub. Date: Apr. 2, 2026

(54) MULTI-PARTY COMPUTATION FOR SECURE DIGITAL ASSET MANAGEMENT

(71) Applicant: Block, Inc., Oakland, CA (US)

(72) Inventors: Jurvis Si Jun Tan, Los Angeles, CA (US); Wilmer Paulino, Los Angeles, CA (US); Jonathan Pollack, Walnut Creek, CA (US); Jesse Posner, Fairfax, CA (US); Jordan Mecom, San Francisco, CA (US); Clayton Douglas Garrett, Atlanta, GA (US)

(21) Appl. No.: 19/171,934

(22) Filed: Apr. 7, 2025

Related U.S. Application Data
(60) Provisional application No. 63/702,610, filed on Oct. 2, 2024.

(51) Int. Cl. G06Q 20/40; G06Q 20/38; H04L 9/08; H04L 9/32

(52) U.S. Cl. CPC G06Q 20/401; G06Q 20/3825; G06Q 20/3829; H04L 9/0825; H04L 9/085; H04L 9/3247

(57) ABSTRACT

Systems and methods are disclosed for security through multi-party computation (MPC). In some examples, a system generates, at a first device and using a first private key share (of a plurality of private key shares). The plurality of private key shares each correspond to different devices. The system receives, from one or more additional devices, one or more additional partial signatures that are generated using one or more additional private key shares (of the plurality of private key shares). The system identifies that a total amount of partial signatures associated with the transaction is meets or exceeds a minimum threshold amount of partial signatures. The system aggregates the first partial signature and the one or more additional partial signatures to generate a signature, and facilitates processing of a transaction using the signature and a distributed ledger.

### CROSS-REFERENCE TO RELATED APPLICATIONS

This application claims the benefit of U.S. Provisional Application No. 63/702,610, filed Oct. 2, 2024 and titled “Multi-Party Computation for Digital Asset Management,” which is hereby incorporated by reference in its entirety and for all purposes.

### TECHNICAL FIELD

With the advent of digital assets, technologies, such as custodians or exchanges, exist making it easy to deploy with user needing only a method of authentication, but locking of account potentially means losing access to underlying coins/assets. Another approach is self-custody (e.g., cold wallets) where the users themselves hold and protect their asset private keys, on their mobile device or browser extension, or in a dedicated hardware. This provides full control over keys, but impacts both usability (e.g., memorizing mnemonics) and security (e.g., with storing the keys on vulnerable customer devices or in cloud storage or paper). Finally, the fact that the user sees a mnemonic and handles it makes the risk of social engineering attacks a real one.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features. Moreover, multiple instances of the same part are designated by a common prefix, in some cases separated from the instance number by a dash and/or parentheses. The drawings are not to scale.

FIG. 1 is a block diagram illustrating a process for distributed key generation (DKG) of a public key and multiple private key shares of a private key through a multi-round interactive protocol that includes communications between multiple devices, in accordance with some examples;

FIG. 2 is a block diagram illustrating a process for partial signature generation in which multiple devices each use one of the private key shares to generate a partial signature, thus generating multiple partial signatures that are combined into a signature via a process for partial signature aggregation, in accordance with some examples;

FIG. 3 is a conceptual diagram illustrating a process for approving a transaction based on communications (e.g., with partial signatures) among multiple devices, in accordance with some examples;

FIG. 4 is a conceptual diagram illustrating an asset configuration in which a first quantity of an asset has active vault status (and is thus not transferrable) and a second quantity of the asset has an inactive vault status (and is thus transferrable and used for a transfer, in accordance with some examples;

FIG. 5A is a conceptual diagram illustrating a process for initiating emergency wallet recovery, in accordance with some examples;

FIG. 5B is a conceptual diagram illustrating a 2-of-2 where a server and a mobile device (with mobile application thereon and/or associated cloud storage) each hold a respective private key, and a process for initiating emergency wallet recovery, in accordance with some examples;

FIG. 6 is a conceptual diagram multiple spending paths implemented across multiple devices, including a normal spending path and a unilateral spending path, in accordance with some examples;

FIG. 7 is a swim lane diagram illustrating a process for generating keys using distributed key generation (DKG), in accordance with some examples;

FIG. 8 is a swim lane diagram illustrating a process for generating keys using distributed key generation (DKG), with additional features relative to the process of FIG. 7, in accordance with some examples;

FIG. 9 is a swim lane diagram illustrating a process for refreshing keys using distributed key generation (DKG), in accordance with some examples;

FIG. 10 is a swim lane diagram illustrating a process for refreshing keys using distributed key generation (DKG) with additional features relative to the process of FIG. 9, in accordance with some examples;

FIG. 11 is a table illustrating backup data being stored at different locations (e.g., different devices), in accordance with some examples;

FIG. 12 is a table illustrating delays in recovery for restoration and/or recovery functionality in different scenarios, in accordance with some examples;

FIG. 13 is a swim lane diagram illustrating a process for a hashed Diffie-Hellman oblivious pseudorandom function (OPRF), in accordance with some examples;

FIG. 14 is a swim lane diagram illustrating a process for PIN Authentication Key (PAK) registration, in accordance with some examples;

FIG. 15 is a swim lane diagram illustrating a process for using PIN Authentication Key (PAK) to perform a privileged action, in accordance with some examples;

FIG. 16 is a block diagram illustrating a process for reclaiming assets, in accordance with some examples;

FIG. 17 is a table illustrating a comparison between different distributed key generation (DKG) protocols, in accordance with some examples;

FIG. 18 is a flow diagram illustrating a process for key tweaking, in accordance with some examples;

FIG. 19 is a swim lane diagram illustrating a process for two-hash Diffie-Hellman Oblivious Pseudorandom Function (OPRF) (2HasDH), in accordance with some examples;

FIG. 20 is a swim lane diagram illustrating a process for a portable blind cloud storage register and give procedure, in accordance with some examples;

FIG. 21 is a swim lane diagram illustrating a process for a portable blind cloud storage take procedure, in accordance with some examples;

FIG. 22 is a flow diagram illustrating a process for multiparty computation (MPC), in accordance with some examples;

FIG. 23 is a flow diagram illustrating a process for improving security through multiparty computation (MPC), in accordance with some examples;

FIG. 24 is a flow diagram illustrating a process for asset recovery, in accordance with some examples;

FIG. 25 is a flow diagram illustrating a process for asset recovery, in accordance with some examples;

FIG. 26 is a flow diagram illustrating a process for improving privacy through blinded computations, in accordance with some examples;

FIG. 27 is a flow diagram illustrating a process for improving security through key share rotation, in accordance with some examples;

FIG. 28 is a block diagram illustrating an example environment for providing an application and/or for customizing the application for different platforms, in accordance with some examples;

FIG. 29 is a block diagram illustrating an example environment including a service provider system which may be associated with the server(s) of FIG. 28, in accordance with some examples; and

FIG. 30 is a block diagram illustrating a system for performing techniques described herein, in accordance with some examples.

### DETAILED DESCRIPTION

Traditional wallet systems for digital assets (hereinafter “digital asset wallets”) can have security issues, user experience issues, and/or recoverability issues. For instance, traditional digital asset wallets, e.g., hot wallets, that are easier to use are generally insecure and not self-sovereign, potentially allowing a malicious party to access a user's assets without permission, and/or allowing other parties to see what transactions a user is involved in. On the other hand, traditional cryptocurrency wallet systems, e.g., cold wallets, that provide more control to users are often difficult for users to use, discouraging users from using cryptocurrencies entirely. Furthermore, such digital asset wallets that are secure are generally not forgiving, upgradeable, flexible, or reliable, or safe, for instance sometimes having single points of failure resulting in a user losing access to funds if they lose their phone or forget a password, and in some cases not allowing a user to upgrade or replace their devices.

For blockchain technologies and other distributed ledger technologies, one challenge is balancing security with usability. Cryptocurrency can be securely stored using a multi-signature setup with specialized hardware wallets. However, such approaches can hinder usability, as not all users have, use, or understand how to use specialized hardware wallets.

Systems and methods are described herein for providing improved security and privacy for managing cryptocurrencies and other assets (e.g., on par with or better than a specialized hardware wallet) with a mobile device, such as a phone, tablet, wearable device, a laptop, a video game console, a media player device, an extended reality (XR) headset, another type of mobile device, or a combination thereof. This allows at least some of the technical benefits of a specialized hardware wallet to be obtained by users of mobile devices, such as improved security (e.g., safeguarding against both remote and physical threats), privacy (e.g., protecting identity and transaction details even in collaborative custody configurations), and asset availability (e.g., providing wallet recovery mechanisms after loss of devices, cloud accounts, or both) while maintaining the improved usability (e.g., familiar user experience on familiar devices without creating operational security burdens) of mobile devices (compared to specialized hardware wallets).

In some examples, the systems and methods described herein provide for improved key management, for instance using a 2-of-2 multiparty computation (MPC) key share authentication arrangement, a 2-of-3 MPC key share authentication arrangement, an N-of-N MPC key share authentication arrangement, a T-of-N(or K-of-N) key share authentication arrangement, or a combination thereof. In some examples, the systems and methods described herein provide for improved key backups, for instance including mechanisms employed to provide user with their app key and a backup of the server key, ensuring their self-sovereignty. In some examples, the systems and methods described herein provide for improvements to privileged action configuration, for instance protecting certain actions are protected to mitigate the loss of funds if parts of a wallet are compromised. In some examples, the systems and methods described herein provide for improvements to asset recovery and/or access recovery, for instance including multiple processes for recovering the wallet if key material is lost, and processes that mitigate attacks that attempt to exploit recovery mechanisms to gain wallet control. In some examples, the systems and methods described herein provide for improvements to privacy, for instance including blinding mechanisms for maintaining user privacy and wallet privacy even in collaborative custody arrangements.

Traditional single-signature (1-of-1) solutions only require authentication of a single device to transfer or otherwise manage assets. Such systems provide a very simple user experience, but present significant risks due to their reliance on a single point of failure. Users are often required to export mnemonic seed phrases and store them securely—a process that is both cumbersome and fraught with potential for loss or theft. In many cases, users are not even aware of the sensitivity and responsibility they are undertaking.

A two-of-two (2-of-2) multi-party computation (MPC) approach instead relies on authentication from two devices to allow a transfer or other asset management operation to be performed. More generally, an N-of-N MPC approach relies on authentication from N devices to allow a transfer or other asset management operation to be performed. In some examples, a T-of-N MPC approach can be used, relying on authentication from at least T devices out of a total of N possible devices to allow a transfer or other asset management operation to be performed. A T-of-N MPC approach (e.g., a 2-of-3 MPC approach) can be beneficial in that, if a device is lost, has its memory erased, suffers from an error or other fault, or otherwise becomes non-functional or non-responsive for the purposes of an MPC-based authentication, authentication can still be granted so long as the other devices are still functional. Thus, some of the systems and methods described herein use T-of-N MPC-based authentication. However, a T-of-N MPC approach can also introduce complexity, so some of the systems and methods described herein improve N-of-N MPC approaches (e.g., 2-of-2 MPC approaches) to improve security and usability.

Note that T-of-N MPC-based authentication can be referred to as K-of-N MPC based authentication. In some examples, N represents the total number of devices that have key shares, T represents the minimum threshold number of devices from which key shares are needed for successful authentication, and K represents a number of devices from which key shares have been received during an authentication process. For authentication to be successful, T≤K≤N must be true. In an illustrative example, the total number of devices that have key shares (N) may be 6, and the minimum threshold number of devices from which key shares are needed for successful authentication (T) may be 4. In this illustrative example, if the number of devices from which key shares have been received during an authentication process (K) is 4, 5, or 6, then authentication is successful. In this illustrative example, if the number of devices from which key shares have been received during an authentication process (K) is 3 or less, then authentication is unsuccessful. In some examples, the variable X may be used in place of K, to refer to the number of devices from which key shares have been received during an authentication process. In some examples, K may be used to refer to the minimum threshold number of devices from which key shares are needed for successful authentication instead of T.

To these ends, the systems and methods described herein use MPC technologies to provide a distributed key configuration that provides simplicity, control (e.g., self-sovereignty), reliability, flexibility, safety, and upgradability. MPC enables splitting the key between the user (device/application/cloud storage) and server hosted by a wallet provider, to carry out operations by running an advanced cryptographic protocol that generates a signature without ever bringing the keys together. As such, the user's key remains protected even if the key share used to sign transactions is stolen from their device—since a single share of the key is meaningless without the other—and the wallet provider cannot generate a signature without the user since they also only hold one share. Secure multiparty computation (MPC) considers a scenario where a number of distinct, yet connected, computing devices (or parties) wish to carry out a joint computation of some kind. The aim of an MPC protocol is to enable them to carry out the computation in a secure manner, even when some of the parties are corrupted and behave adversarially.

For instance, the systems and methods described herein use distributed key generation (DKG) to generate a public key and a set of private key shares spread across multiple devices. The systems and methods described herein use partial signature generation to generate partial signatures at different devices, and partial signature aggregation with a signing threshold to combine the partial signatures from at least a threshold number of the devices (not necessarily requiring all the devices) to generate a signature to sign for a transaction. The MPC implementations described herein disclose highly secure software wallets that narrow the security gap with hardware wallets, where the software wallet is designed without a single point of failure. The use of MPC allows regular rotation of secrets without moving funds. The use of MPC also allows recovery without moving funds while leveraging mobile device's secure enclave. In addition, the use of MPC also allows a PIN recovery feature that is resistant to brute-force attacks. The use of MPC also allows a more secure solution that single-sig hardware wallet. Further, the solutions allow seamless transition from, a 2-of-2 system to 2-of-3 system, a capability that does not exist in traditional MPC solutions.

The systems and methods described herein provide several wallet recovery techniques and systems as well, particularly in the context of a 2-of-2 system, such as one where a mobile application and a server each hold a private key. The systems and methods described herein can provide one or more of case of use and reliability and flexibility, even if a user loses mobile device(s) (and mobile application executing thereon), forgets password(s), and the like. The systems and methods disclosed herein also address recovery issues in the context of a 2-of-2 system where recovery becomes difficult in the absence of a hardware, such as a hardware wallet. Generally, in the context of a 2-of-3 system, a hardware wallet helps with “contested recovery” scenarios, reducing the likelihood of stalemate situations. In a 2-of-2 system, contested recoveries, or other contested actions like canceling an “un-vault” request, become more vulnerable without a strong second factor, increasing the risk of deadlock. Additionally, in a 2-of-3 system, losing one factor still leaves two remaining keys for recovery. However, in a 2-of-2 system, losing either key (or key backup) can be catastrophic. If the mobile application and its associated cloud data are lost, recovery becomes impossible.

In some examples, the methods and systems apply a PIN Authentication Key (PAK). But, PINs are inherently weak against brute-force attacks and typically insufficient for securing cryptographic secrets. To mitigate this, the methods and systems disclosed herein include an oblivious pseudo-random function (OPRF) protocol, and in the case of a simultaneous loss of both the mobile application and cloud data, the systems and methods described herein can use a combination of a dual OPRF (D-OPRF), Social Recovery, and time-locks.

In case of a Lost App Recovery, when only the mobile application is lost, disclosed methods and systems leverage an OPRF to generate a PAK. The PAK takes the place of the hardware wallet in our existing “Delay & Notify” (D&N) process, which is already used for contested recovery. The server cannot brute-force the PIN without access to the customer's cloud-stored ciphertext.

In case of Lost App and Lost Cloud Recovery, disclosed methods and systems utilize a D-OPRF system between the server and a trusted contact. This D-OPRF may decrypt a pre-signed transaction (PST), which can spend the wallet's Bitcoin to the current 2-of-2 setup. A time-locked condition may ensure that after a delay (e.g. 7 days), the funds can also be spent using the PIN-based key, ensuring recoverability. A separate emergency access kit (EAK) can protect against collusion between the server and the trusted contact by allowing the protected customer to preemptively move funds before the time-lock expires.

The systems and methods described herein provide cloud-based recovery tools and an Emergency Access Kit (EAK) that protect a user's assets (e.g., cryptocurrency) from being lost or rendered inaccessible, whether from mismanagement or external threats. This dual focus on safeguarding against both accidental loss and malicious attacks leverages multi-party computation and zero-knowledge proofs to deliver private and secure self-custody.

The systems and methods described herein leverage MPC protocols such as Flexible Round-Optimized Schnorr Threshold (FROST) signatures to secure sensitive material, facilitate off-chain recovery, enable key share rotation, and allow upgrades to hardware backed security. The systems and methods described herein also leverage personal identification number (PIN)-derived keys utilizing oblivious pseudorandom functions (OPRFs) to address key loss challenges and improve data availability in self-custodial systems.

The systems and methods described herein are simple for users to use, in that they have no dependence on specific hardware, and no required print output (e.g., no display required). The systems and methods described herein provide users with control, allowing a self sovereign cryptocurrency wallet system that prevents verifiers or third parties from stealing funds or censoring transactions. The systems and methods described herein are forgiving, in that a lost phone or cloud access (e.g., password) does not result in lost funds. The systems and methods described herein are safe, in that there is no single point of failure for full loss of funds. The systems and methods described herein are upgradeable, for instance allowing devices to be replaced (e.g., upgraded) and providing wallet continuity when using a hardware wallet device.

Systems and methods are disclosed for secure transaction authorization based on multi-party computation (MPC). In some examples, a system may generate, at a first device and using a first private key share corresponding to the first device, a first partial signature associated with a transaction. A plurality of private key shares may include the first private key share. The plurality of private key shares may each correspond to different devices of a plurality of devices. The plurality of devices may include the first device. The system may receive, from one or more additional devices of the plurality of devices, one or more additional partial signatures associated with the transaction. The one or more additional partial signatures may be generated using one or more additional private key shares of the plurality of private key shares. The system may identify that a total amount of partial signatures associated with the transaction is greater than or equal to (meets or exceeds) a minimum threshold amount of partial signatures. The total amount of partial signatures includes the first partial signature and the one or more additional partial signatures. The system may aggregate the first partial signature and the one or more additional partial signatures. This may generate a signature associated with the transaction. The system may facilitate processing of the transaction using the signature and a distributed ledger.

In some examples, combination of different partial signatures from different devices can be considered a form of multifactor authentication for the transaction, with different partial signatures representing the different factors of authentication for the transaction. Similarly, combination of different private key shares from different devices to form a private key can be considered a form of multifactor authentication for the transaction, with different private key shares representing the different factors of authentication for the transaction. By automating many of the MPC interactions between devices that allow the different partial signatures from different devices (and/or the different private key shares from different devices) to be used for multifactor authentication for the transaction, computer security and network security are improved without improving user interface complexity or user experience complexity.

In some examples, the partial signatures and/or private key shares represent new kinds of files that enable a computer security system to do things it could not do before, for instance to authenticate a transaction using partial data from different devices. In some examples, the partial signatures and/or private key shares can be used to detect suspicious activity, for instance if an attacker attempts to initiate a transaction without all of the partial signatures and/or private key shares needed, or with an incorrect partial signature and/or private key share (e.g., from before a previous key refresh). The system can take proactive measures in the event of such suspicious activity, for instance initiating a key refresh, banning the attacking user and/or device, invalidating the private key share(s) and/or partial signature(s) used by the attacker, or a combination thereof.

Systems and methods are disclosed for time-delayed secure recovery. In some examples, a system initiates a timer that is scheduled to count from a request time to an end time. The request time may be associated with communication of a request for initiation of a recovery procedure. The system may provide a notification indicative of the request and the end time. The notification may include an interactive element that is configured to trigger sending of a response to cancel the initiation of the recovery procedure. The system may initiate the recovery procedure based on the response not being communicated as of the end time.

In some examples, the request to initiate secure recovery and the notification are communicated via different communication channels. For instance, the request can be communicated via a first communication channel, while the notification can be communicated via a second communication channel. The first communication channel and the second communication channel can improve computer security and network security in a similar way as multifactor authentication, for instance in that an attacker would need to control both the first communication channel and the second communication channel to gain access to the user's assets through the recovery mechanism. Lack of control over both the first communication channel and the second communication channel by an attacker could be detected as suspicious activity, giving the true user a chance to cancel the recovery procedure and proactively block the attacker from accessing the user's assets. The system can take additional proactive measures in the event of such suspicious activity, for instance initiating a key refresh, banning the attacking user and/or device, invalidating the private key share(s) and/or partial signature(s) used by the attacker, or a combination thereof.

Systems and methods are disclosed for improved privacy in multi-party computation (MPC) system through blinded computations. In some examples, a system can receive a first blinded data element. The system may combine the first blinded data element with at least a second blinded data element to compute a blinded result. The system may verify a validity of the blinded result. The system may facilitate a transaction based on the validity of the blinded result.

Blinded calculations can involve calculations with blinded values, or values that are encrypted using homomorphic encryption. By using blinded computations to verify a validity of the blinded result and ultimately facilitate a transaction, the homomorphic encryption used in the blinded calculation can represent an encryption technique that improves network security and computer security. Furthermore, the blinded data elements can represent new kinds of data that enable a computer security system to do things it could not do before, namely verify validity of data without knowing the exact makeup of the data (e.g., without knowing a value in the data), thus improving privacy and security. In some examples, such blinded verification allows verification to be performed in scenarios where verification would otherwise be avoided (to avoid a loss in privacy), thus improving security by enabling addition of verification operations in privacy-sensitive scenarios (e.g., where data includes, or is related to, private key shares, partial signatures, PINs, wallet descriptors, asset amounts in a wallet, vaulted asset amounts, unvaulted asset amounts, other sensitive data, or combinations thereof).

Systems and methods are disclosed for secure key share rotation using multi-party computation (MPC). In some examples, a system monitors a status of a first instance of a private key share of a plurality of private key shares. The plurality of private key shares may be associated with a plurality of devices. The plurality of private key shares may be portions of a private key. The system may identify, based on a comparison of the status to a rule, a condition. In response to identifying the condition, the system may automatically generate a second instance of the private key share as part of refreshing the plurality of private key shares. Each device of the plurality of devices may store one of the plurality of private key shares without any of the plurality of devices having access to an entirety of the private key. The second instance of the private key share may be different from the first instance of the private key share

In some examples, refreshing the different private key shares from different devices that would form a private key could be considered a form of updating a multifactor authentication for a transaction to improve security of the multifactor authentication. For instance, refreshing the different private key shares may also refresh the different partial signatures from the different devices, again updating a multifactor authentication for a transaction to improve security of the multifactor authentication. By automating many of the MPC interactions between devices that allow the different partial signatures from different devices (and/or the different private key shares from different devices) to be used and/or updated for multifactor authentication for the transaction, computer security and network security may be improved without improving user interface complexity or user experience complexity.

In some examples, the partial signatures and/or private key shares represent new kinds of files that enable a computer security system to do things it could not do before, for instance to authenticate a transaction using partial data from different devices. In some examples, the partial signatures and/or private key shares can be used to detect suspicious activity, for instance if an attacker attempts to initiate a transaction without all of the partial signatures and/or private key shares needed, or with an incorrect partial signature and/or private key share (e.g., from before a previous key refresh). The system can take proactive measures in the event of such suspicious activity, for instance initiating a key refresh, banning the attacking user and/or device, invalidating the private key share(s) and/or partial signature(s) used by the attacker, or a combination thereof.

Systems and methods are disclosed for multi-party computation to improve security. In some examples, a first device (of a set of N devices) generates, through a multi-round interactive protocol for distributed key generation (DKG) that includes communications between the N devices, a public key and N private key shares of a private key corresponding to the public key. Each device of the N devices may store one of the N private key shares without any of the N devices having access to an entirety of the private key. The first device may generate, using a first private key share of the N private key shares, a first partial signature associated with a transaction. The first device may receive, from one or more devices of the N devices, one or more additional partial signatures associated with the transaction, the one or more additional partial signatures may have been generated using one or more additional private key shares of the N private key shares. The one or more additional private key shares may be distinct from the first private key share. The first partial signature and the one or more additional partial signatures may represent X partial signatures. The first device may identify that T≤X≤N, wherein Tis a minimum threshold number of partial signatures. The first device may aggregate the first partial signature and the one or more additional partial signatures to generate a signature associated with the transaction. The first device may and facilitate processing of the transaction using the signature and a distributed ledger.

Systems and methods are disclosed for time-delayed secure recovery. In some examples, a system receives a request to initiate a wallet recovery procedure associated with an amount of an asset. The system can initiate a timer. The system may provide an interactive alert indicative of receipt of the request. The interactive alert may include an option to cancel the request until the timer reaches a threshold time. The system may initiate the wallet recovery procedure in response to the timer reaching the threshold time.

In some implementations, the application for secure digital asset management integrates multi-party computation (MPC) for enhanced security, eliminating single points of failure. Traditional methods rely on custodians or self-custody, both of which have inherent security and usability trade-offs. By leveraging MPC, this system ensures that private keys are never fully assembled in a single location, significantly reducing risks associated with key compromise. The implementation includes distributed key generation (DKG), partial signature aggregation, and a robust vault system to safeguard assets from unauthorized access. Furthermore, privacy is enhanced through blinded computations and zero-knowledge proofs, maintaining confidentiality even in collaborative custody configurations. The system also introduces an advanced wallet recovery mechanism, combining time-locked security measures and multi-device authentication, ensuring seamless usability while prioritizing user sovereignty and security.

The present methods and systems improve digital asset security by implementing distributed key generation (DKG) and multi-party computation (MPC) to protect private keys from single points of compromise. By leveraging threshold cryptography and time-locked recovery processes to ensure secure and decentralized access to digital assets, the technical improvements ensure that asset security is maintained even in cases of device failure or unauthorized access attempts, solving a practical challenge in blockchain and digital wallet security.

Various aspects of the application will be described with respect to the figures.

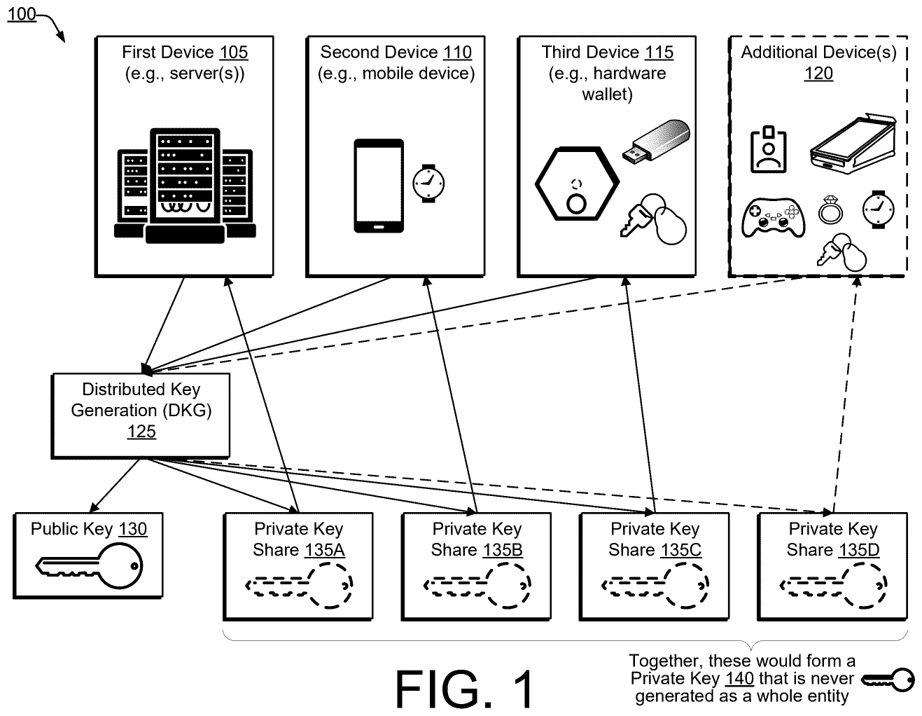

FIG. 1 is a block diagram illustrating a process 100 for distributed key generation (DKG) 125 of a public key 130 and multiple private key shares 135A-135D of a private key 140 through a multi-round interactive protocol that includes communications between multiple devices (e.g., a first device 105, a second device 110, a third device 115, and/or additional device(s) 120). In particular, the devices (e.g., first device 105, second device 110, third device 115, and/or additional device(s) 120) use a multi-round interactive protocol for distributed key generation (DKG) 125 that includes communications between the devices to generate the public key 130 and the private key shares 135A-135D of the private key 140. The private key shares 135A-135D, if combined together, would form the private key 140; however, the private key 140 is never generated during the process 100 for DKG 125, and none of the devices (e.g., the first device 105, the second device 110, the third device 115, and/or the additional device(s) 120) ever have a copy of the private key 140 in its entirety.

In some examples, the first device 105 is a server, such as a server associated with a payment service and/or verifier of transactions. In some examples, the second device 110 is a mobile device, such as a smartphone, a tablet computer, a wearable device, a media player, or a game console. In some examples, the third device 115 is a hardware wallet device, of which two examples are illustrated. In some examples, the devices may include one or more additional device(s) 120, which may include, for instance a badge, an identification card, a payment card, a point of sale (POS) terminal device, a video game console, a video game controller, a wearable device (e.g., watch, ring, glasses), a head-mounted display device, a headset, a pair of smart glasses, a key fob, and the like.

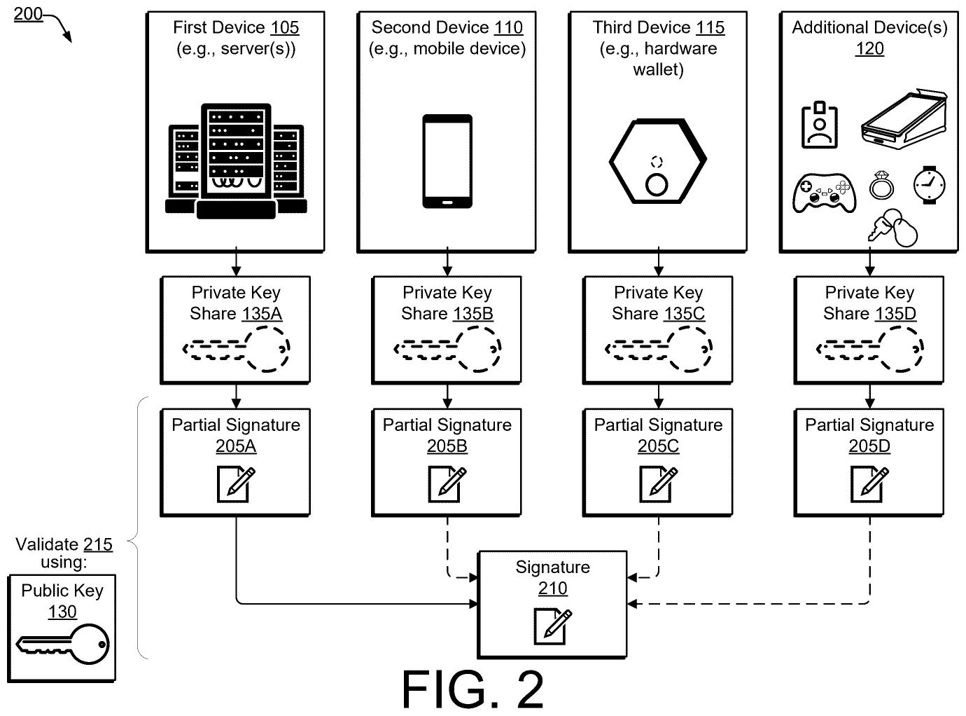

FIG. 2 is a block diagram illustrating a process 200 for partial signature generation in which multiple devices (e.g., the first device 105, the second device 110, the third device 115, and/or the additional device(s) 120) each use one of the private key shares 135A-135D to generate a partial signature, thus generating multiple partial signatures 205A-205D that are combined into a signature 210 via a process for partial signature aggregation. For instance, the first device 105 uses the private key share 135A to generate the partial signature 205A, the second device 110 uses the private key share 135B to generate the partial signature 205B, the third device 115 uses the private key share 135C to generate the partial signature 205C, and the additional device(s) 120 use the private key share 135D to generate the partial signature 205D. In some cases, at threshold number of the partial signatures 205A-205D are needed to generate the signature 210. For instance, in some examples, the threshold number of two, in which case at least two of the partial signatures 205A-205D are needed to generate the signature 210. In some examples, the signatures 210 and/or the partial signatures 205A-205D can be validated 215 using the public key 130, for instance by the first device 105 (e.g., the server), any of the other devices, or another system. In some examples, the partial signatures 205A-205D can be Edwards-curve Digital Signature Algorithm (EdDSA) signatures, Schnorr signatures. Flexible Round-Optimized Schnorr Threshold (FROST) signatures, or a combination thereof.

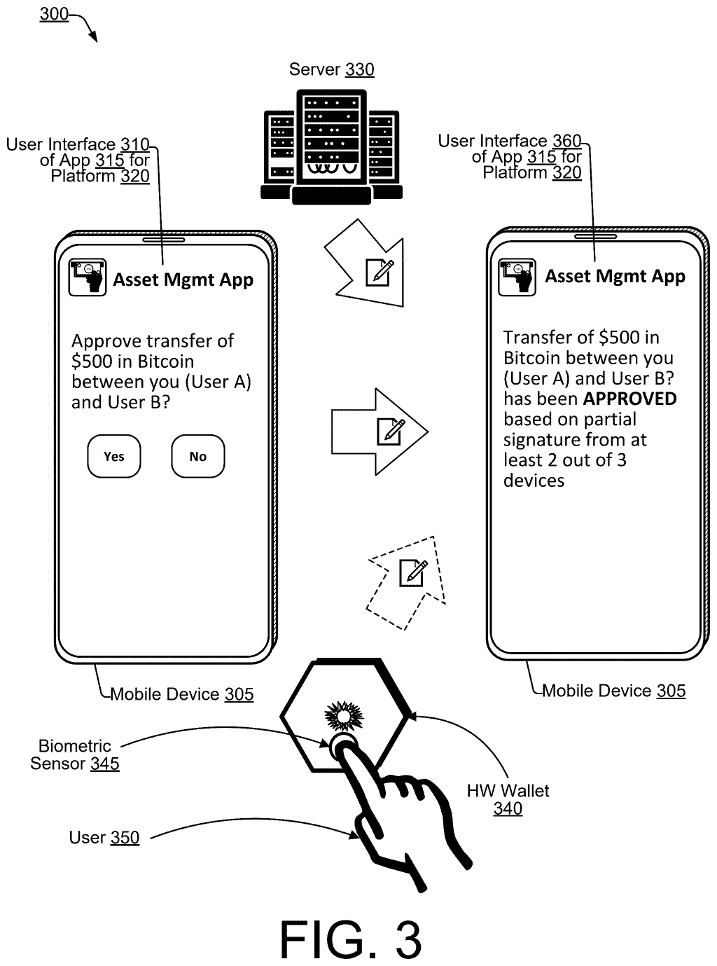

FIG. 3 is a conceptual diagram illustrating a process 300 for approving a transaction based on communications (e.g., with partial signatures) among multiple devices. For instance, a user interface 310 for an app 315 on a mobile device 305 is illustrated. The app 315 is associated with a platform 320 (e.g., a payment service, a distributed ledger, or a combination thereof). The mobile device 305 can be an example of the second device 110, or vice versa. The user interface 310 includes a message reading “Approve transfer of $500 in Bitcoin between you (User A) and User B?” with a “Yes” button and a “No” button. Pressing the “Yes” button may cause the mobile device 305 to communicate with a server 330 and/or a hardware wallet 340. In some examples, the server 330 may be an example of the first device 105, or vice versa. In some examples, the hardware wallet 340 may be an example of the 115, or vice versa.

Pressing the “Yes” button may cause the mobile device 305 to generate and/or retrieve its own partial signature (e.g., partial signature 205B). Pressing the “Yes” button may cause the server 330 to generate, retrieve, and/or provide its own partial signature (e.g., partial signature 205A). Pressing the “Yes” button may cause the hardware wallet 340 to generate, retrieve, and/or provide its own partial signature (e.g., partial signature 205C). Two or more of these partial signatures may be aggregated and combined to form a signature (e.g., signature 210) that is used to sign the transaction (e.g., the transfer of $500 in Bitcoin between user A and user B).

A user interface 360 of the app 315 is also shown, with the message “Transfer of $500 in Bitcoin between you (User A) and User B? has been APPROVED based on partial signature from at least 2 out of 3 devices.” According to the message in the user interface 360, one of the three devices (e.g., between the mobile device 305, the server 330, and the hardware wallet 340 did not provide a partial signature, but even so, the transaction was able to proceed using partial signatures from two out of the three devices. For instance, if the hardware wallet 340 was lost or otherwise inaccessible, the partial signature from the hardware wallet 340 (e.g., the partial signature 205C) may be missing, but the signature (e.g., signature 210) can be generated using just two of the three partial signatures, and the transaction can be initiated and processed.

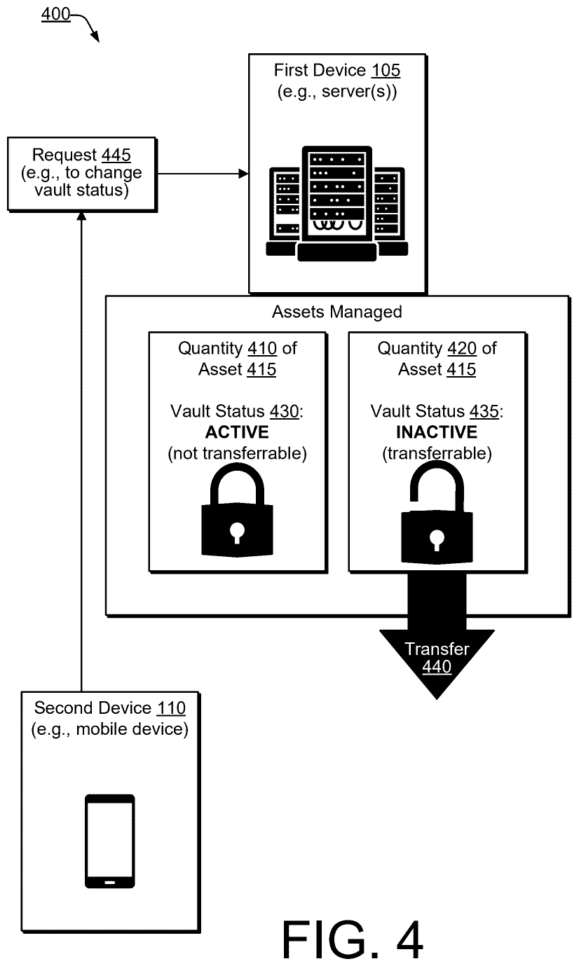

FIG. 4 is a conceptual diagram illustrating an asset configuration 400 in which a first quantity 410 of an asset 415 has active vault status 430 (and is thus not transferrable) and a second quantity 420 of the asset 415 has an inactive vault status 435 (and is thus transferrable and used for a transfer 440). In the asset configuration 400, the first device 105 manages a total amount of the asset 415 (e.g., a sum of the first quantity 410 and the second quantity 420) on behalf of a user. The user may be associated with the second device 110 as well, and in some cases the third device 115 as well (not pictured in FIG. 4). A data store (e.g., database, ledger) associated with the first device 105 includes a record associating that first quantity 410 of the asset 415 with the active vault status 430. While the active vault status 430 is applied to the first quantity 410 of the asset 415, the first quantity 410 of the asset 415 is not transferrable (non-transferable) or “locked,” and therefore cannot be transferred as part of any transaction unless and until the active vault status 430 is removed (e.g., deactivated).

The data store (e.g., database, ledger) associated with the first device 105 includes a record associating that second quantity 420 of the asset 415 with the inactive vault status 435. While the inactive vault status 435 is applied to the second quantity 420 of the asset 415, the second quantity 420 of the asset 415 is transferrable, and therefore can be transferred as part of a transaction. For instance, a transfer 440 is illustrated as an arrow transferring at least a subset of the second quantity 420 of the asset 415 from the second quantity 420 of the asset 415 because the second quantity 420 of the asset 415 has the inactive vault status 435.

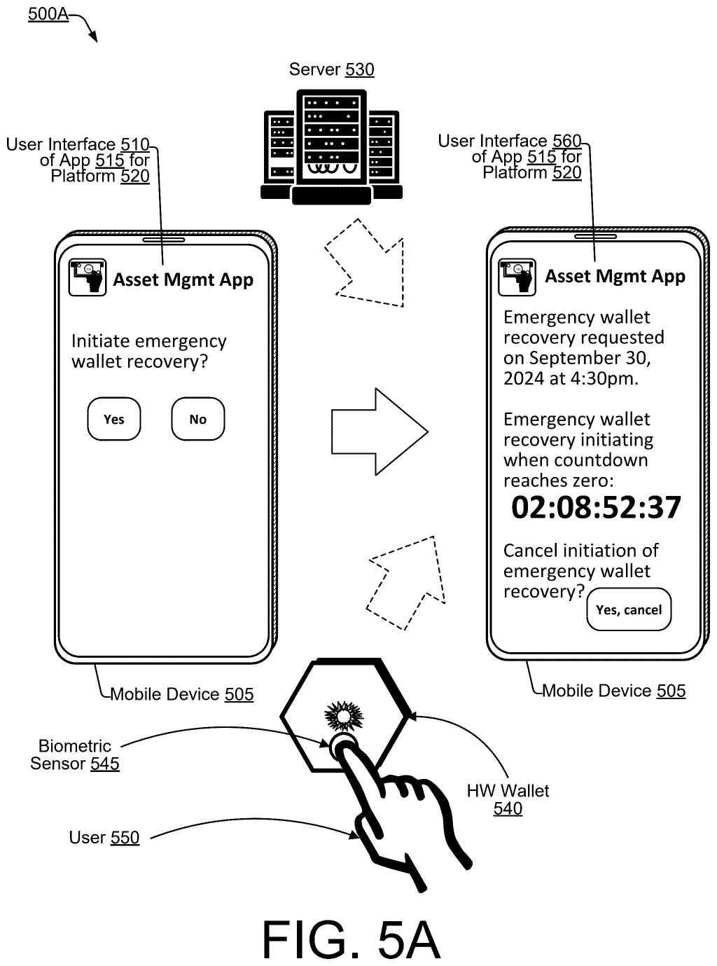

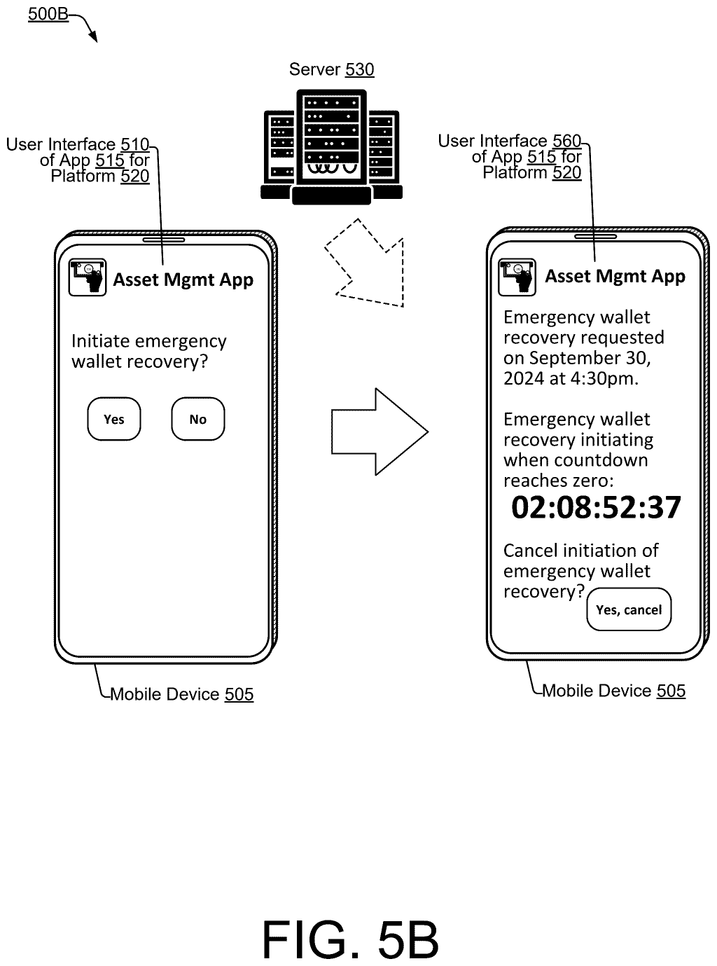

In some examples, the first device 105 may receive a request 445 from the second device 110. The request 445 may be a request 445 to change the vault status of a quantity of assets. In a first illustrative example, the request 445 may be a request to remove the active vault status 430 from the first quantity 410 of the asset 415, for instance instead applying an inactive vault status 435 to the first quantity 410 of the asset 415. In a second illustrative example, the request 445 may be a request to remove the inactive vault status 435 from the second quantity 420 of the asset 415, for instance instead applying an active vault status 430 to the second quantity 420 of the asset 415. In some examples, to prevent an unwanted change in vault status (e.g., a malicious actor threatening the user to unlock the first quantity 410 of the asset 415 from the active vault status 430 to an inactive vault status 435 in a “wrench” attack), the such a change in vault status can be gated behind a time delay similar to the time delay interface illustrated in FIGS. 5A-5B.

FIG. 5A is a conceptual diagram illustrating a process 500A for initiating emergency wallet recovery. For instance, a user interface 510 for an app 515 on a mobile device 505 is illustrated. The app 515 is associated with a platform 520 (e.g., a payment service, a distributed ledger, or a combination thereof). The mobile device 505 can be an example of the second device 110, or vice versa. The user interface 510 includes a message reading “Initiate emergency wallet recovery?” with a “Yes” button and a “No” button. Pressing the “Yes” button may cause the mobile device 505 to communicate with a server 530 and/or a hardware wallet 540. In some examples, the server 530 may be an example of the first device 105, or vice versa. In some examples, the hardware wallet 540 may be an example of the 115, or vice versa.

In some examples, pressing the “Yes” button may cause the mobile device 505 to generate and/or retrieve its own partial signature (e.g., partial signature 205B). Pressing the “Yes” button may cause the server 530 to generate, retrieve, and/or provide its own partial signature (e.g., partial signature 205A). Pressing the “Yes” button may cause the hardware wallet 540 to generate, retrieve, and/or provide its own partial signature (e.g., partial signature 205C). Two or more of these partial signatures may be aggregated and combined to form a signature (e.g., signature 210) that is used to verify that the emergency wallet recovery should proceed.

In some examples, the partial signatures from the server 530 and/or the hardware wallet 540 are not necessary to initiate the emergency wallet recovery. For instance, the hardware wallet 540 is not present in FIG. 5B.

FIG. 5B is a conceptual diagram illustrating a process 500B for initiating emergency wallet recovery. The emergency wallet recovery of FIGS. 5A-5B can be gated behind a time delay. For instance, the user interface 560 of the app 515 is also shown, with the messages “Emergency wallet recovery requested on Sep. 30, 3024 at 4:30 pm,” “Emergency wallet recovery initiating when countdown reaches zero: 02:08:52:37,” and “Cancel initiation of emergency wallet recovery?,” with a “Yes, cancel” button. According to the message in the user interface 560, the emergency wallet recovery process will initiate automatically in 2 days, 8 hours, 52 minutes, and 37 seconds unless the “Yes, cancel” button of the user interface 560 is pressed. As noted below, certain types of emergency wallet recovery procedures can cause a security risk, such as decryption of stored private key shares, so this time delay prevents accidental initiation of the emergency wallet recovery, or unwanted initiation of the emergency wallet recovery (e.g., a malicious actor threatening the user to initiate emergency wallet recovery in a “wrench” attack to try to perform a unilateral asset transfer). For instance, if the user is being coerced by a malicious actor to initiate emergency wallet recovery, the user can cancel the request later, when the user is safe from the malicious actor. This time delay for emergency wallet recovery can be referred to as an emergency wallet recovery time delay, an emergency wallet recovery time-lock, an EAK (emergency access kit) time delay, or an EAN time lock.

In some examples, a change in vault status (e.g., from the active vault status 430 to the inactive vault status 435 based on the request 445) can be gated behind a time delay similar to the time delay interface illustrated in user interface 560 of FIGS. 5A-5B. For instance, a user interface can alert the user that the request 445 has been received, and can initiate a countdown to when the vault status will change if the request 445 is not cancelled by then, and can give an option for the user to cancel. This way, if the user is being coerced by a malicious actor to change their vault status, the user can cancel the request later, when the user is safe from the malicious actor. This time delay for a change in vault status (e.g., from active vault status 430 to inactive vault status 435 or vice versa) can be referred to as a vault time delay, or a vault time lock.

In some examples, the vault time lock is enforced by a server (e.g., first device 105, server 330, server 530, server 615). With the vault time lock, the server can notify the user (e.g., via the mobile device 505 or another communication channel) and give the user an opportunity to cancel. In some examples, no application countdown timer is presented—for instance, the notification can simply tell the user how long the user has to cancel the request before the vault status is changed (e.g., identifying a date and/or time). In some examples, the user interface in the app 515 includes of two balances (similar to a checking account and a savings account) where funds can be transferred between them, with one balance representing the first quantity 410 of the asset 415 with the active vault status 430, and with the other balance representing the second quantity 420 of the asset 415 with the inactive vault status 435. In some examples, when transferring out of the vault (e.g., when the request 445 requests that at least a subset of the first quantity 410 be changed from the active vault status 430 to the inactive vault status 435, and/or transferred out to another account via a transfer 440), the server 530 and/or the app 515 enforce a time-delay, and/or can show a date and/or time for when the funds will be changed into the inactive vault status 435 and/or transferred (e.g., via transfer 440).

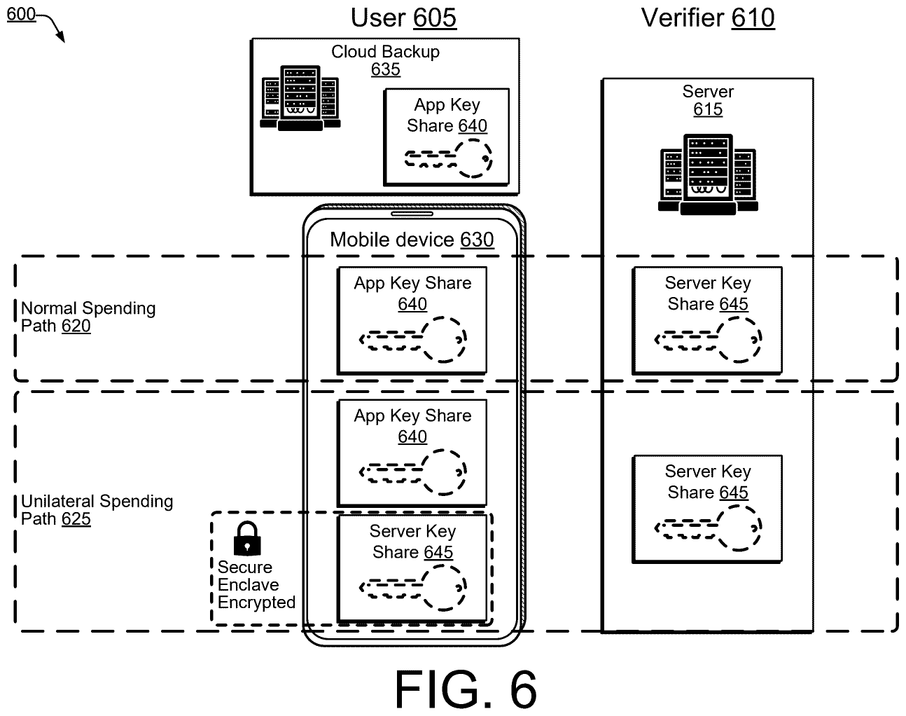

The EAK (emergency access kit) time-lock is for a scenario in which the server(s) (e.g., first device 105, server 330, server 530, server 615) are unavailable, inaccessible, stops operating, is compromised, and/or is uncooperative. In such a scenario, the user can put the app 515 into a special emergency mode. When initiating this special emergency mode, the application countdown timer can be display in the user interface 560, with a cancel button, for instance to deter wrench attacks. After the timer elapses, the mobile device 505 then decrypts its copy of the server key share 645 using its secure enclave, and then the phone has both key shares (e.g., app key share 640 and server key share 645) and can move the funds without the server. This is illustrated in, and discussed further with respect to, FIG. 6.

FIG. 6 is a conceptual diagram illustrating multiple spending paths 600 implemented across multiple devices, including a normal spending path 620 and a unilateral spending path 625. The devices can include device(s) associated with a user 605, such as a mobile device 630 and a cloud backup 635. The mobile device 630 may be an example of the second device 110, the mobile device 305, and/or the mobile device 505, or vice versa. The cloud backup 635 may be a personal cloud backup that is not associated with a verifier 610. The cloud backup 635 may back up the key(s) and/or key share(s) that are on the mobile device 630). The devices can include device(s) associated with the verifier 610, such as a server 615. The server 615 can be an example of the first device 105, the server 330, and/or the server 530, or vice versa.

The systems and methods described herein provide a 2-of-2 software wallet via the first device 105 (e.g., the server 330, the server 530) and the second device 110 (e.g., the mobile device 305, the mobile device 505) that can be upgraded to a 2-of-3 hardware wallet via the first device 105 (e.g., the server 330, the server 530), the second device 110 (e.g., the mobile device 305, mobile device 505), and the third device 115 (e.g., the hardware wallet 340, the hardware wallet 540). Users can use the app 315 and onboard with or without the third device 115 (e.g., the hardware wallet 340, the hardware wallet 540). Upgrading is easy, in that the third device 115 (e.g., the hardware wallet 340, the 504//) can be added to the key configuration at any time via key rotation.

In some examples, the systems and methods described herein can use FROST keys and signatures to manage the keyset, enhancing both user experience and security, making it appear as a 1-of-1 on-chain. Additionally, the systems and methods described herein can use two spending paths: a normal spending path 620 for normal spending and a unilateral spending path 625 for unilateral spending by the customer. The unilateral spending path 625 is fully controlled by the user and protected by their phone's enclave, providing secure and independent access.

In some examples, the normal spending path 620 can use a 2-of-2 MPC system, a 2-of-3 MPC system, an N-of-N MPC system, and/or a T-of-N MPC system. For instance, in the normal spending path 620, in some examples, the app on the mobile device 630 (e.g., second device 110, app 315, app 515) and server (e.g., first device 105, server 330, server 530) can each generate a key share, and both key shares (e.g., the app key share 640 and the server key share 645) can be needed to authorize a transaction. In some examples, since the server key share 645 of the server 615 is needed for authorizing transactions, the server 615 can implement additional signing policies to further improve security.

In the normal spending path 620, when a user (e.g., customer) wants to spend from the wallet, processing the transaction is authorized based on partial signatures from both the app (of the mobile device 630) and the server 615, corresponding to the app key share 640 and the server key share 645, respectively. Since the server key share 645 is necessary for transactions, the server 615 can enhance fund safety by implementing signing policies to protect the funds. The app key share 640 can be an example of the private key share 135B, or vice versa. The server key share 645 can be an example of the private key share 135A, or vice versa.

One such policy is the use of vaults as in FIG. 4. Users can deposit a portion of their wallet into a vault by setting a vault amount. The server 615 will not co-sign any transaction that would cause the balance to drop below this vault amount, effectively protecting the quantity of the asset that has the active vault status 430 from being spent. To withdraw coins from the vault by lowering the vault amount, users can go through a time-delay process similar to the time-delay process illustrated in the user interface 560.

In some examples, the server 615 can implement further co-signing policies, such as delaying transactions based on fraud heuristics indicating a high probability (e.g., exceeding a threshold) of fraud.

The unilateral spending path 625 differs from the normal spending path 620. Having the server 615 in the critical path for spending enhances security, but true self-custody is present when the user 605 has the ability to move their funds independently of the server 615 (e.g., without relying on the server 615). In some examples, the systems and methods described herein provide the unilateral spending path 625 as a 1-of-1 spending path. In some examples, the systems and methods described herein provide the unilateral spending path 625 as a second 2-of-2, 2-of-3, N-of-N, and/or T-of-N spending path. In the unilateral spending path 625, the mobile device 630 stores the app key share 640, but also, the mobile device 630 is given an encrypted instance (or copy) of the server key share 645 that the mobile device 630 stores in a secure enclave within the mobile device 630. The secure enclave can include tamper detection circuitry that can delete the contents of the secure enclave (e.g., the server key share 645 and in some cases the app key share 640) if a tamper attempt is detected. In some cases, the server key share 645 is decryptable only by the secure enclave of the mobile device 630, for instance in response to a biometric authentication using a biometric sensor of the mobile device 630. This enclave-based encryption limits access to the physical phone and the app, allowing the app to secure this key behind biometrics and a time delay (e.g., 14 days). In some examples, the biometric sensor of the mobile device 630 can include a fingerprint sensor with a fingerprint detection and/or recognition subsystem; include a handprint sensor with a handprint detection and/or recognition subsystem; an optical sensor (e.g., image sensor of a camera, structured light sensor) with a face detection and/or recognition subsystem, an iris detection and/or recognition subsystem, and/or a person detection and/or recognition subsystem; another biometric sensor with a corresponding user detection and/or recognition subsystem; or a combination thereof.

The user 605 can unilaterally choose to use the unilateral spending path 625, placing the wallet in emergency wallet recovery mode after the time delay. Emergency wallet recovery mode offers the user a simple “send all assets” functionality. In some examples, a user interface of the app on the mobile device 630 can explain that performing the emergency wallet recovery will irreversibly end the wallet. If the user decides to proceed, the secure enclave decrypts the server key share 645, combines the server key share 645 with the app key share 640 (e.g., to generate a private key as in the private key 140), and sends the funds using the private key. In situations where the app key share 640 and the server key share 645 are FROST key shares, the private key as a whole may be referred to as the FROST master key. Once the FROST master key has been constructed, security assumptions can no longer be made about the wallet; however, the funds can be transferred to their new destination.

In some examples, all key material stored on the mobile device 630 is also backed up in the cloud backup 635. In some examples, all key material stored on the mobile device 630 is also backed up in the cloud backup 635 except for the server key share 645 that is only stored in the secure enclave of the mobile device 630.

The security of a wallet depends on protecting cryptographic keys from unauthorized access or misuse. As noted above, the wallet design illustrated in FIG. 6 features an app key share 640 held by the mobile device 630 of the user 605, and a server key share 645 held by the server 615 of the verified 610. In the wallet design of FIG. 6, the app key share 640 is stored locally on the mobile device 630, for instance using the Keychain on iOS and/or Encrypted-SharedPreferences backed by the local Keystore on Android. This app key share 640 is decrypted and held in memory for transaction signing. The security of app key share 640 relies on the underlying mobile platform's application sandboxing (on the mobile device 630) and the presence of a trusted execution environment in the mobile device 630, which together help prevent key exfiltration, indirectly through various hardware security and OS mechanisms.

On the server side (of the server 615), the server key share 645 associated with the signing for the user 605 (and/or the mobile device 630) is secured through a layered encryption approach involving Data Encryption Keys (DEKs) and a Customer Master Key (CMK). Server key shares (such as the server key share 645) is encrypted using the DEKs. These DEKs are themselves encrypted with a CMK managed by a Key Management Service (KMS) (e.g., such as Amazon Web Services (AWS) AWS KMS) and stored at rest in a data structure (e.g., a database such as a DynamoDB database). The code that manages these keys and signs customer transactions is referred to as the Wallet Security Module (WSM) and can run in an isolated compute environment (e.g., an AWS Nitro Enclave) in a cloud network system.

In some examples, the CMK has a strict policy that defines how it can be used. Specifically, the CMK can only decrypt DEKs when a valid cryptographic attestation is presented, proving that the code executing within an isolated compute environment (e.g., AWS Nitro Enclave) matches a specific hash value (e.g., a PCR0 as a hash of an enclave image that represents the identity of the code). This policy condition ensures that only an enclave running the approved code can decrypt the DEKs; unauthorized or altered code cannot use the CMK to decrypt them. The policy effectively binds the CMK's decryption capability to a particular deployment, preventing misuse even if someone attempts to deploy a malicious enclave.

In some examples, the systems and methods discussed herein perform key rotation. Key rotation essentially performs DKG on a periodic basis, replacing the key shares (e.g., app key share 640, server key share 645) over time. In some examples, key rotations may be implemented as regular and/or periodic key rotations at time intervals that are regular and/or predetermined. Key rotation can limit the useful lifetime of any compromised key material. In any attack, an attacker would need to collect at least two artifacts (e.g., app key share 640 and server key share 645). Key rotations can further require the attacker to gain access to both artifacts before the next rotation. This can prevent the attacker from gaining access in scenarios where an attacker only gains only partial access (e.g., to one of two artifacts). Key rotation also ensures that compromised key material is not indefinitely useful to the attacker.

In addition to proactive periodic key rotations, the systems and methods described herein can also implement key rotation in response to transition conditions, for instance when the user 605 is migrating the wallet to another phone, whether recovering from a lost device, when planning a transition to a new phone, in response to an indication that the phone is lost (or otherwise inaccessible), in response to an indication that the server is inaccessible, and the like. This ensures wallet continuity for the user 605, preventing costly sweeps and funds from being sent to inaccessible addresses.

The server's signing keys (e.g., the server key share 645) are encrypted using Data Encryption Keys (DEKs), which rotate (i.e., perform key rotation(s)) periodically, for instance approximately every 2 million uses of a DEK. The system illustrated in FIG. 6 (e.g., the server 615) generates and caches DEKs, utilizing a KMS (e.g., AWS KMS) and a data store (e.g., AWS DynamoDB) to store and update usage counts in batches to minimize database interactions. By employing local caching and a leasing mechanism, the server 615 efficiently retrieves DEKs while mitigating nonce-collision risks and reducing the potential impact if a DEK is compromised.

In some examples, the DEKs themselves are encrypted with a CMK, such as an AWS CMK. In some examples, the WSM has a policy on its CMS that binds use of the WSM's CMS to a specific WSM deployment via a hash value (e.g., PCR0 value) of (associated with) a Trusted Platform Module (TPM) of an isolated compute environment (e.g., AWS Nitro Trusted Platform Module (TPM)), as indicated in the example code configuration below:

```
“Action”: “kms:Decrypt”,
“Resource”: “*”,
“Condition”: {
  “StringEqualsIgnoreCase”: {
    “kms:RecipientAttestation:PCR0”:
    “${var.enclave_attestation_pcr0}”
  }
}
```

The PCR0 is a hash of the code deployed within the enclave, stored and locked within the TPM. This means that the CMK cannot be used outside of an allowlisted WSM deployment.

In some examples, a dedicated cloud account (e.g., a dedicated AWS account and/or admit account) can be used to manage the CMK, ensuring strict isolation and control. The dedicated account can have dual control across two groups. The account can be secured using multi-factor authentication (MFA). In some examples, and universal second factor (U2F) token(s) for the account are stored in a secure location that requires a third, unrelated, group to access. This ensures that changes to the CMK policy are extremely difficult to make, improving security.

All infrastructure is provisioned using a secure cloud infrastructure system, (e.g., AWS CloudFormation). In some examples, key updates or policy changes are governed through a CI pipeline. The WSM deployment requires multi-party approval for any changes, with individuals (e.g., engineers and/or administrators) in a signing quorum providing cryptographic signatures for authorization. A separate pipeline manages the trusted certificates for the individuals (e.g., engineers and/or administrators), which are stored in a secure cloud storage container (e.g., a Simple Storage Service (S3) bucket), and signed changes must meet the required signature threshold.

WSM's binary (the .eif) file can be signed, and the hash of the signing certificate goes in PCR8, as indicated below:

$$PCR 8 = sha 384 ( 0 \times 00 * 48 ‖ sha 384 ( SignatureSection [ 0 ] . cert ) )$$

The WSM's binary being signed, and the hash of the WSM's binary, allow one to verify that WSM executed code signed by the appropriate private key. This protects against an attacker maliciously deploying their own instance of an enclave with a matching PCR0, because such an attacker cannot sign the binary correctly.

In the wallet design illustrated in FIG. 6, the mobile app (running on the mobile device 630), as well as individuals such as security researchers, could request WSM's attestation document and inspect it. Signed .eif files enable use of the enclave to establish a secure channel with strong attestation guarantees. The mobile application (running on the mobile device 630) can receive an attestation document containing the enclave signature. The mobile application (running on the mobile device 630) can verify the attestation document, extract and validate the PCR8 contents from the attestation document, and use the enclave's public key (e.g., included in the attestation document) to establish a secure channel to the enclave. This enables parties (e.g., the mobile device 630 and/or the user 605) to inspect and verify the enclave software while also ensuring that the code is actually executing. Additionally, this process ensures that the user 605 is indeed communicating with the intended enclave. Consequently, the user 605 can be more confident that the enclave is not acting maliciously, as a signed mobile app (e.g., running on the mobile device 630) will only communicate with a signed backend enclave.

With respect to the normal spending path 620, the systems and methods described herein can perform key rotations are regularly and proactively, happening automatically in the background while the user 605 uses the app (e.g., app 315, app 515). Rotating key shares is a capability of FROST signature schemes, where old key shares are exchanged for new ones. Old key shares can be used together, and new key shares can be used together, but importantly, old key shares cannot be used with new key shares. This prevents an attacker with an old key share from using it with the new key shares or acquiring the corresponding old key share that was deleted during a rotation.

With respect to the unilateral spending path 625, the systems and methods described herein perform enclave rotations, for instance in addition to the periodic rotations discussed above. These key rotations are done regularly and proactively, happening automatically in the background while the user 605 uses the app (e.g., app 315, app 515). In enclave rotations, the instance of the server key share 645 in the secure enclave of the mobile device 630 is also rotated, along with the app key share 640 and the instance of the server key share 645 that is at the server 615.

As noted previously, the systems and methods described herein can also implement key rotation in response to transition conditions. Such key rotations can be performed when a customer is migrating to from an old mobile device 630 to a new mobile device 630 (e.g., new phone). In some examples, a key rotation performed in response to such a transition condition can use a QR-code process, that is biometrically gated, to have the current enclave key (e.g., the instance of the server key share 645 in the secure enclave of the old mobile device 630) on the old mobile device endorse a new enclave key (e.g., an instance of a newly rotated server key share 645 in the secure enclave of the new mobile device 630) on the new mobile device. After the rotation is complete, the new mobile device now has all of the active key material (e.g., app key share 640, server key share 645) and the old mobile device can delete the old key material (e.g., app key share 640, server key share 645). In some examples, such key rotations can be further secured using a delay and notify interface similar to the user interface 560, thereby alerting the user 605 of a request for a transition condition related key rotation and providing the user 605 an opportunity to cancel the transition condition related key rotation.

Transition conditions can also include recovery scenarios, such as scenarios in which the user 605 loses access to the mobile device 630 (e.g., the mobile device 630 is lost, stolen, becomes damaged or dysfunctional, or is otherwise inaccessible to the 605). In such a recovery scenario, the current enclave key (e.g., the instance of the server key share 645 in the secure enclave of the mobile device 630) is not available to endorse the new enclave key during the key rotation. In such a recovery scenario, a new enclave key (e.g., a new instance of the server key share 645 to be stored in a secure enclave of a new mobile device 630) can be generated via a key rotation that is secured using a delay and notify interface similar to the user interface 560, thereby alerting the user 605 of a request for a transition condition related key rotation and providing the user 605 an opportunity to cancel the transition condition related key rotation. This scenario does potentially leave some key material on the old mobile device 630—the instance of the server key share 645 encrypted by the secure enclave. However, extracting secret material from a secure enclave is extremely difficult, and the transition condition related key rotation process ensures that, even if an attacker might gain access to the instance of the server key share 645 encrypted in the secure enclave of the old mobile device 630, the instance of the server key share 645 encrypted in the secure enclave of the old mobile device 630 will no longer be valid or useful.

There are a number of scenarios for recovery by a user 605. In a lost phone scenario in which the mobile device 630 is inaccessible (e.g., lost, stolen, damaged, etc.) but the cloud backup 635 remains intact, an instance of the app key share 640 that was backed up in the cloud backup 635 can be retrieved and restored to the mobile device 630. To prevent attackers with cloud access from linking an app and/or mobile device 630 to the cloud backup 635, the systems and methods discussed herein can gate cloud-based recovery with a 7 day veto window, for instance via a delay and notify interface similar to the user interface 560.

In an illustrative example, the mobile device 630 may be dropped in the ocean. The 605 gets a new mobile device 630 and downloads the app (e.g., app 315, app 515). The customer follows the “restore a wallet” path. The server 615 initiates a 7 day Delay and Notify. Seven days later, the user 605 returns to the app, and the server 615 generates a new auth key, rotates key shares and completes the full recovery.

In a lost cloud scenario in which the cloud backup 635 is inaccessible (e.g., password is lost or changed, servers associated with the cloud backup 635 are down, connection to the cloud backup 635 is down) but the mobile device 630 is still accessible, the cloud backup 635 (when it becomes accessible again) can retrieve the instance of the app key share 640 from the mobile device 630.

In an illustrative examples, the user 605 can forget their personal cloud backup password and gets permanently locked out of their cloud account. The user 605 creates or connects to a new cloud account on the same mobile device 630. The app (e.g., app 315, app 515) of the mobile device 630 replaces the contents of the cloud (e.g., retrieving and backing up the app key share 640 from the mobile device 630) with no delay.

In a lost server scenario, the server 615 is inaccessible (e.g., permanently or temporarily uncooperative or unreachable), for instance due to the server 615 being down, a connection to the server 615 being down, the verifier 610 no longer existing, or some other issue. The lost server scenario is critical to demonstrating the self-sovereignty of the wallet. The user 605 can use the unilateral spending path 625 to move the funds out of the wallet.

In an illustrative example, a natural disaster can wipe out the servers of the verifier 610, destroying or otherwise shutting down the server 615 permanently. However, the app (e.g., app 315, app 515) still exists on the mobile device 630 of the user 605. The user 605, in the app, selects the “Unilateral Spending” option for the unilateral spending path 625. This starts a delay, enforced by the app code, which lasts for 14 days. The delay can function like the user interface 560 of FIGS. 5A-5B. The secure enclave can request a biometric scan (e.g., fingerprint scan, face scan, and/or iris scan), and decrypts an emergency access kit (EAK) that includes the instance of the server key share 645 that was stored in the secure enclave of the mobile device 630. The app can now, in emergency mode, support a “send-all” function to send all funds to a destination of the user 605's choosing.

In a lost phone and cloud scenario in which the user 605 loses access (e.g., simultaneously or contemporaneously) to both their phone and cloud account, additional hardware such as a third device 115 (e.g., hardware wallet 340, hardware wallet 540) and/or additional device(s) 120 can be used to initiate a key rotation and recover access to the funds of the user 605. In some examples, without additional hardware, a lost phone and cloud scenario can result in a loss of funds.

In an app unavailable scenario in which the app is removed from the mobile device 630 and cannot be redownloaded (e.g., delisted or blocked by an app store of the mobile device 630). Without the app, there mobile device 630 has no way to reach server 615, access the app key share 640, or use the enclave to leverage unilateral spending path 625. In the app unavailable scenario, additional hardware such as a third device 115 (e.g., hardware wallet 340, hardware wallet 540) and/or additional device(s) 120 can be used to initiate a key rotation and recover access to the funds of the user 605. In some examples, without additional hardware, an app unavailable scenario can result in a loss of funds.

Recovery tools are a double-edged sword, offering the user 605 a means to recover from loss while potentially providing attackers with exploitable tools. To distinguish between the user 605 and an attacker, the systems and methods described herein make user of a Delay and Notify (D&N) system as illustrated in the user interface 560 of FIG. 5. Recognizing that attackers may also compromise the communication channel, the veto nature of D&N results in a stalemate where each can block the other's actions. Over time, this situation favors the user 605, who can eventually regain unilateral control of their communication channel through identity-based methods-such as using their driver's license at a store of the verifier 610 (or a provider of the mobile device 630) to secure their mobile device 630 number or a linked credit card with the verifier 610 (or a provider of the mobile device 630) to reestablish identity.

Use of a D&N veto signals suspicious activity. For three days after a veto, the wallet operates with elevated security, adding an additional one-time password (OTP) requirement to any action that would otherwise only require a D&N. This does provide the user 605 a clear path to thwart the attack. The user 605 can gain access to communication channels to veto any attacker actions, regain unilateral access to communication channels so that OTPs prevent the attacker from initiating new actions, and rotate keys to invalidate compromised materials. In some examples, a D&N interface may be a user interface of the app itself, as in the user interface 560 of FIGS. 5A-5B. However, for added security, the D&N interface may use email, text messaging, another app, or another communication channel that is known to be controlled by the user 605.

If an attacker gains access to a cloud account of the user 605, the attacker could attempt to gain full control of a wallet by performing a cloud-based recovery. As this could equally likely be the real user 605 trying to recover from a stolen mobile device 630, cloud recoveries can be protected by a Delay and Notify, for instance of 7 days. In an illustrative example, an attacker gains access to the cloud account and links a device they control. The attacker requests to restore the wallet from the cloud. The server 615 initiates a 7-day Delay and Notify before restoring the wallet, for instance allowing the user 605 to cancel the attacker's request via email or text message. The user 605 can then regain unilateral control by cancelling the request via their email, preventing the attacker from taking further privileged actions.

In a stolen phone scenario in which an attacker has gained control of the mobile device 630 and is able to unlock it, funds higher than a spending limit may be protected by spending controls. Once the user 605 initiates a cloud recovery, the server stops co-signing transactions while the recovery is in process. If the attacker has access to the mobile device 630 of the user 605, the attacker could receive the cloud recovery alert and veto the legitimate recovery. Now the wallet is in a stalemate with the user 605 vetoing spending actions and the attacker vetoing recovery actions. Once the user 605 gains unilateral control over their email/text, the attack can be thwarted.

In an illustrative example, an attacker gains access to the mobile device 630 and can consistently unlock it The attacker drains the funds below the spending limits. The attacker tries to send funds above the limit and is vetoed by the user 605 within the 3 day D&N. The user 605 begins recovery on a new mobile device 630 which is vetoed by the attacker within the 7 day D&N. The user 605 regains unilateral control of their email, and completes a cloud recovery.

In a unilateral spending attack scenario, an attacker gains control of the mobile device 630 and initiates the unilateral spending path 625. In some examples, initiating the unilateral spending path 625 begins with a biometric check, followed by a 2-day delay, and requires a second biometric check before proceeding with the unilateral spending path 625.

In an illustrative example, the attacker steals the mobile device 630. The attacker passes a biometrics check and requests to begin the unilateral spending path 625 process. The app enforces a 2 day delay. The attacker fails the second a biometrics check and cannot enter the unilateral spending path 625 mode to press the “send all” button.

The unilateral spending path 625 design relies on an instance of the server key share 645 being protected by the secure enclave of the mobile device 630. However, in some examples, a mobile device 630 may lack a secure enclave. In some examples, a user 605 attempting to onboard with an unsupported mobile device 630 (e.g., a mobile device 630 without a secure enclave) receives an alert that their mobile device 630 is not capable of securing a bitcoin wallet.

To transition the user to using an additional device (e.g., third device 115, additional device(s) 120, hardware wallet 340, hardware wallet 540), the server 615 and/or mobile device 630 can change the signing threshold from 2-of-2 to include the hardware and become a 2-of-3 after a Delay and Notify period. All key material associated with the unilateral spending path 625 is deleted. In some examples, new Unspent Transaction Outputs (UTXOs), both incoming and change transactions, do not include the additional unilateral spending path 625.

Another approach is to incorporate hardware into the 2-of-2 key configuration, serving as an alternative to the enclave encryption mechanism. In addition to using the enclave key (e.g., the instance of the server key share 645 in the secure enclave of the mobile device 630) for the unilateral spending path 625, the user 605 could create a hardware-encrypted copy of the server key share 645. Here, the hardware acts purely as an encryption device, not a signing device. The user 605 can store the encrypted artifact separately, protecting against the lost phone and cloud scenario and the app unavailable scenario.

Another approach is to allow the app to be installed on multiple mobile devices 630 simultaneously. Subsequent devices would each have the same app key share 640 and server key share 645, but the server key share 645 would be encrypted to the local secure enclave of each device. Each mobile device 630 can have fully functioning apps. Note, this does not allow multiple mobile device 630 to spend together as they have the same key material, but it does allow the user 605 to recover from the lost phone and cloud scenario and the app unavailable scenario if they still have at least mobile device 630 with the app.

In a “bring your own public key” scenario, the user 605 can create their own unilateral spending artifacts by simply providing a public key (e.g., public key 130). These encrypted artifacts can be stored as the user 605 chooses and include an app key share (e.g., app key share 640), server key share (e.g., server key share 645), and wallet descriptor (e.g., xPub). This feature may be better for a power user rather than a majority of users, but shows the flexibility of the systems and methods described herein. In some examples, the wallet descriptor can be combined with a chain code to produce a child key of the public key. Each bitcoin wallet can be and/or use a child key that is derived from a master key.

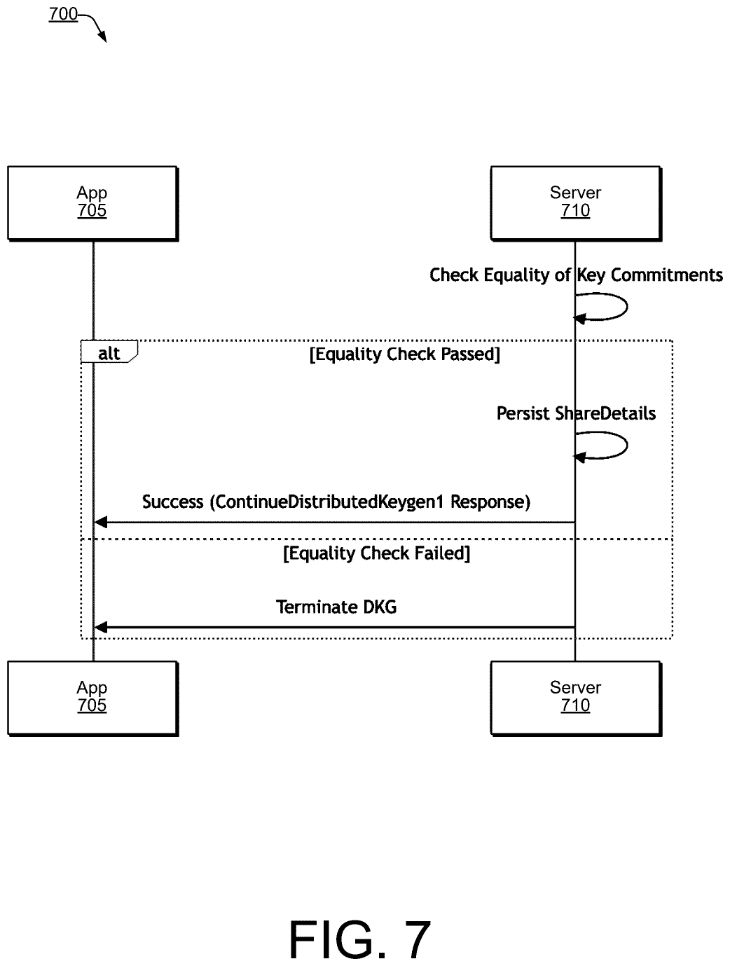

FIGS. 7-16 document outlines recovery mechanisms for the systems and methods discussed herein. The recovery mechanisms can reduce or eliminate the need for specific devices (e.g., hardware wallet) while maintaining secure recovery mechanisms. For instance, the systems and methods discussed herein use a 2-of-3 system, where a hardware wallet (e.g., the third device 115, the hardware wallet 340, the hardware wallet 540), a mobile application (e.g., of the second device 110, the mobile device 305, the mobile device 505, the mobile device 630), and a server (e.g., the first device 105, the server 330, the server 530, the server 615) each hold a private key share (e.g., private key shares 135A-135D), and two of the three private key shares are needed to aggregate a signature to sign for a transaction (e.g., to aggregate two of three of the partial signatures 205A-205D to form the signature 210 and sign for the transaction). By removing one of the devices (e.g., the hardware wallet), new challenges for recovery are introduced, such as contested scenarios and cases where both a mobile device 630 and its cloud backup 635 are lost.

Without three devices (e.g., server 615, mobile device 630, and hardware wallet), recovery becomes more difficult. For instance, if the hardware wallet is removed from the set of devices (e.g., becomes lost, stolen, damaged, destroyed, or otherwise inaccessible), issues can be introduced with use of just the server and mobile device.

One issue that can be introduced if one of the devices (e.g., the hardware wallet) is inaccessible is contested recovery. The hardware wallet helps with contested recovery scenarios, reducing the likelihood of stalemate situations. In a 2-of-2 system, contested recoveries, or other contested actions like canceling an “un-vault” request, become more vulnerable without a strong second factor, increasing the risk of deadlock.

Another issue that can be introduced if one of the devices (e.g., the hardware wallet) is inaccessible is simultaneous loss of application and cloud data. In a 2-of-3 system, losing one factor still leaves two remaining keys for recovery. However, in a 2-of-2 system, losing either key (or key backup) can be catastrophic. If the mobile application and its associated cloud data are lost, recovery can become impossible.

Thus, the systems and methods discussed herein include solutions for a contested recovery and simultaneous loss of application and cloud data, such as use of at least one personal identification number (PIN) Authentication Key (PAK), an emergency access kit (EAK), and/or a time lock.

PINs are often short, for instance typically being four or six digits long, and can thus be inherently weak against brute-force attacks and therefore insufficient for securing cryptographic secrets. To mitigate this, the systems and methods described herein utilize an oblivious pseudo-random function (OPRF) protocol, and in the case of a simultaneous loss of both the mobile application and cloud data, the systems and methods described herein use a combination of a dual OPRF (D-OPRF), Social Recovery, and time-locks.

In a lost app scenario where only the mobile application is lost, the systems and methods described herein leverage an OPRF to generate a PAK. The PAK takes the place of the hardware wallet in the “Delay & Notify” (D&N) process, which is already used for contested recovery. The server 615 cannot brute-force the PIN without access to the user 605's cloud-stored ciphertext (e.g., in the cloud backup 635).

In a lost app and lost cloud recovery scenario in which both the mobile application (of the mobile device 630) and cloud backup 635 are lost, the systems and methods discussed herein an utilize a dual-OPRF (D-ORPF) system between the server 615 and a trusted contact of the user 605. This D-OPRF decrypts a pre-signed transaction (PST), which can spend the wallet's assets (e.g., cryptocurrencies) using a 2-of-2 setup. A time-locked condition can ensure that after a delay (e.g. 7 days), the funds can also be spent using the PIN-based key, ensuring recoverability. A separate emergency access kit (EAK), protects against collusion between the server 615 and the trusted contact by allowing the user 605 to preemptively move funds before the time-lock expires.

In both scenarios, these recovery solutions maintain a high level of security without requiring a hardware wallet (e.g., third device 115, hardware wallet 340, hardware wallet 540). However, the hardware wallet can enhance security further.

Lost app recovery relies on encrypted data stored in the server (e.g., server 615). This data is secured by 2 key shares that are generated using a multi-party computation (MPC) protocol between the mobile application (on the mobile device 630) and the server 615. The server key share 645 can be secured by a Wallet Security Module (WSM), which may be a type of hardware security module (HSM). The user 605's key share is stored in their cloud backup 635. In some examples, the instance of the app key share 640 stored in the cloud backup 635 is not encrypted, but is regularly refreshed using an MPC protocol to invalidate potentially compromised shares (e.g., via key rotation). One approach is to refresh on every new application open event, and to nudge the user 605 to refresh if the server hasn't detected a refresh in a predetermined number of days. In addition, the server 615 verifies that the contents of the encrypted backup are correct, without learning the contents, with an efficient zero-knowledge proof. In some examples, the instance of the app key share 640 stored in the cloud backup 635 is encrypted.

In some examples, backup of the app key share 640 to the cloud backup 635 can use a Threshold Diffie-Hellman protocol, such as Threshold Diffie-Hellman 2 (TDH2) protocol for MPC decryption, as well as a verifiable encryption protocol. In some examples, for privacy reasons, the systems and methods described herein add a chain code in addition to the app key share 640 backup to the contents of the encrypted backup.

In some examples, the chain code is required to recover funds. However, in some examples, access to the chain code can also reveals the entire transaction history of the wallet. By including the chain code in the encrypted backup, the systems and methods described herein can ensure only the user 605 has access to the transaction history, which is not revealed to the server during the recovery process.

FIG. 7 is a swim lane diagram illustrating a process 700 for generating keys using distributed key generation (DKG). The process 700 includes operations performed by an app 705 on a mobile device (e.g., second device 110), operations performed by a server 710, and interactions between the app 705 (e.g., the mobile device) and the server 710.

The distributed key generation (DKG) protocol in the process 700 uses the key generation phase of the TDH2 protocol. When the wallet is first configured, the app 705 and/or server 710 perform a DKG which outputs signing shares, a group signing public key, and verifiable secret sharing (VSS) signing commitments. During the final step of the DKG, the group public key and VSS are sent to the server 710 so the server 710 can perform its equality check.

To implement TDH2, the app 705 and/or server 710 run the DKG in parallel to output encryption shares, a group encryption public key, and VSS encryption commitments. TDH2 also creates a random generator during key generation. For instance, the app 705 and/or server 710 can use the hashing to elliptic curves algorithm in RFC 9380 to derive a random generator from the group public key's x-coordinate and a context string.

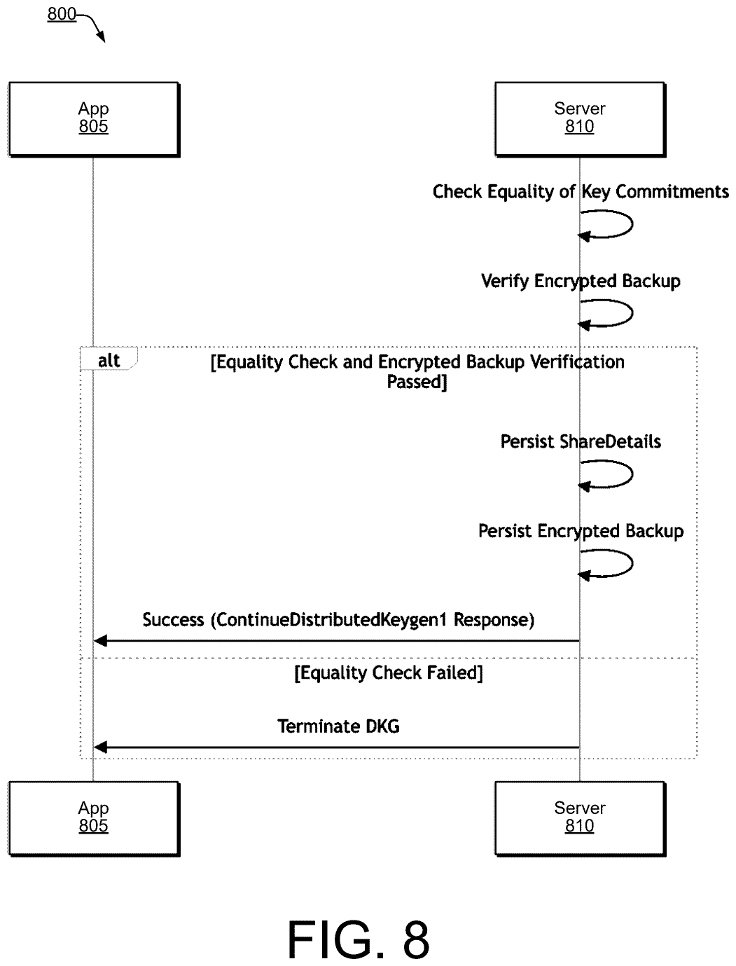

FIG. 8 is a swim lane diagram illustrating a process 800 for generating keys using distributed key generation (DKG), with additional features relative to the process 700 of FIG. 7.

The process 800 modifies the DKG protocol in the process 700 by adding a parallel DKG to generate encryption shares for the app 805 (app_encryption_key_share) and server 810 (server_encryption_key_share) and add the outputs as additional items in the App Share Package and Server Share Package. The process 800 also adds an encrypted backup of the app_signing_key_share and the chain code to the data sent alongside the public key and VSS. The process 800 also adds an additional server check when performing its equality check to verify the encrypted backup.

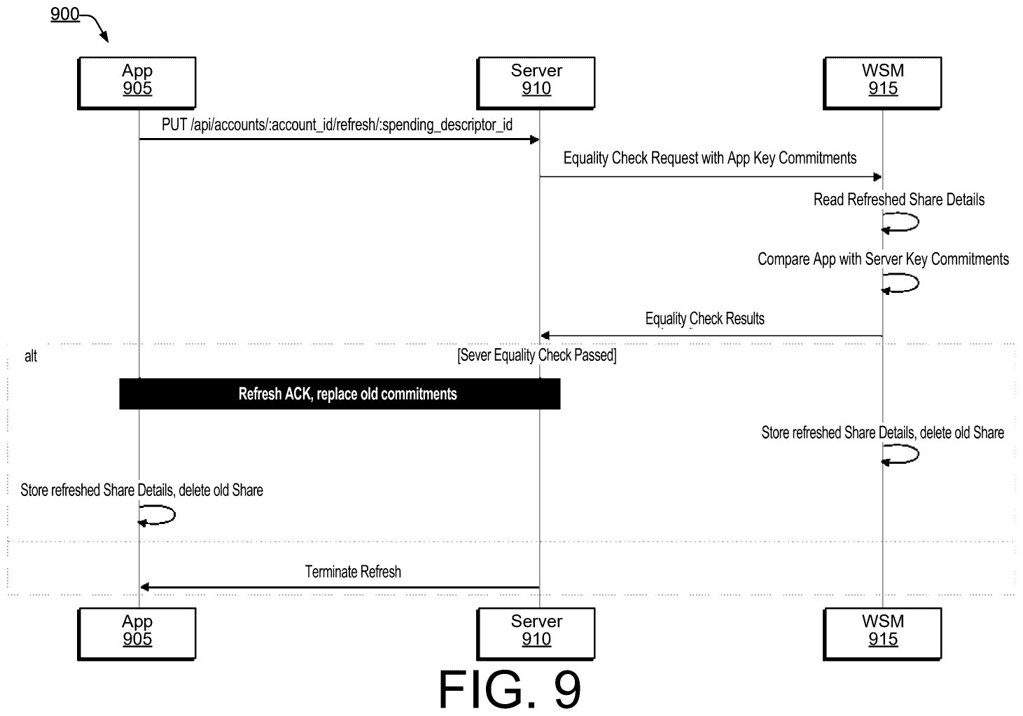

FIG. 9 is a swim lane diagram illustrating a process 900 for refreshing keys using distributed key generation (DKG). The process 900 involves interactions between an app 905 (e.g., app 315, app 515, app 705, app 805) of a mobile device (e.g., second device 110, mobile device 305, mobile device 505, mobile device 630), a server 910 (e.g., first device 105, server 330, server 530, server 615, server 710, server 810), and a WSM 915 associated with the server 910.

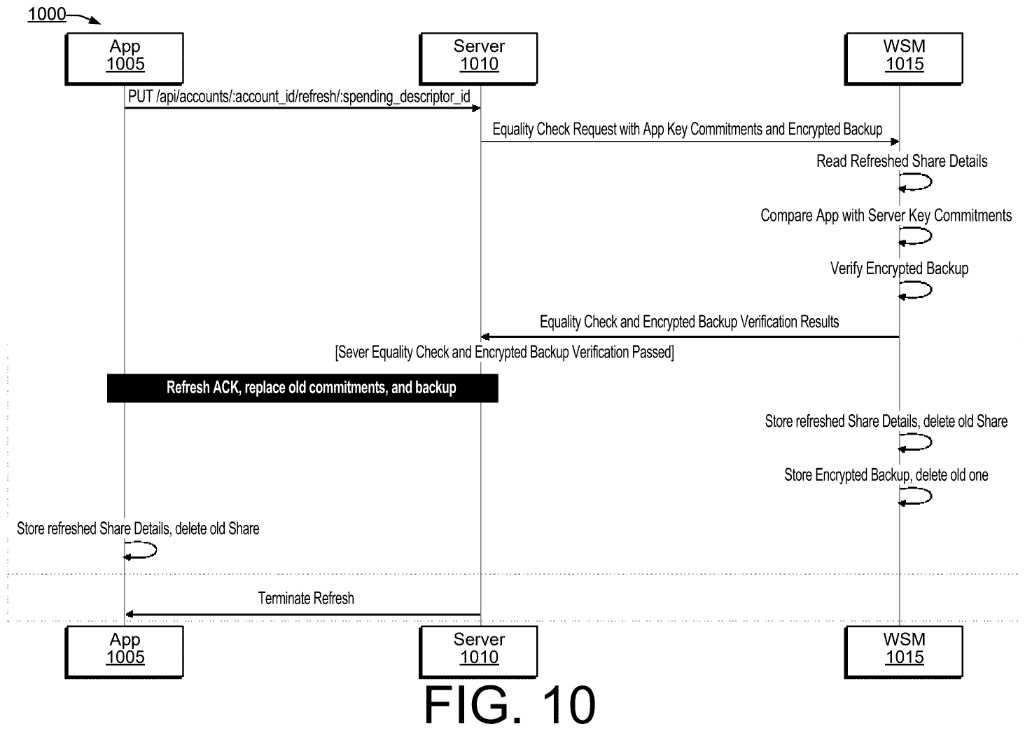

FIG. 10 is a swim lane diagram illustrating a process 1000 for refreshing keys using distributed key generation (DKG) with additional features relative to the process 900 of FIG. 9. The process 1000 involves interactions between an app 1005 (e.g., app 315, app 515, app 705, app 805, app 905) of a mobile device (e.g., second device 110, mobile device 305, mobile device 505, mobile device 630), a server 1010 (e.g., first device 105, server 330, server 530, server 615, server 710, server 810, server 910), and a WSM 1015 (e.g., WSM 915) associated with the server 1010. The process 1000 for refreshing keys includes modifications relative to the process 900 for refreshing keys. For instance, the 1000 includes an additional encrypted backup along with an additional commitment vector, and an additional check of verifying the encrypted backup when the server 1010 performs its equality check. When the refresh protocol of process 1000 is considered successful and complete, the server 1010 deletes both its stale signing key share along with the stale encrypted backup.

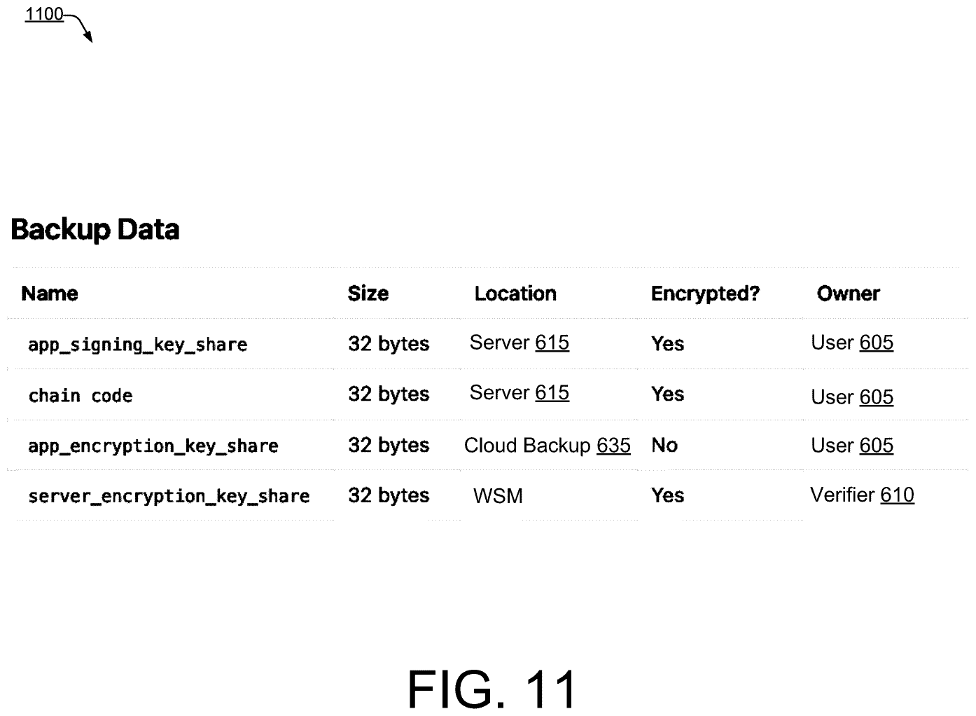

FIG. 11 is a table 1100 illustrating backup data being stored at different locations (e.g., different devices). For instance, the app_signing_key_share is 32 bytes in size, is stored at the server (e.g., server 615), is encrypted, and is owned by the user 605. The chain code is 32 bytes in size, is stored at the server (e.g., server 615), is encrypted, and is owned by the user 605. The app_encryption_key_share is 32 bytes in size, is stored at in the cloud (e.g., cloud backup 635), is not encrypted, and is owned by the user 605. The server_encryption_key_share is 32 bytes in size, is stored at the WSM (e.g., WSM associated with the server 615, WSM 915, WSM 1015), is not encrypted, and is owned by the verifier 610.

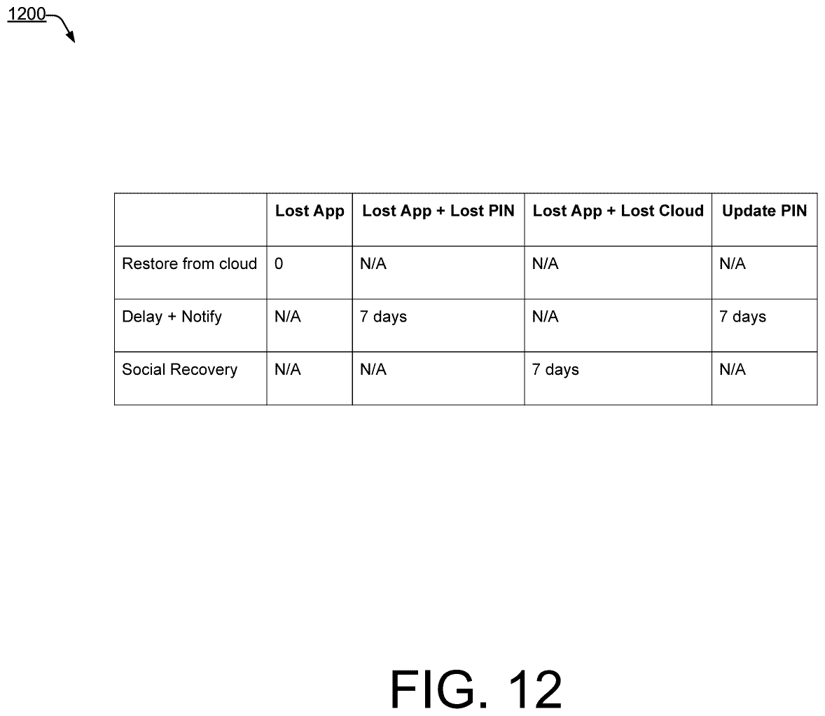

FIG. 12 is a table 1200 illustrating delays in recovery for restoration and/or recovery functionality in different scenarios.

In some examples, restoring from cloud (e.g., from cloud backup 635) in a lost app scenario has a 0-day delay. In some examples, the D&N for a lost app and lost PIN scenario is has a 7-day delay. In some examples, the D&N for an update PIN scenario is has a 7-day delay. In some examples, a social recovery (e.g., via a trusted contact) in a lost app and lost cloud scenario has a 7-day delay.

In some examples, a delay & notify (“D&N”) process is used when a customer performs a Lost App recovery. In some examples, a hardware wallet (e.g., third device 115, hardware wallet 340, hardware wallet 540) can be used to resolve a contested recovery. In some examples, a PIN Authentication Key (PAK) can be used to resolve contested recovery.

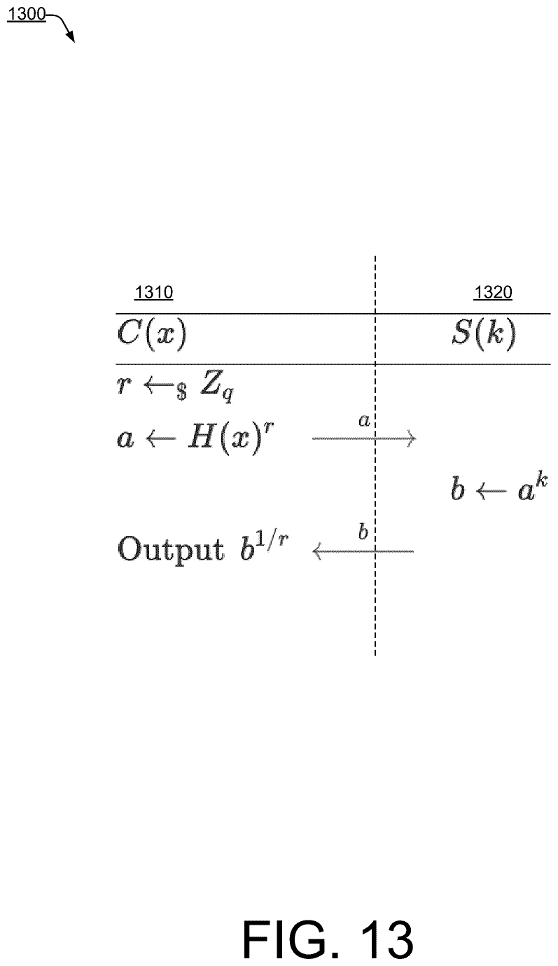

FIG. 13 is a swim lane diagram illustrating a process 1300 for a hashed Diffie-Hellman oblivious pseudorandom function (OPRF). A hashed Diffie-Hellman OPRF is illustrated in FIG. 13. In FIG. 13, C (x) is the customer 1310, in this case the mobile application (e.g., second device 110, app 315, app 515), and S (k) is the server 1320 (e.g., first device 105, server 330, server 530, server 615, server 710, server 810, server 910, server 1010).

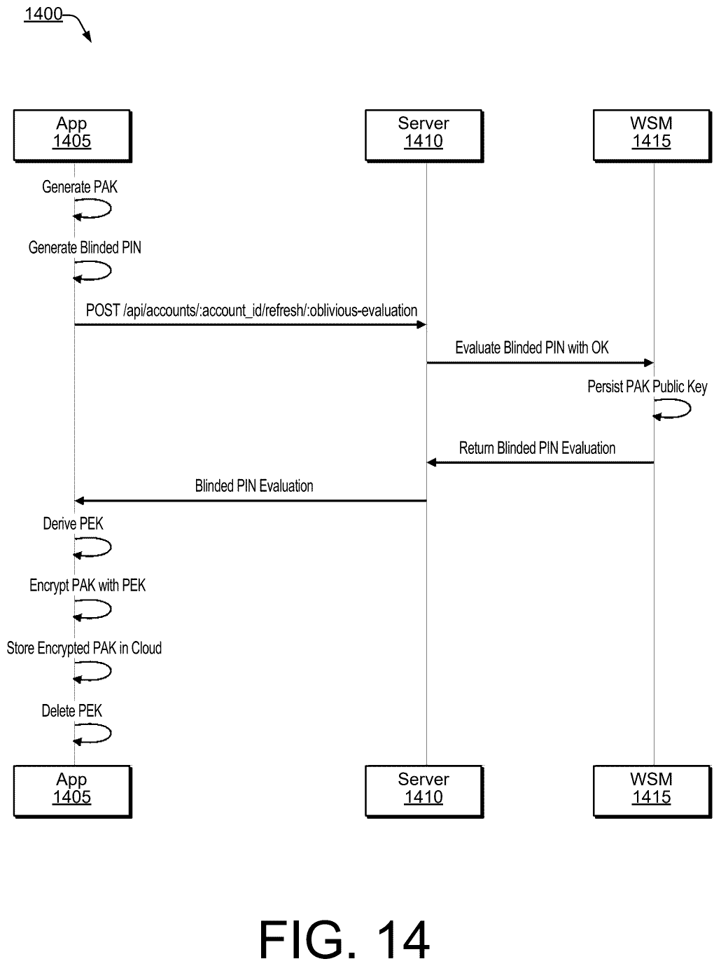

FIG. 14 is a swim lane diagram illustrating a process 1400 for PIN Authentication Key (PAK) registration. The systems and methods described herein utilize an OPRF to make the PIN difficult to brute-force both for the server 1410 (e.g., first device 105, server 330, server 530, server 615, server 710, server 810, server 910, server 1010) and external attackers. In the OPRF protocol, the WSM 1415 (e.g., WSM 915, WSM 1015) generates a secret OPRF key (OK) for each user 605. Then the mobile application 1405 (e.g., app 315, app 515, app 705, app 805, app 905, app 1005) sends the WSM 1415 a blinded PIN. The WSM 1415 then computes a strong key using the OPRF that is derived from the blinded PIN and returns the blinded result to the mobile application 1405. The mobile application 1405 unblinds the result to get the PIN Encryption Key (PEK). The mobile application 1405 generates a PAK and encrypts the PAK with the PEK, and stores the encrypted PAK in the cloud (e.g., in the cloud backup 635), and in some cases deletes the PEK.

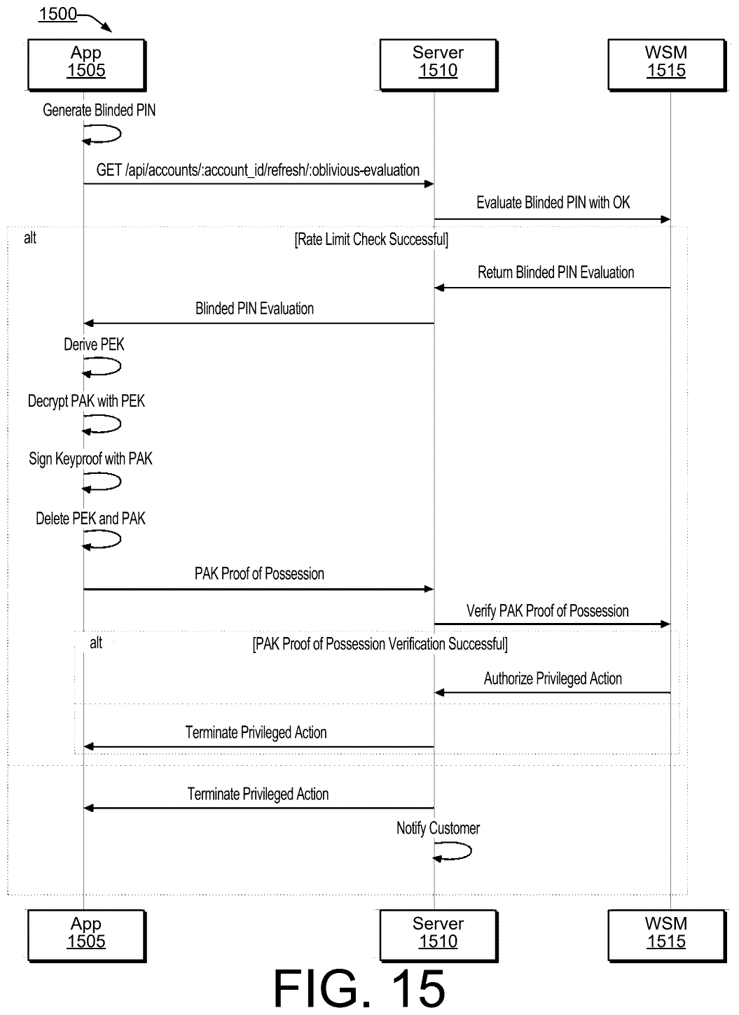

FIG. 15 is a swim lane diagram illustrating a process 1500 for using PIN Authentication Key (PAK) to perform a privileged action. As long as the user 605 has access to their cloud data and their PIN, they can use the OPRF of the server 1510 (e.g., first device 105, server 330, server 530, server 615, server 710, server 810, server 910, server 1010, server 1410) to derive their PEK, and then use the PEK to decrypt the PAK stored in the cloud (e.g., cloud backup 635), and sign with the PAK to authorize the privileged action (e.g. D&N cancellation). The public key for the PAK is registered with the server during the initial wallet onboarding.

The server's OPRF endpoint is rate-limited to prevent external brute-force attacks. A policy that rate limits at 10 queries per hour per account and 300 queries per month would require 1.4 years to brute-force a 4-digit PIN. These parameters can be adjusted as needed as needed to find a balance between API accessibility, brute-force resistance, and PIN length. A 6-digit PIN can be preferable to a 4-digit PIN to help protect the user 605 (compared to very common and/or frequently reused 4-digit PINs), while still being a manageable length.

In some examples, the app 1505 (e.g., app 315, app 515, app 705, app 805, app 905, app 1005, 1405), server 1510, and/or WSM 1515 (e.g., WSM 915, WSM 1015, 1415) can implement a per-IP address rate limit is useful to prevent attackers from maliciously using up the rate-limit to prevent genuine attempts at recovery by the user 605. In some examples, the app 1505, the server 1510, and/or the WSM 1515 can also require a signature from an evaluation request key (ERK) that is stored in the cloud backup 635 of the user 605, so that an attacker must compromise the cloud backup 635 of the user 605 to attempt an OPRF evaluation with a guessed PIN.

In some examples, the app 1505, the server 1510, and/or the WSM 1515 can avoid key rotations to prevent an attacker with access to the cloud backup 635 of the user 605, and knowledge of the PIN of the user 605 from locking out the user 605. In this case, contested recovery escalates to control of communication channels as part of the D&N process, and potentially a stalemate.

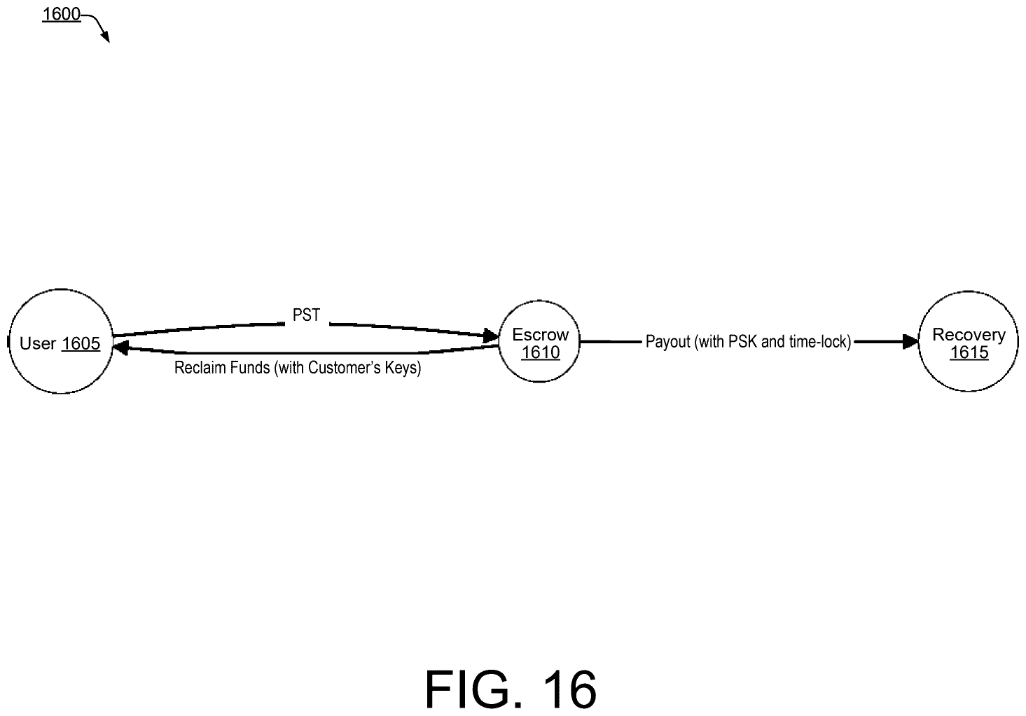

FIG. 16 is a block diagram illustrating a process 1600 for reclaiming assets.

In a lost app and lost cloud scenario, social recovery using a trusted contact of the user 1605 (e.g., user 605) can be used to help the user 1605 recover access to their assets. Without additional hardware (e.g., third device 115, additional device(s) 120, hardware wallet 340, hardware wallet 540), the only information the user 1605 possesses is their PIN. However, in the lost app and lost cloud scenario, the systems can no longer rely on the PAK, because it depends on cloud data (e.g., from the cloud backup 635)

Social recovery with a trusted contact provides another recovery option in this scenario. Because loss of cloud data is part of this loss scenario, this social recovery scheme is based on a PIN. To mitigate against collusion risk between the trusted contact and the verifier 610, the social recovery scheme relies on an encrypted PST with a time-locked clawback mechanism.

In some examples, the process 1600 can use a pre-signed time-locked sweep transaction to help the user 1605 reclaim assets. Whenever the user 1605 receives or spends a UTXO, the mobile application (e.g., app 315, app 515, app 705, app 805, app 905, app 1005, mobile application 1405, app 1505) creates a transaction that spends all of the wallet's UTXOs to an output with two spending conditions. The first spending condition allows the output to be spent with the wallet's existing 2-of-2 keys. This is the clawback mechanism that can be used if the user 1605 did not intend for the pre-signed transaction to be broadcast. The second spending condition allows the output to be spent from a PIN Spending Key (PSK), using a D-OPRF between the trusted contact and the server. However, this spending condition also imposes a 7-day time-lock that doesn't start tolling until the pre-signed transaction is broadcast.

This transaction is then signed by the mobile application's key share (e.g., app key share 640) and encrypted with a key derived from the customer's PIN and the D-OPRF. Lastly, the encrypted PST is sent to the server for storage in the server. The funds are put in escrow 1610 and eventually paid out, and the user 1605 achieve recovery 1615. In some examples, the system can derive the public key from the dual OPRF such that the private key isn't computed until and unless it is needed to sign for the pre-signed transaction.

To brute-force the PSK, both the server (e.g., first device 105, server 330, server 530, server 615, server 710, server 810, server 910, server 1010, server 1410, server 1510) and the trusted contact need to collude by running the D-OPRF protocol with every possible PIN combination. However, funds can only be spent with PSK after the time-lock expires. If the user 1605 detects the PST was broadcast maliciously, the user 1605 can use the EAK to move the funds before the time-lock expires (see Watchtowers below).

As noted above, the PST may need to be updated when UTXOs are sent or received.

For sending, the mobile application updates the PST whenever the mobile application signs a transaction. The server retains all encrypted PSTs it receives from the mobile application until it receives an acknowledgment from the mobile application that a PST can be deleted. The system can either accumulate the old state indefinitely, or build a configuration to have the mobile application monitor the blockchain to make sure the new UTXOs are confirmed before sending an acknowledgment to the server that it can delete a PST.

For receiving, the new UTXO is not available in Lost App+Cloud recovery until the customer opens their mobile application to update the PST. Whenever the server detects that the wallet received funds, the server sends a push notification to the customer's device instructing them to open their mobile application. The server continues to send notifications at a regular frequency (e.g. every few days), potentially escalating to email and SMS, until it receives an updated PST.

Even with the aid of advanced cryptographic techniques, it is difficult to implement a blockchain monitoring and notification system that is run by a server without leaking the customer's address information to that server. However, as described above, such a notification system is required to ensure the PST is consistently updated.

To address this issue, a trusted execution environment (TEE) in a server can be used. An example is the AWS® Nitro Secure Enclave (NSE). This can be built within WSM, which can be built on a TEE. In some examples, a TEE module can be used that is dedicated to blockchain monitoring.

Whenever a user 1605 generates a new address, they encrypt is using the TEE's public key. The encrypted address is sent to the TEE after the customer verifies the TEE's attestation document and embedded public key, which should authenticate the public key used for encryption to bind the attested code to the encryption process. These encrypted addresses are stored in the TEE.

The server can provide deposit notifications with a blockchain polling worker that runs in the server. The server can update this worker to send blocks, as it discovers them, to the TEE. Whenever the TEE receives a new block, it checks for UTXOs received by customers by querying the list of encrypted addresses, which it is able to decrypt within the TEE. The TEE returns a map of block hashes and customer account IDs that disclose the blocks in which customers received UTXOs. However, this map does not reveal which specific transactions within each block belong to each customer.

To improve block syncing time within the TEE, a block checkpoint can be hard-coded and periodically updated. All blocks up to the checkpoint are trusted as valid. These checkpoints are verifiable by customers because they are embedded in the code referenced in the attestation document. In some examples, Simplified Payment Verification (SPV) of block headers is sufficient for the TEE to authenticate chain data, rather than full block validation.

The process for enrolling a trusted contact and initiating recovery can a secure password-authenticated key exchange 2 (SPAKE2) authentication method. In some examples, upon recovery 1615, the trusted contact returns their OPRF output in the SPAKE2 channel instead of a decrypted key.

In some examples, the D-OPRF is implemented by having each trusted contact secure an OPRF key in addition to WSM. A protected user 1605 can request a blinded PIN from a trusted contact's OPRF using the SPAKE2 secure channel. Each trusted contact stores their own OK in their cloud and uses it to initialize their OPRF.

When the protected user 1605 receives a blinded PIN from both the server and a trusted contact, the app unblinds the results and then uses them both as inputs to a hash-based message authentication code (HMAC) key derivation function (HKDF), along with a context string, to derive the PSK.

To defend against collusion risk between the trusted contact and the server, the user 1605 can monitor the blockchain to detect the broadcast of the pre-signed transaction. The systems and methods described herein provide the user 1605 with several ways to perform this monitoring: (1) the user 1605 can be provided a link to a block explorer tied to the transaction ID, (2) the mobile application can check for this transaction when it is opened, and (3) the verifier 610 (e.g., the server 615) can run a watchtower service to monitor for the transaction ID.

In some examples, a separate watchtower service can provide the user 1605 with additional assurance. The user 1605 can also run their own watchtower if they have access to a bitcoin full-node. In the event that the user 1605 detects that both the verifier 610 and the trusted contact are colluding against them, the user 1605 can use their EAK to move their funds, even without the cooperation of the verifier 610.

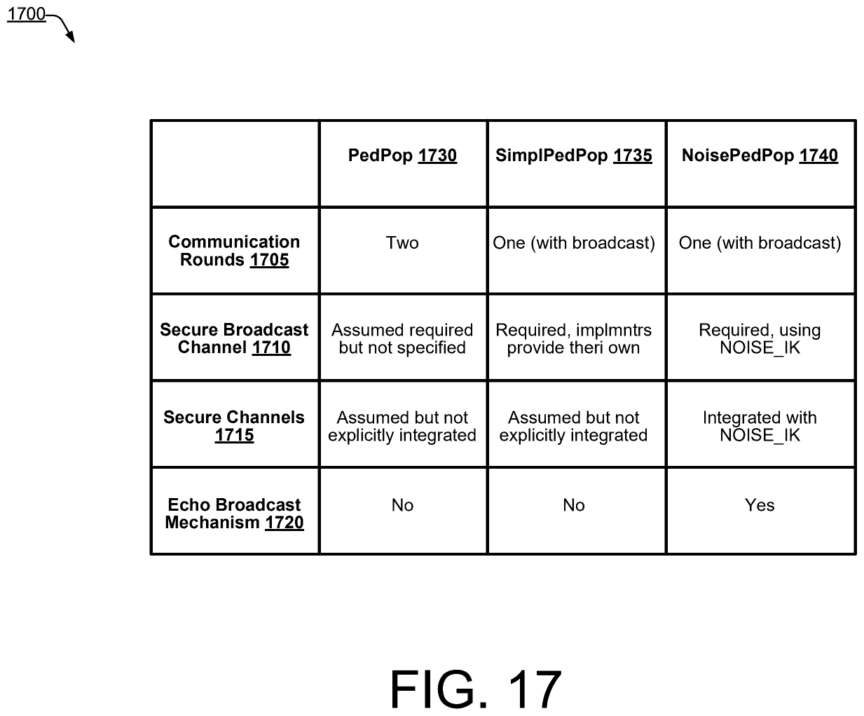

FIG. 17 is a table illustrating a comparison between different distributed key generation (DKG) protocols. The DKG protocols including a Pedersen-style DKG protocol (PedPop 1730), a refined Pedersen-style DKG protocol (SimplPedPop 1735), and a further refined Pedersen-style DKG protocol (NoisePedPop 1740) that provides integrated secure communication channels.

Traditional multi-signature cyptocurrency wallets (e.g., Bitcoin wallets) typically involve each participant in a collaborative custody setup holding a unique key. To authorize spending (and/or other transfers), the wallet relies on a script that mandates the presentation of a quorum of valid signatures from the associated public keys. While effective, this approach has notable limitations.

Firstly, when an output is spent, the entire script—including all public keys—is revealed on-chain. This increases transaction costs due to additional data and reduces privacy by exposing the wallet's multi-signature arrangement. Secondly, changing the set of signers similarly necessitates a “sweep” transaction-moving all funds to a new wallet, a process that can be cumbersome, expensive, and privacy revealing. Thirdly, in certain key arrangements, a lost key requires a sweep to a new wallet using the remaining keys.

To mitigate these issues, the systems and methods described herein leverage Multi-Party Computation (MPC) to manage multi-signatures off-chain. In some examples, the systems and methods described herein can use the Flexible Round-Optimized Schnorr Threshold Signatures (FROST) protocol, or a modified variant thereof. FROST provides an efficient and secure framework for threshold cryptography in collaborative settings. FROST enables participants to collaboratively generate valid Schnorr signatures verified against a single public key, without ever assembling the corresponding private key, and without revealing their individual private key shares.

As a result, transactions become more cost-effective by encoding fewer keys and signatures. Additionally, they are more private, revealing no details about the multi-signature arrangement on-chain. Furthermore, FROST is compatible with protocols that facilitate seamless secret refreshes and configuration changes, enabling the replacement, removal, and addition of keys entirely off-chain. This avoids moving funds, incurring fees, linking UTXOs, or losing access to previous addresses whenever changes to the key set are required. An especially valuable application of this capability is the ability to update a wallet by seamlessly adding or removing hardware devices.

FROST includes two main components: a Distributed Key Generation (DKG) protocol and a signing protocol that enables signature aggregation among participants.

FROST is traditionally used with an enhanced Pedersen-style DKG protocol, referred to as PedPop 1730. The PedPop 1730 protocol incorporates proofs of possession to safeguard against rogue key attacks. The PedPop 1730 protocol requires two communication rounds 1705 and assumes the availability of a secure broadcast channel 1710 and/or secure channels 1715.

The SimplPedPop 1735 protocol is a refined version of the PedPop 1730 protocol that reduces the required communication rounds and ads a final broadcast phase, relative to the PedPop 1730 protocol. This broadcast ensures unanimous agreement on the final public key among all participants, streamlining the DKG process and helping to guard against active adversaries. However, like the PedPop 1730 protocol, the SimplPedPop 1735 protocol still requires implementers to provide their own secure broadcast channel 1710 and/or secure channels 1715.

The systems and methods described herein introduce a new variant that is further refined relative to the PedPop 1730 protocol and the SimplPedPop 1735 protocol, referred to as the NoisePedPop 1740 protocol. The NoisePedPop 1740 protocol integrates the round optimization from the SimplPedPop 1735 protocol employs an echo broadcast mechanism 1720 to guard against active adversaries. Additionally, the NoisePedPop 1740 protocol utilizes a NOISE IK protocol to provide integrated secure channels 1715 for communication, effectively addressing the need for a secure broadcast channel 1710 within the NoisePedPop 1740 protocol.

The app (on the mobile device 630) and server (e.g., first device 105, server 330, server 530, server 615, server 710, server 810, server 910, server 1010, server 1410, server 1510, server 1920) engage in three stages of DKG in order to generate an aggregate public key and VSS (Verifiable Secret Sharing) commitments.

During a key share generation stage, the app (on the mobile device 630) generates a proof of possession (R₁, σ₁), a list of coefficient commitments to its polynomial \vec{C}₁, and an intermediate share, f₁(2). The server 615 does the same, generating a proof of possession (R₂, σ₂), a list of coefficient commitments to its polynomial \vec{C}₂, and an intermediate share, f₂(1). Note, \vec{C}₁= [symbol] φᵢ₀, φᵢ₁ [symbol] , and each φᵢ₁ is called a coefficient commitment. In a communication round, both the app (at the mobile device 630) and server 615 send [symbol] (\tilde{R}ᵢ, \tilde{σ}ᵢ), \vec{C}₁, fₑ( [symbol] ) [symbol] to each other.

During a key share aggregation stage, the app (on the mobile device 630) and the server 615 validate the coefficient commitments and the proof of possession to ensure that the provided intermediate share is valid. Then, they assemble their own Shamir share by taking the sum of the intermediate shares they have:

$${s}_{i} = {\prod }_{ℓ = 1}^{2} {f}_{i} ( l ) .$$

Additionally, they take the first element of the coefficient commitment given to them, and add it to their own to obtain the aggregate public key:

$$Y = {\prod }_{l = 1}^{2} {ϕ}_{10} .$$

Lastly, they each compute the aggregate VSS commitments:

$$\vec{C} = 〈 {\prod }_{ℓ = 1}^{2} {ϕ}_{ℓ0} , {\prod }_{ℓ = 1}^{2} {ϕ}_{ℓ1} 〉 .$$

During an equality check stage, in a broadcast round, the app (on the mobile device 630) and the server 615 send \vec{C} and Y to each other, and ensure that the one they computed is the same as the one they receive from each other. The DKG is only considered a success and completed once both app (on the mobile device 630) and the server 615 performs this equality check. Both the communication and broadcast rounds would be done through a secure channel based on NOISE IK.

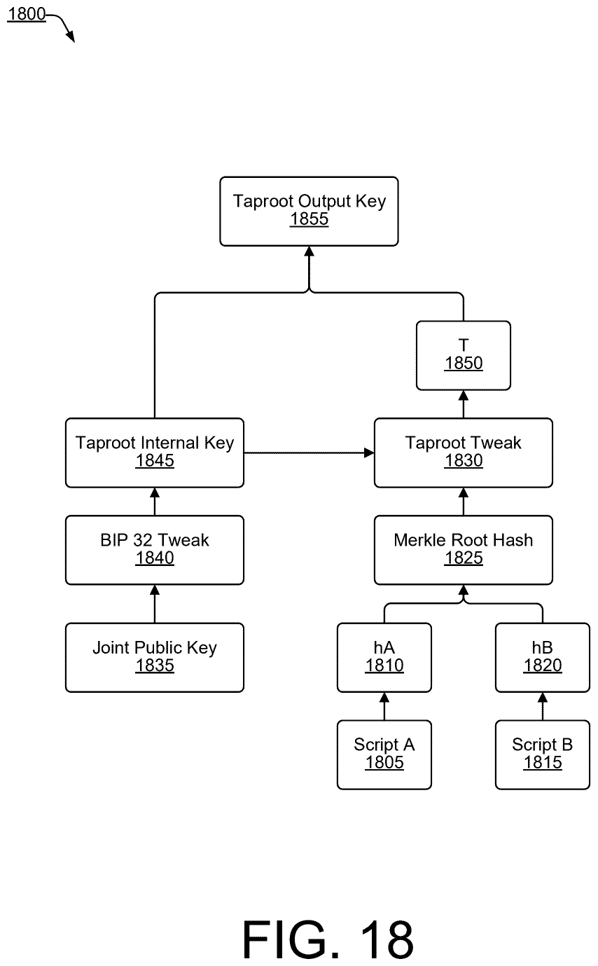

FIG. 18 is a flow diagram illustrating a process 1800 for key tweaking. The process 1800 for key tweaking is associated with Bitcoin and/or FROST.

To prevent address reuse in Bitcoin, wallets can use the Bitcoin Improvement Proposal 32 (BIP32) protocol to derive child key pairs for different outputs. In the context of Taproot transactions, derived public keys can require an additional “tweak” to obtain a Taproot output key, which is then encoded to generate a receive address.

A secure system (e.g., the mobile device 630, the server 615) applies a BIP 32 tweak 1840 (t_{b32}) to a joint public key 1835 to generate a taproot internal key 1845 Ŷ according to the equation Ŷ=Y·t_{b32}. The system checks if the y-coordinate (Ŷ_{y}) of the taproot internal key 1940 (Ŷ) is even (Ý_{y}|2). If it isn't, the system negates the y-coordinate, with the resulting value being referred to as \hat{t}. This check is performed as follows:

$$\hat{t} = \{ \begin{matrix}{t}_{b 32} & if {\hat{Y}}_{y} \vert 2 \\ - {t}_{b 32} & else\end{matrix}$$

Additionally, the system holds on to the parity bit for use in signing later, thus:

$$π = \{ \begin{matrix}0 & if {\hat{Y}}_{y} \vert 2 \\ 1 & else\end{matrix}$$

Then, the system adds the \hat{t} computed above with the taproot tweak 1830 (t_{xonly}) to obtain the final tweak 1850 (\tilde{t}), according to equation: \tilde{t}=\hat{t}+t_{xonly} mod q. The taproot tweak 1830 (t_{xonly}) is based on a merkle root hash 1825 that is generated using a hash hA 1810 of a Script A 1805 and a hash hB 1820 of a Script B 1815.

Next, the system negates to make sure Y′ has an even y-coordinate before tweaking it with the Taproot key to obtain the Taproot output key 1855 (\tilde{Y}). This would be encoded to give the system a Bitcoin address thus:

$${Y}^{′} = \{ \begin{matrix}\hat{Y} & if {\hat{Y}}_{y} \vert 2 \\ - \hat{Y} & else\end{matrix}$$

$$\tilde{Y} = {Y}^{′} + {g}^{{t}_{xonly}}$$

Lastly, the system negates the value of t based on the parity of \tilde{Y}_{y} to produce

$$t = \{ \begin{matrix}\tilde{t} & if {\tilde{Y}}_{y} \vert 2 \\ - \tilde{t} & else\end{matrix}$$

In order to produce a signature, the system computes the Taproot output key 1855 (\tilde{Y}) and the parity bit π, which are used in signing.

The app (of the mobile device 630) and the server 615 independently compute the Taproot output key 1855 (\tilde{Y}) and parity bit π. The Taproot output key 1855 (\tilde{Y}) and parity bit π can be as inputs to a signing protocol, also referred to as a signature aggregation protocol.

The signing protocol generates a valid Schnorr signature and is achieved through a secure aggregation process where each participant contributes to the final signature in such a way that the aggregate signature remains indistinguishable from a standard Schnorr signature. In some examples, the verification of signatures produced using FROST is identical to the conventional Schnorr signature verification procedure, making it compatible with BIP340 and BIP341 protocols.

In some examples, the signing protocol works as follows. In some examples, the signing protocol is modified to facilitate blind signing as discussed herein. At a nonce generation stage of the signing protocol, the app (of the mobile device 630) and the server 615 generate nonces (dₐ, eₐ) [symbol] [symbol] × [symbol] _{q} and (dₛ, eₛ) [symbol] [symbol] _{q}× [symbol] _{q}, respectively. The app (of the mobile device 630) and the server 615 compute their nonce commitments (Dᵢ, Eᵢ)=(g^{d}^{ᵢ}, g^{e}^{ᵢ}) and send them to each other.

At a signing stage of the signing protocol, once the app (of the mobile device 630) and the server 615 receive nonce commitments from each other, the app (of the mobile device 630) and the server 615 first check ( [symbol] , [symbol] )∈ [symbol] . Where [symbol] is the group of prime order q, and [symbol] is the index of their counterparty. The app (of the mobile device 630) and the server 615 both aggregate their own nonce commitments with their counterparty's:

$$D ← {\prod }_{ℓ = 1}^{2} {D}_{ℓ} and E ← {\prod }_{ℓ = 1}^{2} {E}_{ℓ} .$$

These values define ρ=(D, E). Both the app (of the mobile device 630) and the server 615 then compute a binding value b such that b=Hₙₒₙ(\tilde{Y}∥1∥2∥ρ∥m) and m is the message. This binding value b is used to derive the group commitment R=D·E^{b}. Additionally, the app (of the mobile device 630) and the server 615 can use R to compute a challenge c=H_{sig}(\tilde{Y}∥R∥m). At this point, the app (of the mobile device 630) and the server 615 have all they need to construct their partial signature thus: σᵢ=dᵢ+(eᵢ·b)+\tilde{s}ᵢ·λᵢ·c. Here, \tilde{s}ᵢ=−sᵢ if \tilde{Y}_{y}|2≠p, else \tilde{s}ᵢ=sᵢ, where sᵢ refers to the respective participant's secret share. λᵢ refers to a Lagrange coefficient such that

$${λ}_{i} = {\prod }_{j ∈ \{ 1 , 2 \} / \{ i \}} \frac{j}{j - i} .$$

The app (of the mobile device 630) and the server 615 can now each send their partial signatures, σᵢ, to each other.

At a signature aggregation stage of the signing protocol, once the app (of the mobile device 630) and the server 615 receive partial signatures from each other, the app and the server 615 need to validate the responses. The and the server 615 do this validation as follows:

$${g}^{{σ}_{t}} {D}_{ℓ} \cdot {( {E}_{ℓ} )}^{b} \cdot {Y}_{ℓ}^{c \cdot {λ}_{ℓ}} . Here , {y}_{ℓ} = {\prod }_{k = 0}^{1} {ϕ}_{k}^{{ℓ}^{k}} .$$

When both the app (of the mobile device 630) and server 615 are convinced they have valid partial signatures, the partial signatures can be aggregated into a full signature thus:

$$σ = {\sum }_{ℓ = 1}^{2} {σ}_{ℓ} + ct .$$

The app and/or the server 615 can publish the signature, (σ, R).

Key refreshes generate a new set of cryptographic keys that are entirely incompatible with any previous key material. This mechanism plays a critical role in mitigating attacks. An adversary attempting to achieve a signing quorum must gather multiple artifacts from various participants. In instances where only partial key material is compromised, key refreshes ensure that the exposure is temporary, and once all participants have refreshed and discarded their old keys, previously compromised keys become obsolete.

Notably, the refresh process is performed entirely off-chain and can occur frequently, potentially every time the application comes online. Key refreshes are accomplished using the Refresh Protocol in Proactive Secret Sharing (PSS).

Like Distributed Key Generation (DKG), key refreshes take a similar, 2-round, 3-step procedure, including: (1) a generation stage, (2) an aggregation stage, and (3) an equality check stage.

At the generation stage of the key refresh protocol, the app (of the mobile device 630) and the server 615 generate a random value

$${a}_{i 1}^{′} ← {ℤ}_{q} .$$

They use this as the coefficient to their refresh polynomial,

$${f}_{i}^{′} such that {f}_{i}^{′} ( x ) = {a}_{i 1}^{′} x .$$

The app (of the mobile device 630) and the server 615 each evaluate three values. The first value is an intermediate share of their refresh polynomial evaluated at their index:

$${f}_{i}^{′} ( i ) = {a}_{i 1}^{′} \cdot i .$$

Each system keeps this first value for itself. The second value is an intermediate share of their refresh polynomial evaluated at their counterparty's index:

$${f}_{i}^{′} ( ℓ ) = {a}_{i 1}^{′} \cdot ℓ .$$

The third value is a commitment to the coefficient of their refresh polynomial φ′ᵢ₁=_{g}a′i1. In a communication round, both the app (of the mobile device 630) and the server 615 share the refresh package,

$$〈 {ϕ}_{i 1}^{′} , {f}_{i}^{′} ( ℓ ) 〉 ,$$

with each other.

At the aggregation stage of the key refresh protocol, once both the app (of the mobile device 630) and the server 615 receive refresh packages from each other, they first need to validate the refresh packages. The app and server do this by ensuring that the coefficient commitment does indeed correspond to the intermediate share:

$${g}^{{f}^{′} {ℓ}^{( i )}} {ϕ}_{ℓ 1}^{{r}^{i}} .$$

If and only if the verification succeeds, both the app and server proceed to compute their refreshed share thus:

$${s}_{i}^{′} = {s}_{i} + {\sum }_{ℓ = 1}^{2} {f}_{ℓ}^{′} ( i ) .$$

Additionally, the app and/or the server update their VSS commitments thus:

$$〈 {\vec{C}}^{′} = {ϕ}_{0} , {ϕ}_{1} \cdot {\prod }_{ℓ = 1}^{2} {ϕ}_{ℓ}^{′} 〉 .$$

In a broadcast round, both the app and the server then store (but do not replace) their refreshed share

$${s}_{i}^{′} ,$$

and send the updated VSS commitment, \vec{C}′, with each other.

At the equality check stage of the key refresh protocol, the app (of the mobile device 630) and the server 615 independently verify that the VSS commitment they obtained with their counterparty matches what they've computed, thus:

$$\vec{\hat{C}} ← {P}_{ℓ}$$

$${\vec{C}}^{′} \vec{\hat{C}}$$

If and only if this equality check passes, the app and/or server securely store and update the cloud backup with the new refreshed share

$${s}_{i}^{′} and {\vec{C}}^{′} .$$

Adding a new key to the key setup can be accomplished using the Repair Protocol in Proactive Secret Sharing (PSS). This is useful for setups where the user may want to expand beyond using just the mobile app and server, and add a third offline device to the collaborative custody setup.

In this instance, the systems and methods described herein use the Refresh protocol in PSS to eliminate the on-chain visibility of signer updates. This means key configuration changes can occur without creating a transaction, allowing users to avoid fees and maintain privacy throughout the process.

In a k-of-n multi-signature setup where k<n, users who lose one of the signing devices within the quorum need to re-establish a key share. This process does not introduce any novel protocols beyond those already discussed. Specifically, to repair a key share, the quorum of signers first conducts the Refresh Protocol to invalidate the lost share. Then, they execute the Repair Protocol to enroll a new key share.

This approach allows for seamless key share recovery without affecting the wallet's on-chain activity, preserving privacy and avoiding transaction fees.

A key enrollment protocol can be used to add a new key. In order to add a new key to the setup, the app (of the mobile device 630) and the server 615 can serve as the threshold of participants needed to come together to collaboratively assemble a set of information for the new signer to derive its share. In the key enrollment protocol, the Lagrange coefficient can be

$${λ}_{i} = {\prod }_{j ∈ \{ 1 , 2 \} ∖ \{ i \}} \frac{j}{j - i} .$$

At the generation stage of the key enrollment protocol, the app (of the mobile device 630) and the server 615 both take their share, and multiply it by the lagrange coefficient λᵢ evaluated at the new participant's index, r: sᵢλᵢ(r). The app and the sever both split this up to additive shares δᵢⱼ such that sᵢλᵢ(r)=δᵢ₁+δᵢ₂. The app and the server then generate repair share commitments \vec{R}ᵢ= [symbol] ψᵢ₁, ψᵢ₂ [symbol] , where ψᵢⱼ=g^{δ}^{ᵢⱼ}. The app and the server keep δᵢ₁ for themselves, and share (δᵢ₂, \vec{R}ᵢ) with each other.

At the aggregate repair share stage of the key enrollment protocol, the VSS commitments is/are

$$\vec{C} = 〈 {\prod }_{ℓ = 1}^{2} {ϕ}_{ℓ 0} , {\prod }_{ℓ = 1}^{2} {ϕ}_{ℓ 1} 〉 ,$$

and φᵢⱼ refers to the coefficient commitment of each participant's i's polynomial such that if fᵢ(x)=aᵢ₁+aᵢ₂x+ . . . +aᵢ₍ₜ₋ₗ₎x^{t-1}, such that φᵢⱼ=g^{a}^{ᵢⱼ}. The app (of the mobile device 630) and the server 615 first both verify the additive share it receives from each other: g^{δ}^{ᵢ₂}=ψᵢ₂. Then, they each verify the repair share by taking the summation of the repair share commitments (\vec{R}) from their counterparty and check that they match the result of the interpolation evaluated with the public verification share of their counterparty, [symbol] , according to the equation: [symbol] ₁· [symbol] ₂ [symbol] [symbol] (r)· [symbol] . Once the verification is complete, both the App and Server assemble an aggregate repair share, ξᵢ, such that ξᵢ=δᵢᵢ+ [symbol] . Finally, both the App and Server share their aggregate repair share (ξᵢ), repair share commitments (\vec{R}), and VSS commitments (\vec{C}) with the new signer.

In the enrollment stage of the key enrollment protocol, the index a refers to the app (of the mobile device 630), and s refers to the server 615. The new signer receives a repair package from the app and server: (ξₐ, \vec{R}ₐ, \vec{C}ₐ)←Pₐ, (ξₛ, \vec{R}ₛ, \vec{C}ₛ)←Pₛ. First, the new signer verifies that the VSS commitments are indeed the same: \vec{C}ₐ [symbol] \vec{C}ₛ. Next, the new signer computes the public verification shares for the app and server thus:

$${Y}_{a} = {\prod }_{k = 0}^{1} {ϕ}_{k}^{{a}^{k}}$$

$${Y}_{s} = {\prod }_{k = 0}^{1} {ϕ}_{k}^{{s}^{k}}$$

Then, the new signer verifies the repair share commitments against the public verification shares they computed, thus:

$${ψ}_{a 1} \cdot {ψ}_{a 2} {λ}_{a} \cdot {Y}_{a}$$

$${ψ}_{s 1} \cdot {ψ}_{s 2} {λ}_{s} \cdot {Y}_{s}$$

Then, the new signer also verifies the aggregate repair share against the repair share commitments, thus:

$${g}^{{ξ}_{a}} {ψ}_{a 1} \cdot {ψ}_{s 2}$$

$${g}^{{ξ}_{s}} {ψ}_{s 1} \cdot {ψ}_{a 2}$$

Once they're both verified, the new signer sums both aggregate repair share to construct the repair share: sᵣ=ξₐ+Ξₛ. Otherwise (else), the process terminates. The new signer then stores both the repair share sᵣ and VSS commitments \vec{C}.

In a k-of-n multi-signature setup where k<n, users 605 who lose one of the signing devices within the quorum need to re-establish a key share. To repair a key share, the quorum of signers first conducts the Refresh Protocol to invalidate the lost share. Then, they execute the Repair Protocol to enroll a new key share.

This approach allows for seamless key share recovery without affecting the wallet's on-chain activity, preserving privacy and avoiding transaction fees. Establishing secure communication channels is essential for a secure FROST-based system implementation. A secure channel refers to a peer-to-peer communication protocol that provides both authenticity and confidentiality guarantees. Since FROST relies on secure channels for key generation, signing, and other critical operations, it is imperative that each participant has a long-term identity to verify they are communicating with the correct party. In some examples, the systems and methods described herein use a secure channel that is based on the NOISE IK protocol, but with Secp256r1 as the Diffe-Hellman function; such a modified NOISE IK protocol can be referred to as Noise IK p256 ChaChaPoly SHA256. This protocol employs Secp256r1 due to Apple's iOS Secure Enclave exclusive support of this curve, which allows us to root the key exchange in the enclave. In some examples, a hardware wallet can also support this same protocol, for instance to allow upgrading from a N-of-N(e.g., 2-of-2) authentication process to a T-of-N(e.g., 2-of-3) authentication process using the hardware wallet.

The Noise framework offers various two-way authentication patterns. Given our requirement for long-term identity verification, patterns involving N (no static key) or X (delayed key transmission) are unsuitable. This leaves K (known static key) and I (immediate key transmission) as options. For the server 615, K can be fulfilled by embedding its long-term identity in the mobile app (of the mobile device 630) and firmware (of the mobile device 630). The mobile app and hardware, lacking an out-of-band communication method, use I, transmitting their static key during the handshake. The server 615 trusts-on-first-use the key on the initial connection, and verifies it on subsequent connections.

Rather than directly embedding the server public key into the firmware and mobile app (of the mobile device 630), the public key can be placed in a certificate with a standard three-tier public key infrastructure (PKI), which can be designed specifically for this purpose. This simplifies server key rotation in case a system is compromised, enabling affected clients to transition into a secure state more easily.

As noted herein, keys are generated, stored, and utilized within our 2-of-2 spending paths. The keys are secured, and FROST can be used to move key management operations off-chain, enhancing both privacy and security. Another important aspect of security is key backup, which ensures both self-sovereignty and recovery from loss.

A loss of the server scenario includes situations where the server becomes inaccessible, becomes uncooperative, attempts to censor transactions, or when the customer simply wishes to exercise full self-sovereignty without relying on the server's participation. To facilitate unilateral control over their funds, the systems and methods described herein provide users with a Self-Sovereign Backup (SSB). The SSB contains the necessary key material to assemble the Self-Sovereign Backup, allowing users to independently access and transfer their funds to any destination of their choosing.

A loss of the app scenario includes situations where the user 605 loses their mobile device 630, and/or the app key share 640 stored on the mobile device 630 is no longer accessible. To address this, the systems and methods described herein securely back up the app key share 640 in a cloud backup 635 associated with the user 605. In some examples, the app key share 640 is encrypted in a manner that does not rely on the mobile device 630, nor is the secret revealed to the server 615. In some examples, the systems and methods described herein also store a backup in the cloud storage (cloud backup 635) of one or more trusted contacts of the user 605.

To ensure the wallet remains self-sovereign, the systems and methods described herein provide users with a self-sovereign backup (SSB). This enables the user 605 to independently recover their funds without relying on the server 615's participation. The SSB works by encrypting the server key share 645 to a public key corresponding to a private key stored within the mobile device's Trusted Execution Environment (TEE). The security of this approach relies on the TEE for two primary reasons: (1) to provide isolation from the application processor, which may have malware; and (2) to enforce customer authentication, such as PIN or biometrics, to gate access to the key.

The combination of these two means that malware cannot secretly access the server key share 645, or the full key (combining the app key share 640, the server key share 645, and/or any other key share(s)). Even if the device's operating system is compromised (assuming the TEE itself remains secure), malware cannot secretly access the key (and/or server key share 645) because any access attempts must prompt for customer authentication within the secure environment. Note that malware present on the mobile device 630 at the time of decryption still poses a security risk. This can be mitigated by encrypting to an external hardware token, instead of a mobile phone TEE.

A trusted execution environment (TEE) is a secure and isolated area within a processor (or within a set of processors) where sensitive data and operations can be processed without being accessible to the main operating system or other applications, providing a high level of security for encryption keys and the like. A TEE provides isolation of sensitive code and data from the rest of the system without relying on external hardware. It ensures that, even if the main operating system or applications are compromised, security-critical resources remain protected.

On iOS devices, the Secure Enclave has been available since the iPhone 5s. For Android devices, the Keystore API is used, but the underlying mechanism can vary. The systems and methods described herein can support at least two security levels depending on type of TEE.

ARM TrustZone is a type of TEE that splits the System-on-Chip (SoC) into two worlds: a “secure world” and a “normal world.” Sensitive operations and data are executed/stored in the secure world, isolated from the normal world. Android StrongBox is a TEE that utilizes a separate hardware-backed security coprocessor (usually integrated within the SoC) to protect cryptographic keys and operations. It runs isolated from the main OS and apps. The iOS Secure Enclave is a TEE that is a dedicated hardware module integrated into Apple devices. It has its own microkernel and secure memory, isolated from the main processor and iOS. Android Keystore at SECURITY LEVEL SOFTWARE is not a TEE.

A first security level is referred to as SECURITY LEVEL TRUSTED ENVIRONMENT and indicates that the mobile device 630 is using a TEE, which is a separate execution environment but runs on the same chip as the main application processor. This enforcement can happen via TrustZone for Cortex-A.

A second security level is referred to as SECURITY LEVEL STRONGBOX and indicates the presence of a secure enclave, similar to what iPhones provide, and also discussed in the Android Compatibility Definition Document (CDD).

Certain cryptographic protocols can be used with a TEE, which can be referred to as TEE cryptographic protocols. These TEE cryptographic protocols can include cryptographic protocols for generating keys, encrypting, and decrypting to the TEE.

In a TEE-based key generation protocol, the mobile app (of the mobile device 630) generates two wrapping keypairs in the TEE. One is generated in the TEE and gated by biometric or PIN authentication, and the other is stored in the TEE without an authentication requirement. This is allows the refreshing of the FROST shares to not require user interaction. These keypairs include local wrapping keypairs with auth (LKA) and local wrapping keypairs with no auth (LKN), referred to collectively as local wrapping keypairs (LKs). The server receives the LKs over a secure (authenticated, encrypted) channel.

$$( {lkn}_{priv} , {lkn}_{pub} ) = {GenerateKeypair}_{secp 256 r 1}$$

$$( {lkn}_{priv} , {lkn}_{pub} ) = {GenerateKeypair}_{secp 256 r 1}$$

$$return ( lka , lkn )$$

The server 615, to encrypt to the mobile device's TEE, does the following:

$$( {eph}_{priv} , {eph}_{pub} ) = {GenerateKeypair}_{secp 256 r 1}$$

$${s}_{1} = ECDH ( {lka}_{pub} , {eph}_{priv} )$$

$${s}_{2} = ECDH ( {lkn}_{pub} , {eph}_{priv} )$$

$$iv = urandom ( 12 )$$

$$k = {HKDF}_{SHA 256} ( {s}_{1} ‖ {s}_{2} )$$

$$ct = AES - GCM ( k , iv , message )$$

$$return ( {eph}_{pub} , ct )$$

The mobile device 630 can decrypt from the TEE as follows:

$${s}_{1} = ECDH ( {lka}_{priv} , {eph}_{pub} )$$

$${s}_{2} = ECDH ( {lkn}_{priv} , {eph}_{pub} )$$

$$( k , iv ) = {HKDF}_{SHA 256} ( {s}_{1} ‖ {s}_{2} )$$

$$pt = AES - {GCM}^{- 1} ( k , iv , ct )$$

$$return pt$$

In addition to the TEE, there are a variety of additional techniques that can be used to further improve security and privacy the systems and methods described herein.

A first technique to improve security is timer enforcement. Application logic may implement a local timer using a hardware timer, such as those that back clock gettime(2) with CLOCK MONOTONIC RAW, that must expire before decryption occurs. While malware could circumvent this, it adds a layer of defense against scenarios where a customer might be coerced into decrypting the server key

A second technique to improve security involves publicly-verifiable backups. To ensure the server 615 actually encrypted and provided its private key share (e.g., the server key share 645), as opposed to something else, the systems and methods described herein can employ publicly verifiable encryption techniques, which can be deployed using the Elliptic Curve Integrated Encryption Scheme (ECIES). This allows users (e.g., user 605 and/or the mobile device 630) to verify, through zero-knowledge proofs, that the correct private key share was encrypted without revealing the key share itself, ensuring that their wallet is truly backed up and self-sovereign.

A third technique to improve security involves key share refreshing. The backup must be refreshed if the key shares change. Since the encryption scheme uses double Diffe-Hellman, the mobile application only needs to provide the non-enclave-backed key when it needs to issue a new ciphertext. The TEE-based key generation protocol discussed herein may be used for key share refreshing.

A fourth technique to improve security involves cloud-only storage. To mitigate risks associated with device loss or upgrade scenarios—where lingering backups could pose a security risk—in some examples, the backup is stored exclusively in the cloud (e.g., cloud backup 635), not locally on the mobile device (e.g., mobile device 630). On iOS, this can be achieved using methods like evictUbiquitousItemAtURL. similar approaches are available on Android platforms, via Google Drive APIs.

It is important to provide a secure backup mechanism for the mobile application's key share (e.g., the app key share 640 of the app on the mobile device 630). Loss of a mobile device 630 can occur on accident or through a malicious action by another individual. The systems and methods described herein ensure that the app key share 640 is not lost with the mobile device 630. This can be addressed with a secure backup of the app key share 640, stored in the user 605's cloud account (e.g., the cloud backup 635), and optionally in the cloud storage of one or more trusted contacts of the user 605 (e.g., the cloud backup 635 can include the trusted contact's cloud storage).

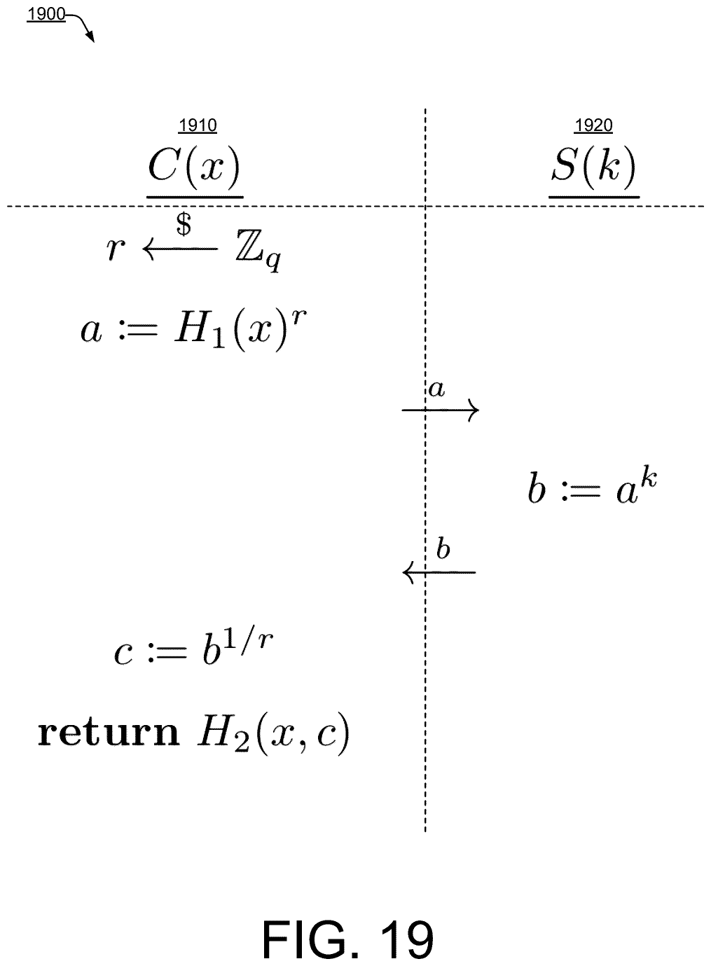

FIG. 19 is a swim lane diagram illustrating a process 1900 for two-hash Diffie-Hellman Oblivious Pseudorandom Function (OPRF) (2HasDH). The customer 1910 C(x) refers to the customer, user, mobile device 630, and/or app on the mobile device 630. The server 1920 S(k) refers to the server 615.

A backup (e.g., of the app key share 640 to the cloud backup 635) is encrypted with a key derived from the customer 1910's PIN. To facilitate this, the mobile application (on the mobile device 630) and the server 1920 can engage in an Oblivious Pseudorandom Function (OPRF) protocol. This allows the customer 1910 to derive a strong encryption key from their short PIN without revealing the PIN or the derived key to the server during the process. The backup is updated whenever key shares are rotated.

The protocol is based on the 2-Hash Diffe Hellman OPRF (2HashDH). In this scheme, the client blinds their PIN by generating a random nonce and multiplying it by a point derived from a hash of the customer's PIN using a hashing to curve protocol such as secp256k1 XMD:SHA-256 SSWU RO. This point, a blinded PIN, is sent to WSM, which returns a blinded value that incorporates the entropy from a unique 256-bit key assigned to each account. The mobile application then unblinds the returned value to derive the customer's secret. The secret and a domain separation tag are passed to an HKDF to derive the encryption key for the app key share (the “PIN Encryption Key”). This process 1900 for 2HashDH is illustrated in FIG. 19.

If an attacker gains access to both the encrypted app key share 640 backup as well as the secret key for the customer 1910 stored in WSM, such an attacked may be able to use a brute-force attack to determine the customer 1910's PIN. To prevent this, the systems and methods described herein can keep the WSM's OPRF keys segregated from any data that is encrypted with the OPRF to prevent brute-force attacks on the PIN.

In some examples, the server 1920's OPRF endpoint is rate-limited to prevent external brute-force attacks. A policy that rate limits at a threshold number of queries per time period (e.g., 10 queries per hour and/or 300 queries per month) can be used. A policy that rate limits at 10 queries per hour and 300 queries per month per account would require 1.4 years to brute-force a 4-digit PIN. These parameters can be adjusted as needed to find an optimal balance between API accessibility, brute-force resistance, and PIN length. A 6-digit PIN is preferable to a 4-digit PIN to help protect customers with very common and/or frequently reused 4-digit PINs, while still being a manageable length.

In addition, the systems and methods described herein can use a per-IP address rate limit to help prevent attackers from maliciously consuming the endpoint to prevent genuine attempts at recovery by the customer. To mitigate against such attacks, the systems and methods described herein can require a signature from an evaluation request key that is stored in the customer 1910's cloud (e.g., cloud backup 635 of user 605), so that an attacker must compromise the customer 1910's cloud to attempt an OPRF evaluation with a guessed PIN.

The systems and methods described herein are also designed to ensure that a user retains access to their assets in situations where the user loses access to parts of their wallet-such as the mobile application, the mobile device (e.g., mobile device 630), the cloud backup (e.g., cloud backup 635), a hardware wallet, or some combination thereof. Various techniques are described for how users can recover wallet access, along with mitigations used to prevent the recovery tools being useful for attackers.

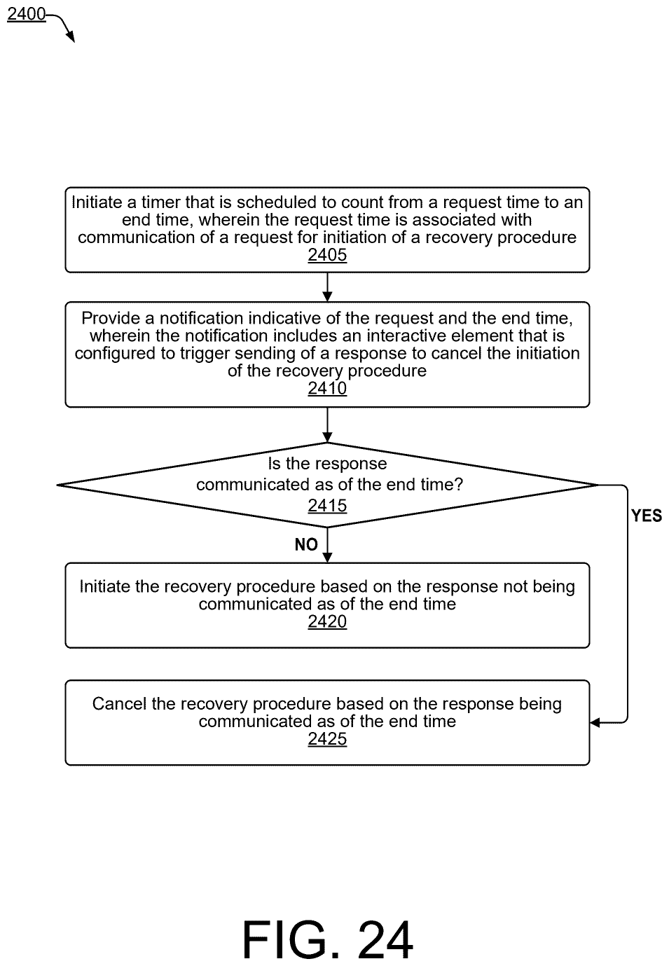

To handle the scenario of customers losing access to their mobile application, the systems and methods described herein utilize a recovery mechanism that leverages an OPRF (e.g., see FIG. 19) with a PIN to derive PIN Authentication Key (PAK). The PAK, in conjunction with a Delay and Notify (D&N) process (e.g., see FIGS. 5A, 5B, 24, and/or 25), acts as a mechanism to prevent an attacker who has cloud access from decrypting the key or restoring the wallet to an attacker's phone. The customer's PIN is also employed to derive the decryption key needed to decrypt the app key share 640 backup stored in the cloud backup 635.

The systems and methods described herein use an OPRF to make the PIN difficult to brute-force both for the server 615 and any external attackers. After deriving the PIN Encryption Key (PEK) using the OPRF protocol described with respect to FIG. 19 and otherwise herein, the mobile application generates a PAK, encrypts the PAK with the PEK, and stores the encrypted PAK in the cloud backup 635. The public key for the PAK is registered with the server 615 during the initial wallet onboarding.

In the event that the mobile application detects the loss of cloud backup data, the application notifies the user 605 and recreates the cloud backup 635 (e.g., of the app key share 640) using the data (e.g., app key share 640) stored locally on the mobile device 630. As illustrated with respect to FIG. 19, the app key share 640 is encrypted using an encryption key derived from the customer's PIN using the server's OPRF, to secure the backup during this process.

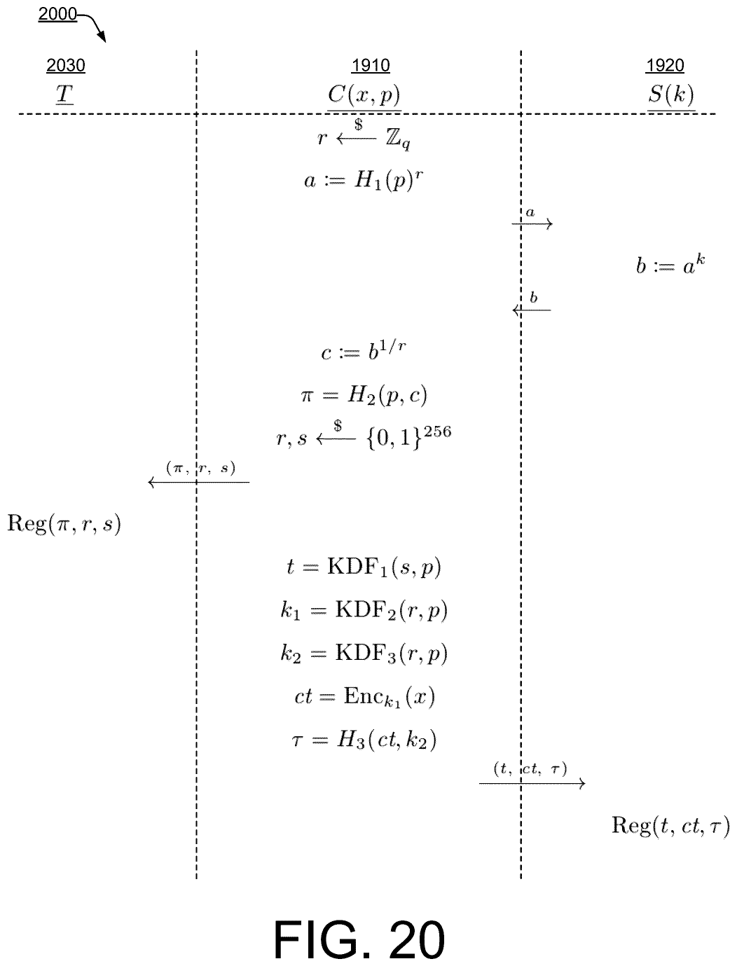

FIG. 20 is a swim lane diagram illustrating a process 2000 for a portable blind cloud storage register and give procedure. In both the process 2000 and the process 2100, the customer 1910 C(x,p) refers to the customer, user, mobile device 630, and/or app on the mobile device 630. The server 1920 S(k) refers to the server 615. The trusted contact 2030 T refers to a trusted contact of the customer 1910 C(x,p).

To safeguard customers 1910 who lose access to both their mobile device 630 and cloud backup data (e.g., in the cloud backup 635) simultaneously, the systems and methods described herein can use a Social Recovery feature. This mechanism is particularly useful in scenarios such as switching between platforms or dealing with security limitations on certain mobile devices (e.g., certain Android devices). For instance, a customer 1910 switching between Android and iOS can result in a change to both a mobile device 630 and cloud provider (for the cloud backup 635) simultaneously. If a customer 1910 neglects to retain the cloud backup data from the cloud backup 635, then making this platform switch risks a loss of funds held in the wallet. With respect to security limitations on certain mobile devices, Android does not provide developers a way to restrict access to cloud data (e.g., cloud backup 635) to the signed application that initializes the cloud data, unlike iOS. In addition, this cloud data (e.g., in the cloud backup 635) can be deleted without any “step-up” authentication. This makes the wallet vulnerable to loss of funds when an attacker gains physical access, even temporarily, to a customer's unlocked mobile device 630 for certain types of mobile devices (e.g., Android mobile devices).

The Social Recovery system relies on one or more Trusted Contacts who assist the customer 1910 in decrypting a backed-up key share (e.g., the app key share 640 backed up in the cloud backup 635). The design is based on the Portable Blind Cloud Storage (PBCS) protocol. PBCS requires two servers: a key server and a data server. In some examples, the server 1920 can refer to one or both of these servers (e.g., to one or both of the key server and the data server). In some examples, the WSM plays the role of the key server, and each trusted contact plays the role of a data server. In such examples, the server 1920 can refer to the WSM, while the trusted contact 2030 can refer to the data server. The WSM issues an enclave-backed attestation document (e.g., an Enclave Attestation) that gives the mobile application assurance that OPRF requests enforces a rate limit to defend against brute-force attacks.

When registering a trusted contact 2030 T, the customer 1910 establishes an authenticated secure channel using the SPAKE2 protocol. The customer 1910 initiates this process by sending an invitation, with a short code, to the trusted contact 2030 T over SMS or another out-of-band communication medium. This SPAKE2 channel is used to transfer data for the interactions between the customer 1910 and the trusted contact 2030 T in the PBCS Register Procedure and Give Procedure.

The customer 1910 then performs the PBCS Register Procedure and Give Procedure, a process 2000 for which is illustrated in FIG. 20. In some examples, the systems and methods described herein can combine the procedures to minimize communication rounds. The customer 1910 begins by deriving a social recovery key from their PIN using WSM's OPRF. The key is registered with the trusted contact 2030 T using the SPAKE2 channel, along with a seed and an encryption nonce.

Then the seed and the customer 1910's PIN are used to derive an authentication token. The customer 1910 also derives an encryption key from their nonce and PIN and uses it to encrypt their key share, and then stores the authentication token, ciphertext, and an integrity tag in WSM. Again, this process 2000 is illustrated in FIG. 20.

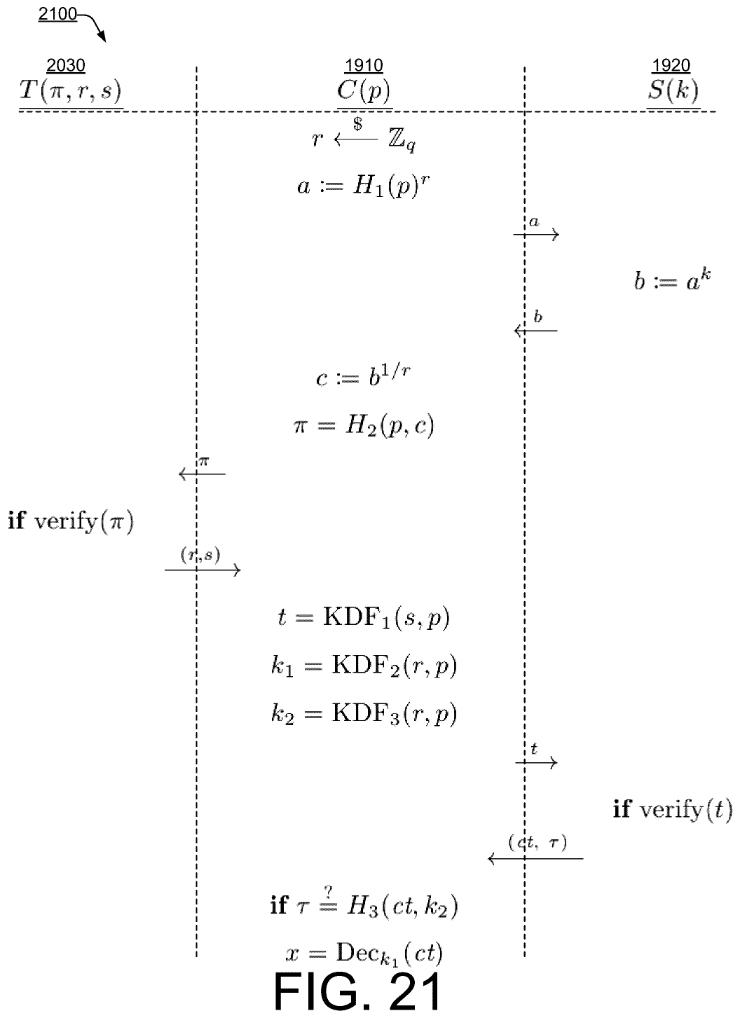

FIG. 21 is a swim lane diagram illustrating a process 2100 for a portable blind cloud storage take procedure. In both the process 2000 and the process 2100, the customer 1910 C(p) refers to the customer, user, mobile device 630, and/or app on the mobile device 630. The server 1920 S(k) refers to the server 615. The trusted contact 2030 T refers to a trusted contact of the customer 1910.

When the customer 1910 needs to recover funds, they establish a new SPAKE2 channel with the trusted contact 2030 T. This SPAKE2 channel is used to transfer data for the PBCS Take Procedure interactions, a process 2100 for which is illustrated in FIG. 21. The customer 1910 derives their social recovery key from their PIN using WSM's OPRF and sends it to the trusted contact 2030 T. If the key verifies, the trusted contact 2030 T returns the seed and nonce. The customer 1910 then uses the seed and nonce to derive their authentication token and encryption key. The customer 1910 authenticates with WSM using the token, which returns the ciphertext and integrity tag. Lastly, the customer 1910 verifies the integrity of the ciphertext with the tag and decrypts the ciphertext. Again, this process 2100 is illustrated in FIG. 21.

Once the customer 1910 has decrypted their key share, the server 1920 S(k) can still refuse to co-sign transactions, refresh shares, or create a new Self-Sovereign Backup until a D&N process has completed. During this process, the customer 1910 can use their PAK to cancel a malicious recovery, and in the event of a contested recovery, control of communication channels can be used to resolve stalemates.

To improve the security of the wallet architecture described herein, the systems and methods described herein can incorporate mechanisms to protect certain privileged actions. These mechanisms leverage time delays as a defensive strategy, making it significantly more difficult for attackers to execute unauthorized operations—especially if they have only momentary or partial access to the customer 1910's device (e.g., mobile device 630) or credentials. By incorporating these time-based defenses, the likelihood that only the true owner (e.g., user 605, customer 1910, customer 1910) can perform sensitive operations is increased and/or improved.

One such mechanism for protecting privileged actions is referred to herein as “Delay and Notify” or “D&N.” Examples of delay and notify are illustrated in FIGS. 5A, 5B, 24, and/or 25.

The Delay and Notify mechanism protects sensitive actions by introducing a mandatory delay before execution. When a protected action is initiated, the server 1920 imposes a predetermined delay period (e.g., one or more minutes, hours, days, weeks, months, and/or years), before carrying out the action.

During this delay, the server 1920 sends notifications to the customer 1910's pre-configured communication channels, such as push notifications, emails, and text messages. These notifications are sent repeatedly to maximize the chances of reaching the customer. If the customer 1910 receives a notification and did not initiate the action, the customer 1910 has the opportunity to veto the pending operation directly from the communication channel or through the app. Vetoing cancels the action, preventing it from being executed. If the delay period elapses without a veto, the server 1920 proceeds to execute the action.

This mechanism mitigates risks by making it challenging for attackers to perform sensitive actions without the customer's knowledge. Attackers who gain temporary access to the customer's device—perhaps it was left unlocked, or they discovered the PIN—cannot immediately execute protected actions. The delay period provides a critical window during which the legitimate customer 1910 can detect and respond to unauthorized attempts.

Provided the customer 1910 has access to their cloud data (e.g., in cloud backup 635) and their PIN, they can utilize the server's OPRF to derive their PEK, and then use the PEK to decrypt the PAK stored in the cloud (e.g., cloud backup 635), and sign with the PAK to authorize the privileged action (e.g., D&N veto).

In some cases, attackers may attempt to compromise the customer 1910's communication channels to suppress notifications or prevent vetoes. However, the attacker would need to maintain exclusive control over all communication channels throughout the length of the delay to do so. If the customer 1910 receives a single notification on any channel, the customer 1910 has the opportunity to block the attacker's action. Over time, regaining control over communication channels typically favors the legitimate customer 1910, who can leverage identity verification processes (e.g., with a telecom provider for a phone number) to restore access.

By design, in a situation when both the attacker and the customer 1910 have access to the communication channel, the wallet is essentially in a stalemate where both sides can veto the actions of the other. If either party is able to gain exclusive access to the communications channel for the duration of the delay, then the stalemate is broken.

To further empower the legitimate customer 1910, and to deter the stalemate from being used as an extortion mechanism, when actions are repeatedly initiated and vetoed the wallet enters a contested state. Once such a contested state has been triggered, a signature from the customer 1910's PAK can be required for both initiating and vetoing protected actions.

If the attacker does not possess the PIN, then the legitimate customer 1910 can use it to break the stalemate and regain control over the wallet, even without exclusive access to the communication channels.

Since the server 1920 is required to co-sign in the normal spending path 620, a customer 1910 can set signing policies enforced by the server 1920 to further enhance security. One such policy is the use of vaults, which allow customers to protect a predefined portion of their balance by setting a minimum balance threshold—the server 1920 adheres to this threshold by refusing to co-sign any transaction that would cause the balance to drop below the threshold.

An example of such vault functionality is illustrated in FIG. 4, in which active vault status 430 is assigned to a first quantity 410 of an asset 415 (e.g., meaning that the first quantity 410 of the asset 415 is protected by the vault), and an inactive vault status 435 is assigned to the second quantity 420 of the asset 415 (e.g., meaning that the second quantity 420 of the asset 415 is not protected by the vault and is available for use in a transfer 440).

A customer 1910 can freely spend funds above the vault threshold without delay, facilitating day-to-day trans-actions. To lower the threshold and make vaulted funds available, the customer 1910 must undergo the Delay and Notify process. This Delay and Notify mechanism mitigates the risk of unauthorized depletion of the customer 1910's core funds. If an attacker gains access to the wallet, the attacker can only spend funds above the vault threshold immediately (e.g., and/or funds with inactive vault status 435 as opposed to active vault status 430). Attempting to access the vaulted funds (e.g., funds with active vault status 430) triggers the Delay and Notify process, giving the customer 1910 time to intervene, for instance to prevent the active vault status 430 from being changed to the inactive vault status 435, or to otherwise prevent a transfer 440.

While the vault mechanism protects funds through server-enforced policies, the customer 1910 would have control of the self-sovereign backup (e.g., of the server key share 645), which allows the customer to spend unilaterally without the server's involvement (e.g., the unilateral spending path 625). However, this backup (e.g, of the server key share 645) is encrypted using the secure enclave of the mobile device 630 and can only be decrypted by the signed app (e.g., on the mobile device 630) that created it. In some examples, the app enforces a mandatory delay and notify mechanism (e.g., one or more minutes, hours, days, weeks, months, and/or years) before decrypting the backup key.

This means an attacker cannot use the Self-Sovereign Backup (e.g., the unilateral spending path 625) to circumvent the vault's time delays and access the vaulted funds immediately. The delay in the app (of the mobile device 630 of the customer 1910) mirrors the delay in the server 1920, ensuring consistent security measures across different recovery paths.

By integrating these time-based defenses at both the server 1920 and app levels, the systems and methods described herein can use a layered security model that mitigates various attack vectors. The combination of the Delay and Notify mechanism and Vaults increases the effort and time required for an attacker to compromise the wallet fully, favoring the legitimate customer 1910 and enhancing overall security without significantly impacting usability.

Maintaining customer privacy is a critical challenge in collaborative custody arrangements, where the server 1920 actively participates in wallet security. The key issue lies in leveraging the server 1920's capabilities without compromising sensitive information about the customer 1910's wallet and transactions. The systems and methods described herein use mechanisms to preserve and/or improve privacy even when the server 1920 is involved in critical operations. These mechanisms include, and/or provide, descriptor privacy, signing privacy, and vault privacy.

A wallet descriptor reveals the entire transaction history of the wallet because it contains all the requisite information to derive its child keys. To protect privacy of the customer 1910, the server 1920 must not store the plaintext wallet descriptor. However, preventing the server from learning this information while still being able to sign is a challenge.

The solution is two-fold. First, the systems and methods described herein can task the mobile application with the sole responsibility of generating and interacting with the chain code. Secondly, the systems and methods described herein can use predicate blind signing to allow the server to sign without learning the child key for which it is signing, and without being able to recognize the final signature, while also being able to enforce signing policies.

When performing BIP32 key tweaking with FROST (e.g., as illustrated in FIG. 18), the tweak is added during the signature aggregation operation. When the signatures are aggregated, they take the form of:

$${s}^{′} = r + x \cdot c$$

In the equation above, r is the nonce, x is the group private key, and c is the challenge hash. To apply the BIP32 tweak t to the signature, the aggregator adds t·c to s′ to produce the signature:

$$s = {s}^{′} + ( t \cdot c ) = r + x \cdot c + ( t \cdot c ) = r + c ( x + t )$$

In the systems and methods described herein, the mobile application (of the mobile device 630 of the customer 1910) is the signature aggregator, which applies the tweak. During signing, the server 1920 only learns blinded values. Therefore, the server 1920 does not need to know the key tweak, or the chain code, to produce its partial signature (e.g., partial signature 205A).

Predicate blind signing combines blind Schnorr signatures with zero-knowledge proofs that make assertions about transaction attributes. This allows the server 2020 to enforce signing policies without learning any identifying information about the transaction. The systems and methods described herein include a protocol for predicate blind signing that is modified to be compatible with FROST, improving security, privacy, and flexibility.

To perform the protocol, the mobile application (e.g., of the mobile device 630 of the 1910) receives a nonce commitment from the server 1920 and uses the nonce commitment to compute a blinded nonce commitment and a blinded challenge hash. The server then uses the blinded challenge hash to create a blinded signature and returns it to the mobile application, which unblinds it. In the process, the server 1920 does not learn the resulting signature, message, challenge hash, or nonce commitment and is unable to derive those values. In some examples, the systems and methods described herein include modifications to predicate blind signing protocol(s) to make the protocol(s) compatible with FROST, BIP340, BIP341, and/or BIP32.

In some examples, the systems and methods described herein include mechanisms that provide and/or improve privacy with respect to the Vault mechanism discussed herein (e.g., illustrated in FIG. 4). For instance, in some examples, velocity controls are enforced by the server 1920, Velocity controls can present a privacy challenge because the server 1920 needs to be able to condition its signature on the verification of whether a customer 1910 has sufficient un-vaulted funds. To solve this, the systems and methods described herein use a series of zero-knowledge proofs that allow the mobile application (e.g., on the mobile device 630 of the customer 1910) to prove to the server 1920 that it has sufficient funds without revealing any other information, such as transaction details and wallet balances.

A proof of sufficient funds can be modeled as a solvency proof. In some examples, the systems and methods described herein repurpose and adapt a proof-of-solvency protocol designed for exchanges called Provisions, thereby efficiently proving sufficient un-vaulted funds without requiring a large and complex circuit using a general-purpose proof system such as Zero-Knowledge Succinct Non-Interactive Argument of Knowledge (zk-SNARK).

In some examples, the systems and methods described herein use a Pay-to-Taproot (P2TR) UTXO set as the anonymity set in the protocol. P2TR addresses are compatible with Provisions because they both correspond to a single public key, rather than a hashed script, and embed that key directly, as opposed to a hashed key. This set can be pruned as needed to meet performance requirements on mobile devices by ejecting unowned outputs using a randomized sampling.

The set only includes UTXOs that were created subsequent to the creation of the wallet. Earlier UTXOs don't provide anonymity because the server 1920 knows the wallet did not send transactions before it was created. As a result, the anonymity set for each wallet grows over time. The initial set isn't built until the first vault deposit, and the systems and methods described herein delay the ability to enable the vault until a sufficient time period has elapsed to populate the set.

In some examples, the systems and methods described herein use the Provisions proof-of-assets protocol to generate a commitment to the sum of wallet assets. This entails generating a Pedersen commitment for each UTXO in the anonymity set and a corresponding proof-of-knowledge that asserts that (1) the mobile application knows the private key for the UTXO and the commitment opens to the balance of the UTXO, or (2) that the commitment opens to zero. The sum of these commitments is a commitment to the sum of wallet assets. These commitments allow the server 1920 to enforce vault policies without learning the customer 1910's vaulted and un-vaulted balances (e.g., without learning the first quantity 410 of the asset 415 with the active vault status 430 or the second quantity 420 of the asset 415 with the inactive vault status 435).

When the mobile application (e.g., on the mobile device 630 of the customer 1910) requests a deposit of coins into the vault, the mobile application creates a Pedersen commitment of the amount to be deposited and sends it to the server 1920. If this is the first deposit commitment received from the customer 1910, the server 1920 stores it as the initial commitment. Otherwise, the server 1920 adds this commitment to the existing deposit commitment to generate a new deposit commitment sum. The mobile application also includes a commitment to the sum of its assets so the server 1920 can verify that the deposit commitment sum is greater than or equal to the sum of wallet assets. Range proofs are included with the Pedersen commitments that assert the committed values do not exceed 251 bits to prevent overflows.

When the mobile application (e.g., on the mobile device 630 of the customer 1910) requests a withdrawal of asset(s) (e.g., bitcoins, cryptocurrencies, and/or other asset(s)) from the vault, the mobile application creates a Pedersen commitment of the amount of the asset(s) to be withdrawn and sends the commitment to the server 1920. After the vault time-delay period has elapsed, the server 1920 then subtracts the Pedersen commitment from the deposit commitment sum to generate the new cumulative commitment sum. The deposit commitment sum is equivalent to the commitment to the sum of the exchange's liabilities in the Provisions proof-of-liabilities protocol.

When a customer 1910 (e.g., the app on the mobile device 630) requests that the server 1920 co-sign a transaction, the server 1920 enforces its vault policy with the following proof components: (1) a commitment to a sum of wallet assets, (2) a commitment to a sum of vault deposits, (3) a commitment to the sum of all non-change outputs in the transaction, and (4) a commitment to the surplus, if any, when the sum of the deposits and the transaction amount is subtracted from the sum of assets. The server 1920 checks whether the assets minus the deposits minus the transaction amount minus the surplus is a commitment to the value of 0.

Using the predicate blind signing protocol, the mobile application (e.g., on the mobile device 630 of the customer 1910) also generates a zero-knowledge proof that the transaction Pedersen commitment opens to the sum of the non-change outputs by including that assertion as a predicate.

The landscape of Bitcoin self-custody has often faced a balance between security and usability. The wallet design described herein brings together cryptographic techniques like FROST-based MPC, secure key backups, OPRFs, and zero-knowledge proofs into a cohesive solution that improves security, privacy, availability, and usability. without compromising on the user experience provided by a mobile-device-based solution.

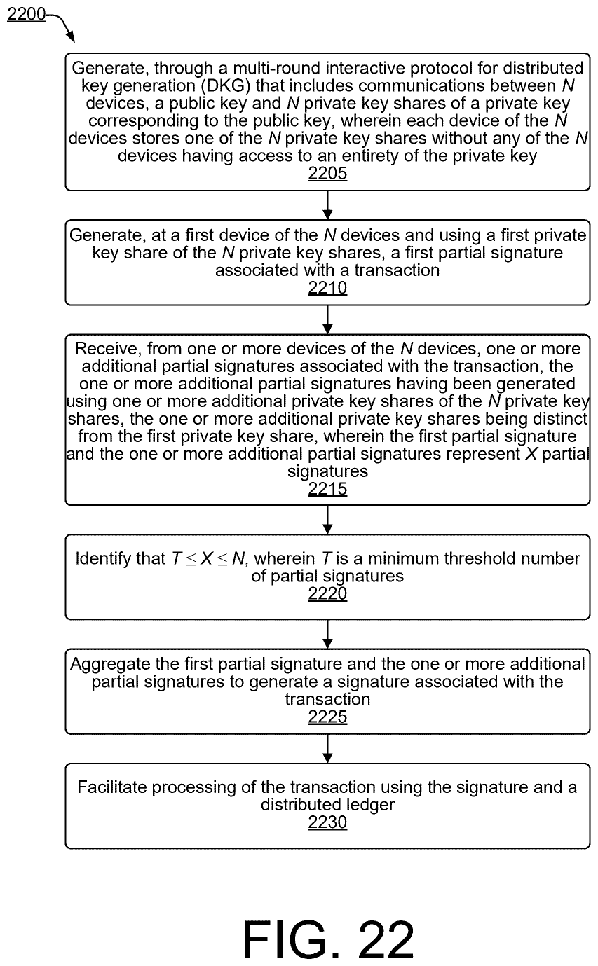

FIG. 22 is a flow diagram illustrating a process 2200 for multiparty computation (MPC). The process 2200 can be performed by, and/or using, a transaction management system. The transaction management system can include, for instance, the first device 105, the second device 110, the third device 115, the mobile device 305, the server 330, the hardware wallet 340, the mobile device 505, the server 530, the hardware wallet 540, the server 615, the mobile device 630, the cloud backup 535, a mobile device with the app 705, the server 710, a mobile device with the app 805, the server 810, a mobile device with the app 905, the server 910, the WSM 915, a mobile device with the app 1005, the server 1010, the WSM 1015, a mobile device and/or application associated with the customer 1310, the server 1320, a mobile device with the app 1405, the server 1410, the WSM 1415, a mobile device with the app 1505, the server 1510, the WSM 1515, a system that performs the process 1800, a mobile device and/or application associated with the customer 1910, the server 1920, a mobile device and/or application associated with the trusted contact 2030, the transaction management system that performs the process 2300, the transaction management system that performs the process 2400, the transaction management system that performs the process 2500, the transaction management system that performs the process 2600, the transaction management system that performs the process 2700, the environment 2800 for application interface customization, the environment 2900, the system 3000, a system, an apparatus, a point of sale (POS) system or terminal, a transaction instrument reader device, a processor that performs instructions stored in a non-transitory computer-readable storage medium, any subsystems or components of any of the above-listed systems, any other computing systems discussed herein, or a combination thereof.

At operation 2205, the transaction management system (or a subsystem thereof) is configured to, and can, generate, through a multi-round interactive protocol for distributed key generation (DKG) that includes communications between N devices, a public key and N private key shares of a private key corresponding to the public key. Each device of the N devices stores one of the N private key shares without any of the N devices having access to an entirety of the private key. In some examples, the private key never exists in its entirety (e.g., in a whole state).

At operation 2210, the transaction management system (or a subsystem thereof) is configured to, and can, generate, at a first device of the N devices and using a first private key share of the N private key shares, a first partial signature associated with a transaction.

At operation 2215, the transaction management system (or a subsystem thereof) is configured to, and can, receive, from one or more devices of the N devices, one or more additional partial signatures associated with the transaction. The one or more additional partial signatures are generated using one or more additional private key shares of the N private key shares. The one or more additional private key shares are distinct from the first private key share. The first partial signature and the one or more additional partial signatures represent X partial signatures.

In some examples, wherein the N devices include a server, a mobile device, and a cryptocurrency wallet device. In some examples, the first device is the server, and the one or more devices include at least one of the mobile device or the cryptocurrency wallet device. In some examples, the first device is the mobile device, and the one or more devices include at least one of the server or the cryptocurrency wallet device. In some examples, the first device is the cryptocurrency wallet device, and wherein the one or more devices include at least one of the server or the mobile device.

At operation 2220, the transaction management system (or a subsystem thereof) is configured to, and can, identify that T≤X≤N. In operation 2220, T is a minimum threshold number of partial signatures.

In some examples, T≤X<N, meaning that the not all of the process 700 can proceed with partial signatures from less than all N devices. For instance, in some examples, N=3 and T=2, meaning that partial signatures from two out of three devices (e.g., the first device 105, the second device 110, and/or the third device 115) are sufficient to proceed with the process 700.

In some examples, the X partial signatures include at least one Flexible Round-Optimized Schnorr Threshold (FROST) signature. In some examples, the X partial signatures include at least one of a Scnorr signature or a Elliptic Curve Digital Signature Algorithm (ECDSA) signature.

At operation 2225, the transaction management system (or a subsystem thereof) is configured to, and can, aggregate the first partial signature and the one or more additional partial signatures to generate a signature associated with the transaction.

At operation 2230, the transaction management system (or a subsystem thereof) is configured to, and can, facilitate processing of the transaction using the signature and a distributed ledger.

In some examples, the distributed ledger is a blockchain ledger. In some examples, the distributed ledger is associated with a Lightning network.

In some examples, the transaction management system (or a subsystem thereof) is configured to, and can, assign a vault status to an amount of an asset with a vault status. The amount of the asset is unusable in the transaction (e.g., not transferrable) while the vault status is assigned to the amount of the asset and until the vault status is unassigned from the amount of the asset. In some examples, facilitating processing of the transaction includes using a second amount of the asset for the transaction, where the vault status is not assigned to the second amount of the asset (e.g., where the second amount has an inactive vault status). In some examples, the transaction management system (or a subsystem thereof) is configured to, and can, receive a request to unassign the vault status from the amount of the asset (e.g., to transition the amount of the asset from an active vault status to an inactive vault status). The transaction management system can initiate a timer and provide an interactive alert indicative of receipt of the request to a mobile device (e.g., one of the N devices). The interactive alert includes an option to cancel the request until the timer reaches a threshold time. The transaction management system can unassign the vault status from the amount of the asset (e.g., to transition the amount of the asset from the active vault status to the inactive vault status) in response to the timer reaching the threshold time.

In some examples, the transaction management system (or a subsystem thereof) is configured to, and can, receive a request to initiate an emergency wallet recovery. The transaction management system can initiate a timer and provide an interactive alert indicative of receipt of the request to a mobile device (e.g., of the N devices). The interactive alert includes an option to cancel the request until the timer reaches a threshold time. The transaction management system can initiate the emergency wallet recovery in response to the timer reaching the threshold time. In some examples, initiating the emergency wallet recovery includes decrypting an emergency access kit that includes the first private key share (e.g., where the first device is a server).

In some examples, the transaction management system (or a subsystem thereof) is configured to, and can, receive a processed personal identification number from a mobile device (e.g., of the N devices), the mobile device having processed a personal identification number using a homomorphic function to generate the processed personal identification number. The transaction management system can combine the processed personal identification number with a second value to generate a combined value. The transaction management system can send the combined value to the mobile device to use for an access control. In some examples, the homomorphic function is an oblivious pseudorandom function (OPRF).

In some examples, the transaction management system (or a subsystem thereof) is configured to, and can, perform a key rotation periodically based on a predetermined time interval. In some examples, the transaction management system (or a subsystem thereof) is configured to, and can, perform a key rotation in response to an indication of a transition condition. Transition condition includes at least one of a transition from a first iteration of the first device to a second iteration of the first device, a transition from a first iteration of a second device of the one or more devices to a second iteration of the second device, an indication that the first device is inaccessible (e.g., lost, stolen, defective, or disabled), an indication that the second device is inaccessible (e.g., lost, stolen, defective, or disabled), or an indication that the first device and the second device are both inaccessible (e.g., lost, stolen, defective, or disabled).

Performing a key rotation includes generating, through a new instance of the multi-round interactive protocol for DKG, a new public key and N new private key shares of a new private key corresponding to the new public key. Each device of the N devices stores one of the N new private key shares without any of the N devices having access to an entirety of the new private key. In some examples, the new private key never exists in its entirety (e.g., in a whole state).

In some examples, the transaction management system (or a subsystem thereof) is configured to, and can, perform a key rotation in response to an indication of a transition condition, wherein performing a key rotation includes generating, through a new instance of the multi-round interactive protocol for DKG, a new public key and N new private key shares of a new private key corresponding to the new public key, wherein each device of the N devices stores one of the N new private key shares without any of the N devices having access to an entirety of the new private key, wherein the transition condition includes at least one of a transition from a first iteration of the first device to a second iteration of the first device, a transition from a first iteration of a second device of the one or more devices to a second iteration of the second device.

In some examples, the transaction management system (or a subsystem thereof) is configured to, and can, store, in a secure enclave of the first device, the first private key share and a second private key share, where the second private key share is associated with a second device of the one or more devices. In some examples, the transaction management system (or a subsystem thereof) is configured to, and can, retrieve the second private key share from the secure enclave of the first device in response to an indication that the second device has been lost, stolen, disabled, and/or otherwise made inaccessible.

In some examples, the transaction management system (or a subsystem thereof) is configured to, and can, cause a second device of the one or more devices to store, in a secure enclave of the second device, the first private key share and a second private key share, where the second private key share is associated with the second device. In some examples, the transaction management system (or a subsystem thereof) is configured to, and can, retrieve the first private key share from the secure enclave of the second device in response to an indication that the first device has been lost, stolen, disabled, and/or otherwise made inaccessible.

In some examples, the transaction management system (or a subsystem thereof) is configured to, and can, cause a second device of the one or more devices to store, at a cloud server associated with the second device, a second private key share that is associated with the second device.

In some examples, the transaction management system (or a subsystem thereof) is configured to, and can, change the quorum (add and remove signers, change the threshold) without moving funds. For instance, in some examples, the transaction management system (or a subsystem thereof) is configured to, and can, change a quorum rule, wherein changing the quorum rule includes at least one of changing N, changing T, or changing at least one of the N devices.

In some examples, the transaction management system (or a subsystem thereof) is configured to, and can, provide a 2-of-2 key configuration that is upgradable to a 2-of-3 key configuration. In some examples, the transaction management system (or a subsystem thereof) is configured to, and can, support arbitrary T-of-N configurations (e.g., 2-of-3, 3-of-4, 2-of-4, etc.). In some examples, the transaction management system (or a subsystem thereof) is configured to, and can, preserve users' privacy by storing chain codes in encrypted backups, using zero-knowledge blind signing for the server, having the mobile application exclusively manage the plaintext chain code, and/or using a TEE for private deposit notifications. In some examples, the transaction management system (or a subsystem thereof) is configured to, and can, provide velocity controls. In some examples, the transaction management system (or a subsystem thereof) is configured to, and can, provide a delay and notify (D&N) recovery system. The D&N recovery system can include systems for contested recovery, including cancellation and escalation. The D&N recovery system can include a PIN authentication key. In some examples, the transaction management system (or a subsystem thereof) is configured to, and can, provide an application timer to deter wrench attacks. In some examples, the transaction management system (or a subsystem thereof) is configured to, and can, include a social recovery system for handling loss of both the mobile application and the cloud data. The social recovery system can be secured by a PIN and/or by a clawback mechanism to defend against collusion between the trusted contact and the server.

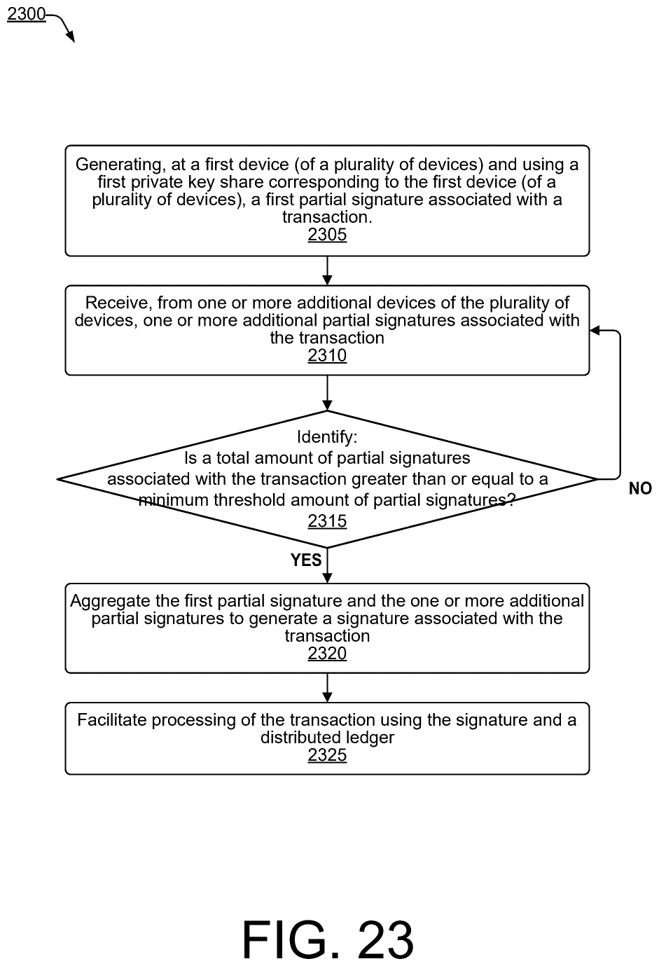

FIG. 23 is a flow diagram illustrating a process 2300 for improving security through multiparty computation (MPC). The process 2300 can be performed by, and/or using, a transaction management system. The transaction management system can include, for instance, the first device 105, the second device 110, the third device 115, the mobile device 305, the server 330, the hardware wallet 340, the mobile device 505, the server 530, the hardware wallet 540, the server 615, the mobile device 630, the cloud backup 535, a mobile device with the app 705, the server 710, a mobile device with the app 805, the server 810, a mobile device with the app 905, the server 910, the WSM 915, a mobile device with the app 1005, the server 1010, the WSM 1015, a mobile device and/or application associated with the customer 1310, the server 1320, a mobile device with the app 1405, the server 1410, the WSM 1415, a mobile device with the app 1505, the server 1510, the WSM 1515, a system that performs the process 1800, a mobile device and/or application associated with the customer 1910, the server 1920, a mobile device and/or application associated with the trusted contact 2030, the transaction management system that performs the process 2200, the transaction management system that performs the process 2400, the transaction management system that performs the process 2500, the transaction management system that performs the process 2600, the transaction management system that performs the process 2700, the environment 2800 for application interface customization, the environment 2900, the system 3000, a system, an apparatus, a point of sale (POS) system or terminal, a transaction instrument reader device, a processor that performs instructions stored in a non-transitory computer-readable storage medium, any subsystems or components of any of the above-listed systems, any other computing systems discussed herein, or a combination thereof.

At operation 2305, the transaction management system (or a subsystem thereof) is configured to, and can, generate (e.g., at a first device and using a first private key share corresponding to the first device) a first partial signature associated with a transaction. The plurality of private key shares includes the first private key share. The plurality of private key shares each correspond to different devices of a plurality of devices, wherein the plurality of devices includes the first device.

At operation 2310, the transaction management system (or a subsystem thereof) is configured to, and can, receive, from one or more additional devices of the plurality of devices, one or more additional partial signatures associated with the transaction. The one or more additional partial signatures were generated using one or more additional private key shares of the plurality of private key shares.

In some examples, the plurality of devices includes a mobile device (e.g., second device 110, mobile device 305, mobile device 505, mobile device 630, mobile device with app 705, mobile device with app 805, mobile device with app 905, mobile device with app 1005, customer 1310, mobile device with app 1450, mobile device with app 1505, user 1605, customer 1910), a server (e.g., first device 105, server 330, server 530, server 615, server 710, server 810, server 910, server 1010, server 1320, server 1410, server 1510, server 1920), and/or a hardware wallet device (e.g., third device 115, hardware wallet 340). In some examples, the one or more additional partial signatures (of operation 2310) include a hardware wallet partial signature generated by the hardware wallet device.

At operation 2315, the transaction management system (or a subsystem thereof) is configured to, and can, identifying whether a total amount of partial signatures associated with the transaction is greater than or equal to a minimum threshold amount of partial signatures, where the total amount of partial signatures includes the first partial signature and the one or more additional partial signatures. If the total amount of partial signatures is greater than or equal to the minimum threshold amount of partial signatures, the process 2300 proceeds to operation 2320 after operation 2315. If the total amount of partial signatures is not greater than or equal to the minimum threshold amount of partial signatures (e.g., is less than the minimum threshold amount of partial signatures), the process 2300 proceeds to operation 2310 after operation 2315, for instance to wait to receive more of the one or more additional partial signatures. The value T in the process 2200 can be an example of the minimum threshold amount.

In some examples, the plurality of devices includes a mobile device, a server and/or a hardware wallet. In some examples, the total amount of partial signatures includes a mobile device partial signature or application partial signature (e.g., partial signature 205B) based on a mobile device key share or application key share (e.g., private key share 135B, app key share 640) from the mobile device (or application on the mobile device), a server partial signature (e.g., partial signature 205A) based on a server key share (e.g., private key share 135A, server key share 645) from the server, and/or a hardware wallet partial signature (e.g., partial signature 205C) based on a hardware wallet key share (e.g., private key share 135C) from the hardware wallet device.

In some examples, the transaction management system (or a subsystem thereof) is configured to, and can, set the minimum threshold amount based on an input. The input can be received via a user interface of one of the plurality of devices (e.g., the mobile device, the server, the hardware wallet, etc.). In some examples, the transaction management system (or a subsystem thereof) is configured to, and can, modify (e.g., change, adjust, increase, decrease) the minimum threshold amount based on an input. The input can be received via a user interface of one of the plurality of devices (e.g., the mobile device, the server, the hardware wallet, etc.).

At operation 2320, the transaction management system (or a subsystem thereof) is configured to, and can, aggregate the first partial signature and the one or more additional partial signatures to generate a signature (e.g., signature 210) associated with the transaction.

At operation 2325, the transaction management system (or a subsystem thereof) is configured to, and can, facilitate processing of the transaction using the signature and a distributed ledger. Facilitating the processing of the transaction using the signature that is generated through signature aggregation provides improved security for the transaction through MPC.

In some examples, before operation 2305, the transaction management system (or a subsystem thereof) is configured to, and can, generate, through a multi-round interactive protocol for distributed key generation (DKG) that includes communications between the plurality of devices, a public key and the plurality of private key shares of a private key corresponding to the public key, for instance as illustrated in FIG. 1. Each device of the plurality of devices stores one of the plurality of private key shares without any of the plurality of devices having access to an entirety of the private key.

In some examples, the transaction management system (or a subsystem thereof) is configured to, and can, cause the first private key share to be stored in encrypted form in a secure enclave of a second device of the one or more additional devices. For instance, the mobile device 630 can be an example of the second device, and the server key share 645 stored in the secure enclave of the mobile device 630 can be an example of the first private key share stored in the secure enclave of the second device. In some examples, the first device is a server (e.g., server 615). The second device stores a second private key share (e.g., the app key share 640). The plurality of private key shares includes the second private key share. In some examples, causing the first private key share to be stored in encrypted form in the secure enclave of the second device includes sending the first private key share from the first device to the second device (e.g., sending the server key share 645 from the server 615 to the mobile device 630).

In some examples, a combination of the first private key share and the second private key share is usable to authorize a transfer of an asset (e.g., the first private key share and the second private key share being usable to generate partial signatures that can be combined as in the process 200 to form a signature 210). In some examples, the transaction management system (or a subsystem thereof) is configured to, and can, receive a request associated with decryption of the first private key share (e.g., server key share 645) from the secure enclave (e.g., of the mobile device 630). The transaction management system (or a subsystem thereof) can initiate a timer, and can provide, to and/or at the second device (e.g., to the mobile device 630), an interactive alert indicative of receipt of the request. The interactive alert includes an option to cancel the request until the timer reaches a threshold time. In response to the timer reaching the threshold time, the second device is configured to decrypt the first private key share, to combine the first private key share and the second private key share to generate the combination, and to use the combination to authorize the transfer of the asset. The user interface 560 of FIGS. 5A-5B can be an example of the interactive alert, with the “cancel” button in the user interface 560 being an example of the option to cancel.

In some examples, the transaction management system (or a subsystem thereof) is configured to, and can, store the first private key share in the first device (e.g., storing the app key share 640 in the mobile device 630). The transaction management system can store a second private key share in encrypted form in a secure enclave of the first device (e.g., storing the server key share 645 in encrypted form in the secure enclave of the mobile device 630). The second private key share is associated with a second device (e.g., the server key share 645 being associated with the server 615) of the one or more additional devices. The plurality of private key shares includes the second private key share. In some examples, the transaction management system (or a subsystem thereof) is configured to, and can, receive the second private key share at the first device from the second device (e.g., receiving the server key share 645 at the mobile device 630 from the server 615), the second private key share having been generated by the second device (e.g., the server key share 645 having been generated by the server 615).

In some examples, the transaction management system (or a subsystem thereof) is configured to, and can, retrieve the second private key share from the secure enclave, combine the first private key share with the second private key share to generate a private key share combination; and use the private key share combination to authorize a transfer of an asset. The private key share combination can be a full private key, or can be a combination of a subset of the private key shares corresponding to the private key. In some examples, combining the first private key share with the second private key share to generate the private key share combination includes combining a first partial signature (corresponding to the first private key share) with a second partial signature (corresponding to the second private key share) as in the process 200 to generate a signature 210. In some examples, the transaction management system (or a subsystem thereof) is configured to, and can, receive a request associated with decryption of the second private key share from the secure enclave (e.g., description of the server key share 645 from the secure enclave of the mobile device 630). The transaction management system can initiate a timer, and can providing an interactive alert indicative of receipt of the request. The interactive alert includes an option to cancel the request until the timer reaches a threshold time. The second device is configured to decrypt the first private key share and combine the first private key share and the second private key share in response to the timer reaching the threshold time. The user interface 560 of FIGS. 5A-5B can be an example of the interactive alert, with the “cancel” button in the user interface 560 being an example of the option to cancel.

In some examples, the transaction management system (or a subsystem thereof) is configured to, and can, assign a vault status (e.g., active vault status 430) to an amount (e.g., first quantity 410) of an asset (e.g., asset 415). The amount of the asset is unusable in the transaction while the vault status is assigned to the amount of the asset and until the vault status is unassigned from the amount of the asset. In some examples, facilitating the processing of the transaction (as in operation 2325) includes using a second amount (e.g., second quantity 420) of the asset (e.g., asset 415) for the transaction (e.g., transfer 440), where the vault status is not assigned to the second amount of the asset (e.g., where the second amount of the asset has inactive vault status 435). In some examples, the transaction management system (or a subsystem thereof) is configured to, and can, receive a request (e.g., request 445) to unassign the vault status from the amount of the asset. The transaction management system can initiate a timer and provide an interactive alert indicative of receipt of the request to a mobile device. The interactive alert includes an option to cancel the request until the timer reaches a threshold time. The transaction management system can unassign the vault status from the amount of the asset in response to the timer reaching the threshold time (e.g., change the amount of the asset from the active vault status 430 to the inactive vault status 435), for instance to make the amount of the asset available for use in the transaction.

In some examples, combination of different partial signatures from different devices can be considered a form of multifactor authentication for the transaction, with different partial signatures representing the different factors of authentication for the transaction. Similarly, combination of different private key shares from different devices to form a private key can be considered a form of multifactor authentication for the transaction, with different private key shares representing the different factors of authentication for the transaction. By automating many of the MPC interactions between devices that allow the different partial signatures from different devices (and/or the different private key shares from different devices) to be used for multifactor authentication for the transaction, computer security and network security are improved without improving user interface complexity or user experience complexity.

In some examples, the partial signatures and/or private key shares represent new kinds of files that enable a computer security system to do things it could not do before, for instance to authenticate a transaction using partial data from different devices. In some examples, the partial signatures and/or private key shares can be used to detect suspicious activity, for instance if an attacker attempts to initiate a transaction without all of the partial signatures and/or private key shares needed, or with an incorrect partial signature and/or private key share (e.g., from before a previous key refresh). The system can take proactive measures in the event of such suspicious activity, for instance initiating a key refresh, banning the attacking user and/or device, invalidating the private key share(s) and/or partial signature(s) used by the attacker, or a combination thereof.

FIG. 24 is a flow diagram illustrating a process 2400 for asset recovery. The process 2400 can be performed by, and/or using, a transaction management system. The transaction management system can include, for instance, the first device 105, the second device 110, the third device 115, the mobile device 305, the server 330, the hardware wallet 340, the mobile device 505, the server 530, the hardware wallet 540, the server 615, the mobile device 630, the cloud backup 535, a mobile device with the app 705, the server 710, a mobile device with the app 805, the server 810, a mobile device with the app 905, the server 910, the WSM 915, a mobile device with the app 1005, the server 1010, the WSM 1015, a mobile device and/or application associated with the customer 1310, the server 1320, a mobile device with the app 1405, the server 1410, the WSM 1415, a mobile device with the app 1505, the server 1510, the WSM 1515, a system that performs the process 1800, a mobile device and/or application associated with the customer 1910, the server 1920, a mobile device and/or application associated with the trusted contact 2030, the transaction management system that performs the process 2200, the transaction management system that performs the process 2300, the transaction management system that performs the process 2500, the transaction management system that performs the process 2600, the transaction management system that performs the process 2700, the environment 2800 for application interface customization, the environment 2900, the system 3000, a system, an apparatus, a point of sale (POS) system or terminal, a transaction instrument reader device, a processor that performs instructions stored in a non-transitory computer-readable storage medium, any subsystems or components of any of the above-listed systems, any other computing systems discussed herein, or a combination thereof.

At operation 2405, the transaction management system (or a subsystem thereof) is configured to, and can, initiate a timer that is scheduled to count from a request time to an end time. The request time is associated with communication of (e.g., sending of and/or receiving of) a request for initiation of a recovery procedure.

A receipt of an input selecting the “yes” button in the user interface 510, for instance, could be an example of the request of operation 2405. A communication sent by the mobile device 505 in response to a receipt of an input selecting the “yes” button in the user interface 510 could be another example of the request of operation 2405. The timer in the user interface 560 is an example of the timer of operation 2405.

At operation 2410, the transaction management system (or a subsystem thereof) is configured to, and can, provide a notification indicative of the request and the end time. The notification includes an interactive element that is configured to trigger sending of a response to cancel the initiation of the recovery procedure. The user interface 560 is an example of the notification of operation 2610, which includes a countdown to the end time. The “cancel” button in the user interface 560 is an example of the interactive element of operation 2410.

In some examples, the request for initiation of the recovery procedure (of operation 2405) is communicated through a first communication channel, and the notification (of operation 2410) is communicated through a second communication channel that is different from the first communication channel. In some examples, one of the communication channels (the first communication channel or the second communication channel) is an email communication channel, a text message communication channel, or an application communication channel associated with an application (e.g., app 315, app 515, an application on the mobile device 630 associated with the app key share 640, app 705, app 805, app 905, app 1005, customer 1310, app 1405, app 1505, user 1605, customer 1910). The two communications channels being different improves security by ensuring that an attacker who submits the request (of operation 2405) does not also receive the notification (of operation 2410) unless the attacker controls both communication channels.

In some examples, the communication of the request (in operation 2405) includes receiving the request, and providing the notification (in operation 2410) includes sending the notification. For instance, in such examples, the transaction management system can be a server 615 or other system that receives the request from the mobile device 630, and provides the notification to the mobile device 630.

In some examples, the communication of the request (in operation 2405) includes sending the request, and providing the notification (in operation 2410) is responsive to receiving the notification. For instance, in such examples, the transaction management system can be a mobile device 630 that sends the request to another system (e.g., server 615) and receives the notification from the other system (e.g., from the server 615).

At operation 2415, the transaction management system (or a subsystem thereof) is configured to, and can, determine whether the response is communicated (e.g., sent and/or received) as of the end time (e.g., based on whether the interactive element of the notification has received an interaction or not). If the response is not communicated as of the end time, the process 2400 proceeds to operation 2420 after operation 2415. If the response is communicated as of the end time, the process 2400 proceeds to operation 2425 after operation 2415.

At operation 2420, the transaction management system (or a subsystem thereof) is configured to, and can, initiate the recovery procedure based on the response not being communicated as of the end time.

In some examples, initiating the recovery procedure (as in operation 2420) includes permitting a first device to decrypt an encrypted variant of a second device private key share from a secure enclave of the first device, the second device private key share having been generated by a second device. For instance, the server 615 or another system can permit the mobile device 630 to decrypt an encrypted variant of the server key share 645 from the secure enclave of the mobile device 630.

In some examples, initiating the recovery procedure (as in operation 2420) includes decrypting an encrypted variant of a second device private key share from a secure enclave of a first device, the second device private key share having been generated by a second device. For instance, the mobile device 630 can decrypt an encrypted variant of the server key share 645 from the secure enclave of the mobile device 630.

In some examples, initiating the recovery procedure (as in operation 2420) includes permitting communication of a first device private key share between a first device and a second device, the first device private key share having been generated by the first device. Communication of the first device private key share between the first device and the second device can refer to communication of the first device private key share from the first device to the second device (e.g., communication of the app key share 640 from the mobile device 630 to the cloud backup 635 to recover from loss of access to or an issue with the cloud backup 635), communication of the first device private key share from the second device to the first device (e.g., communication of the app key share 640 from the cloud backup 635 to the mobile device 630 to recover from loss of access to or an issue with the mobile device 630), or a combination thereof.

In some examples, initiating the recovery procedure (as in operation 2420) includes sending a first device private key share from a first device to a second device (e.g., sending the app key share 640 from the mobile device 630 to the cloud backup 635 to recover from loss of access to or an issue with the cloud backup 635), the first device private key share having been generated by the first device.

In some examples, initiating the recovery procedure (as in operation 2420) includes receiving a first device private key share at a first device and from a second device (e.g., receiving the app key share 640 from the cloud backup 635 at the mobile device 630 to recover from loss of access to or an issue with the mobile device 630), the first device private key share associated with the first device.

In some examples, initiating the recovery procedure (as in operation 2420) includes facilitating derivation of a social recovery key based on a personal identification number (PIN) using an oblivious pseudorandom function (OPRF) and authenticating a token, wherein the token is based on data from a trusted contact device.

In some examples, initiating the recovery procedure (as in operation 2420) includes facilitating derivation of a social recovery key using a personal identification number (PIN) and based on an oblivious pseudorandom function (OPRF), sending the social recovery key to a device, receiving a seed and nonce from the device in response to a verification of the social recovery key by the device, derives a token and an encryption key based on the seed and the nonce, provides the token for authentication to a second device to receive a ciphertext and an integrity tag, and decrypts the ciphertext in response to verifying an integrity of the ciphertext using the integrity tag. An example of this social recovery technique is shown in the process 2100 of FIG. 21, and can be based on the process 2000 of FIG. 20.

At operation 2425, the transaction management system (or a subsystem thereof) is configured to, and can, cancel the recovery procedure based on the response being communicated as of the end time (e.g., based on the interactive element having received an interaction before the end time is reached). The mechanism in the notification (of operation 2410) that allows the cancellation of the recovery procedure (as in operation 2425) can be referred to as a clawback mechanism.

In some examples, a duration of time between the request time and the end time is at least one day. In an illustrative example, the duration of time can be 3 days, 7 days (e.g., as in the table 1200), or another period of time discussed herein. The period of time being sufficiently long gives the user some time to react to the notification, improving security by ensuring that a legitimate user can cancel the recovery procedure if the request was sent by an attacker.

In some examples, the request to initiate secure recovery and the notification are communicated via different communication channels. For instance, the request can be communicated via a first communication channel, while the notification can be communicated via a second communication channel. The first communication channel and the second communication channel can improve computer security and network security in a similar way as multifactor authentication, for instance in that an attacker would need to control both the first communication channel and the second communication channel to gain access to the user's assets through the recovery mechanism. Lack of control over both the first communication channel and the second communication channel by an attacker could be detected as suspicious activity, giving the true user a chance to cancel the recovery procedure and proactively block the attacker from accessing the user's assets. The system can take additional proactive measures in the event of such suspicious activity, for instance initiating a key refresh, banning the attacking user and/or device, invalidating the private key share(s) and/or partial signature(s) used by the attacker, or a combination thereof.

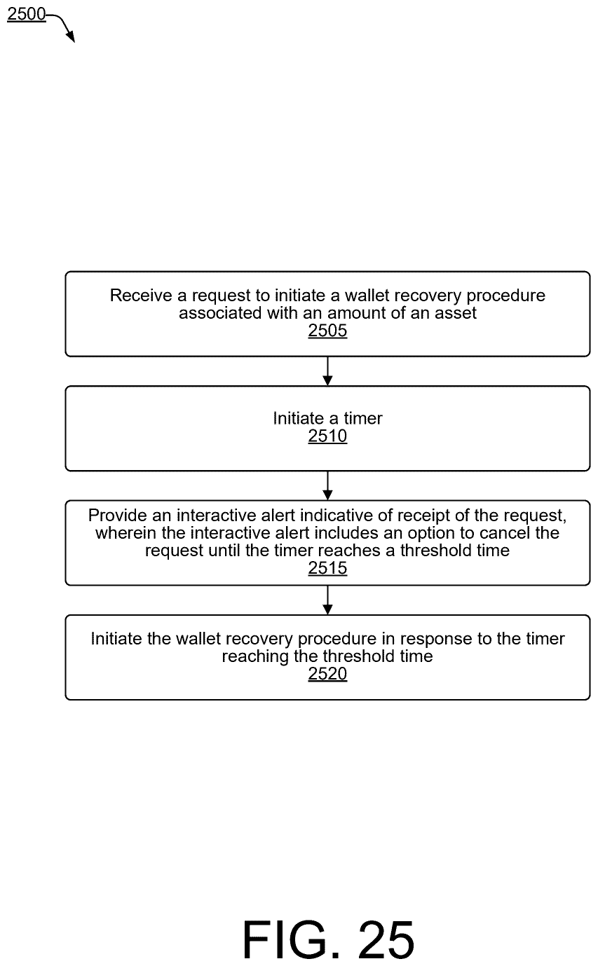

FIG. 25 is a flow diagram illustrating a process 2500 for wallet recovery. The process 2500 can be performed by, and/or using, a transaction management system. The transaction management system can include, for instance, the first device 105, the second device 110, the third device 115, the mobile device 305, the server 330, the hardware wallet 340, the mobile device 505, the server 530, the hardware wallet 540, the server 615, the mobile device 630, the cloud backup 535, a mobile device with the app 705, the server 710, a mobile device with the app 805, the server 810, a mobile device with the app 905, the server 910, the WSM 915, a mobile device with the app 1005, the server 1010, the WSM 1015, a mobile device and/or application associated with the customer 1310, the server 1320, a mobile device with the app 1405, the server 1410, the WSM 1415, a mobile device with the app 1505, the server 1510, the WSM 1515, a system that performs the process 1800, a mobile device and/or application associated with the customer 1910, the server 1920, a mobile device and/or application associated with the trusted contact 2030, the transaction management system that performs the process 2200, the transaction management system that performs the process 2300, the transaction management system that performs the process 2400, the transaction management system that performs the process 2600, the transaction management system that performs the process 2700, the environment 2800 for application interface customization, the environment 2900, the system 3000, a system, an apparatus, a point of sale (POS) system or terminal, a transaction instrument reader device, a processor that performs instructions stored in a non-transitory computer-readable storage medium, any subsystems or components of any of the above-listed systems, any other computing systems discussed herein, or a combination thereof.

At operation 2505, the transaction management system (or a subsystem thereof) is configured to, and can, receive a request to initiate a wallet recovery procedure associated with an amount of an asset. Examples of the wallet recovery procedure include the wallet recovery procedures of FIGS. 5A, 5B, 6, 11, 12, 13, 14, 15, and 16.

At operation 2510, the transaction management system (or a subsystem thereof) is configured to, and can, initiate a timer, as in the timer of the user interface 560.

At operation 2515, the transaction management system (or a subsystem thereof) is configured to, and can, provide an interactive alert indicative of receipt of the request. The interactive alert includes an option to cancel the request until the timer reaches a threshold time, as in the user interface 560.

At operation 2520, the transaction management system (or a subsystem thereof) is configured to, and can, initiate the wallet recovery procedure in response to the timer reaching the threshold time.

In some examples, the wallet recovery procedure includes a mobile device (e.g., mobile device 630) retrieving a private key share (e.g., a backed up instance of the app key share 640) from a cloud server (e.g., cloud backup 635). In some examples, the wallet recovery procedure includes a cloud server (e.g., cloud backup 635) retrieving a private key share (e.g., the instance of the app key share 640 at mobile device 630) from a mobile device (e.g., mobile device 630).

In some examples, the wallet recovery procedure includes use of a dual oblivious pseudo-random function (D-OPRF) to decrypt a pre-signed transaction (PST) from a trusted contact device.

In some examples, the wallet recovery procedure includes retrieval of a first private key share (e.g., private key share 135C) from a hardware wallet device (e.g., third device 115, hardware wallet 340, hardware wallet 540) and a second private key share (e.g., private key share 135A, server key share 645) from a server (e.g., first device 105, server 330, server 530, server 615, server 710, server 810, server 910, server 1010, server 1410, server 1510).

In some examples, the wallet recovery procedure includes a personal identification number (PIN) update process.

In some examples, the wallet recovery procedure includes decryption of a server key share (e.g., server key share 645) in a secure enclave of a mobile device (e.g., mobile device 630) and combination of the server key share with an app key share (e.g., mobile device 630) of the mobile device (e.g., mobile device 630).

In some examples, the transaction management system(s) of FIGS. 22-27 (or a subsystem thereof) is configured to, and can, provide additional features to improve privacy, for instance using proof-of-solvency zero-knowledge proofs to make the vault privacy preserving. For instance, in some examples, the transaction management system(s) can prove that a user is solvent mathematically, via blinded calculations with encrypted data, without revealing what UTXOs the user controls control and how much of any asset (e.g., cryptocurrency such as Bitcoin) the user has. Blinded calculations refer to calculations using encrypted values that are encrypted using homomorphic encryption. For instance, the number 5 can be blinded (encrypted via homomorphic encryption) and added to a blinded number 10 (encrypted via homomorphic encryption) to produce a blinded number 15 (encrypted via homomorphic encryption). In some examples, the transaction management system(s) (e.g., server and/or mobile device) can take advantage of the ability to calculate blinded values (that are encrypted via homomorphic encryption) to perform various calculations without revealing any information about the user, their assets, and/or any transactions.

In some examples, the transaction management system(s) (e.g., server and/or mobile device) takes a whole UTXO set, and for each UTXO, creates a zero knowledge proof. The transaction management system(s) creates a commitment to the value of the asset(s) (e.g., cryptocurrency) at that UTXO, and creates a zero knowledge proof of that commitment. In some examples, the transaction management system(s) either (a) knows the private key for the UTXO and they're multiplying the blinded commitment by one, or (b) doesn't know the private key, and multiplies the blinded commitment by zero. The transaction management system(s) adds up all these blinded commitments (and/or associated multiplication products). In some examples, then, some UTXOs where the private key is unknown to the transaction management system(s) (e.g., servers) are zero, and the UTXOs where the private key is known to the transaction management system(s) (e.g., servers) are the value of the UTXO. The transaction management system(s) (e.g., servers) can sum these together, and get a blinded sum of assets that the transaction management system(s) (e.g., servers) can check against to identify whether one or more users are solvent, have enough of an asset to perform a transaction, and the like.

In some examples, the transaction management system(s) of FIGS. 22-27 (or a subsystem thereof) is configured to, and can, identify liabilities in a blinded manner to preserve and/or improve users' privacy. For instance, in some examples, the transaction management system(s) of FIGS. 22-27 (or a subsystem thereof) (e.g., a server associated with a cryptocurrency exchange) is configured to, and can, for each user, create a blinded commitment to the user's liability, and then give the blinded commitment to each user. If the exchange is lying, the user can catch it by checking against the blinded commitment (e.g., decrypting the blinded commitment or performing a calculation against the blinded commitment). In some examples, these blinded commitments can be summed, in a blinded manner, to identify liabilities associated with the exchange. In some examples, blinded assets can be summed similarly to identify assets managed by the exchange. In some examples, the blinded sum of liabilities can be subtracted from the blinded sum of assets to identify if the exchange is solvent.

In some examples, similar blinded computations can be used to implement velocity controls (e.g., rules and/or parameters that limit the number and amount of transactions that can be made within a given time period), either for individual users, for groups of users (e.g., a family or company or organization), or across the entire exchange, in a zero-knowledge manner to preserve privacy. For instance, the transaction management system(s) (e.g., the mobile device) can create a blinded sum of assets and/or a blinded sum of commitments. Each time the balance, assets, and/or commitments change, the transaction management system(s) (e.g., the mobile device) can register a blinded update to the balance, assets, and/or commitments with the server. In some examples, when a transfer of assets (e.g., funds) is requested, the mobile device and/or server can the blinded sum of assets minus the blinded commitment that's been registered with the server, minus the blinded transaction amount. If the result is greater or equal to zero, then the transaction management system(s) (e.g., the mobile device and/or server) know the user has enough funds (e.g., outside the vault) to spend.

In some examples, the transaction management system(s) of FIGS. 22-27 (or a subsystem thereof) is configured to, and can, provide another layer of improved security by improving over traditional personal identification numbers (PINs). In some cases, it is useful for the transaction management system(s) to have an additional way, or authentication factor, to prove that a user (e.g., user 605 or a trusted contact for social recovery) is who they say they are. Additional hardware, such as a hardware wallet (e.g., third device 115, hardware wallet 340, hardware wallet 540) can be one such additional authentication factor. However, an improved PIN system can provide another. PINs are typically short, for instance being four or six digits, so that users can remember them. But the problem with the short pin is that it is not secure. For instance, for a four digit PIN, there are only 10,000 possible PINs, so an attacker could feasible guess a four digit PIN. A six-digit PIN might be slightly more secure. In some examples, to improve over this while still not requiring the user to memorize a longer password, the transaction management system(s) of FIGS. 22-27 (or a subsystem thereof) is configured to, and can, use an oblivious pseudo random function (OPRF) run on a server. In an illustrative example, a mobile device can receive a PIN, input via a user interface. To generate a strong (long and complex) key from the relatively short PIN without revealing the PIN or key to the server, the mobile can blind the PIN (e.g., encrypt the PIN via homomorphic encryption) and send the blinded PIN to the server. The server computes a long key (e.g., which the server may blind) based upon the server's own secret key (e.g., server key share 645 or another key or key share) and the blinded PIN to generate a blinded result. The server sends the blinded result back to the mobile device. Then the phone unblinds the result to have a secure (long and complex) key. This way, the server knows neither the PIN nor the key-only the mobile phone does. However, now, the mobile device has a strong key, generated using the OPRF, that the mobile device can use to encrypt and/or protect its assets, transactions, and the like.

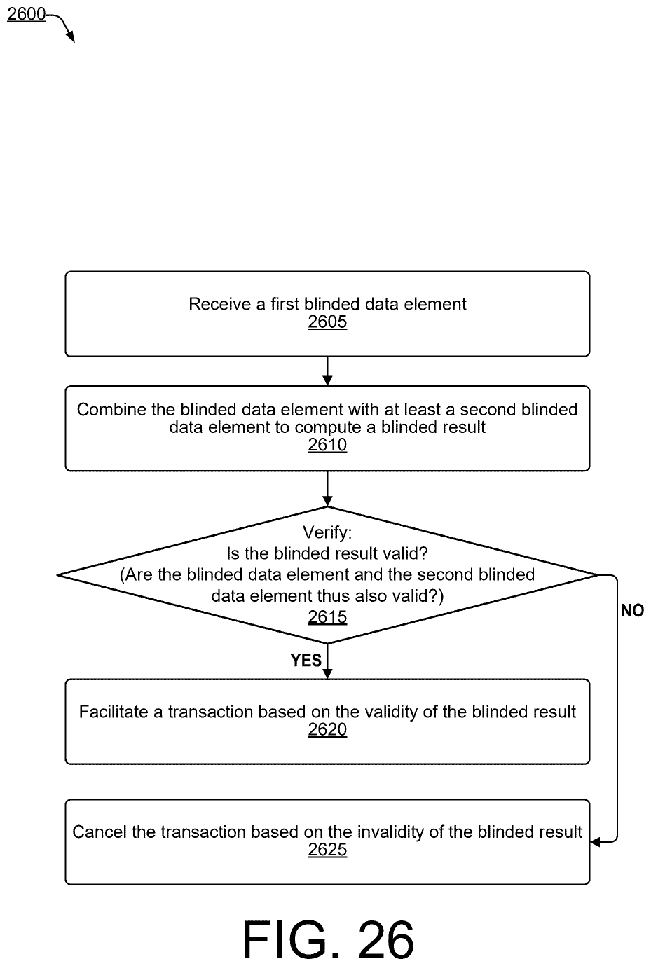

FIG. 26 is a flow diagram illustrating a process for improving privacy through blinded computations. The process 2600 can be performed by, and/or using, a transaction management system. The transaction management system can include, for instance, the first device 105, the second device 110, the third device 115, the mobile device 305, the server 330, the hardware wallet 340, the mobile device 505, the server 530, the hardware wallet 540, the server 615, the mobile device 630, the cloud backup 535, a mobile device with the app 705, the server 710, a mobile device with the app 805, the server 810, a mobile device with the app 905, the server 910, the WSM 915, a mobile device with the app 1005, the server 1010, the WSM 1015, a mobile device and/or application associated with the customer 1310, the server 1320, a mobile device with the app 1405, the server 1410, the WSM 1415, a mobile device with the app 1505, the server 1510, the WSM 1515, a system that performs the process 1800, a mobile device and/or application associated with the customer 1910, the server 1920, a mobile device and/or application associated with the trusted contact 2030, the transaction management system that performs the process 2200, the transaction management system that performs the process 2300, the transaction management system that performs the process 2400, the transaction management system that performs the process 2500, the transaction management system that performs the process 2700, the environment 2800 for application interface customization, the environment 2900, the system 3000, a system, an apparatus, a point of sale (POS) system or terminal, a transaction instrument reader device, a processor that performs instructions stored in a non-transitory computer-readable storage medium, any subsystems or components of any of the above-listed systems, any other computing systems discussed herein, or a combination thereof.

At operation 2605, the transaction management system (or a subsystem thereof) is configured to, and can, receive a first blinded data element. At operation 2610, the transaction management system (or a subsystem thereof) is configured to, and can, combine the blinded data element with at least a second blinded data element to compute a blinded result.

In some examples, transaction management system (or a subsystem thereof) is configured to, and can, receive the second blinded data element before operation 2610.

In some examples, the first blinded data element is a variant of a data element that is encrypted using homomorphic encryption. In some examples, the second blinded data element is a variant of a second data element that is encrypted using homomorphic encryption.

At operation 2615 the transaction management system (or a subsystem thereof) is configured to, and can, verify whether the blinded result is valid. In some examples, at operation 2615, the transaction management system (or a subsystem thereof) is configured to, and can, verify whether the first blinded data element and/or the second blinded data element are valid, for instance based on whether the blinded result is valid. If the blinded result is valid (and/or the first blinded data element and/or the second blinded data element are valid), then the process 2600 proceeds from operation 2615 to operation 2620. If the blinded result is invalid (and/or the first blinded data element and/or the second blinded data element are invalid), then the process 2600 proceeds from operation 2615 to operation 2625.

In some examples, the transaction management system (or a subsystem thereof) is configured to, and can send the blinded result to a device, and receive a confirmation of the validity (or invalidity) of the blinded result from the device (e.g., based on the device unblinding the blinded result). In such examples, verifying the validity (or invalidity) of the blinded result is based on the confirmation received from the device.

At operation 2620, the transaction management system (or a subsystem thereof) is configured to, and can, facilitate a transaction based on the validity of the blinded result.

At operation 2625, the transaction management system (or a subsystem thereof) is configured to, and can, cancel the transaction based on the invalidity of the blinded result.

In some examples, the process 2600 can be used to improve privacy for wallet descriptors. For instance, in some examples, the first blinded data element is associated with a key, and the second blinded data element is a key tweak, such as a Bitcoin Improvement Proposal 32 (BIP32) tweak (e.g., BIP32 tweak 1840 and/or a Taproot tweak (e.g., taproot tweak 1830). In some examples, a blinded wallet descriptor can be the blinded result is the taproot output key 1855 (or a blinded variant thereof). In some examples, the first blinded data element, the second blinded element, or the blinded result.

In some examples, the process 2600 can be used to improve privacy for signing. For instance, in some examples, the first blinded data element is a blinded nonce commitment and the second blinded data element is a blinded challenge hash (or vice versa), and the blinded result is a blinded signature. In some examples, the transaction management system (or a subsystem thereof) is configured to, and can, receive the second blinded data element (e.g., the challenge hash or the blinded nonce commitment). In some examples, the transaction management system (or a subsystem thereof) is configured to, and can, send a nonce commitment to a device, where the blinded nonce commitment is received from the device and is a blinded variant of the nonce commitment. In some examples, the transaction management system (or a subsystem thereof) is configured to, and can, send the blinded signature to a device, and receive a confirmation of the validity (or invalidity) of the blinded signature from the device based on the device unblinding the blinded signature. In some examples, verifying the validity (or invalidity) of the blinded result (as in operation 2615) is based on the confirmation.

In some examples, the process 2600 can be used to improve privacy for a wallet (e.g., how much is stored in the wallet). For instance, in some examples, the first blinded data element is a first commitment associated with a first unspent transaction output (UTXO), the second blinded data element is a second commitment associated with a second UTXO, and the blinded result is associated with a total amount of assets in a wallet (e.g., or a commitment associated therewith). In some examples, the blinded result can indicate, either in its blinded form or unblinded form, whether the total amount of assets in the wallet is positive, negative, or zero. In some examples, the blinded result can indicate, either in its blinded form or unblinded form, whether the total amount of assets in the wallet is zero or nonzero. In some examples, at least one of the UTXOs (e.g., the first UTXO and/or the second UTXO) is associated with a transfer of at least one asset relative to the wallet, such as a deposit of the at least one asset into the wallet and/or a withdrawal of at least one asset from the wallet. In some examples, at least one of the UTXOs (e.g., the first UTXO and/or the second UTXO) is associated with a transaction that involves the wallet and at least one asset. In some examples, at least one of the UTXOs (e.g., the first UTXO and/or the second UTXO) is associated with a Pay-to-Taproot (P2TR) UTXO set.

In some examples, the process 2600 can be used to improve privacy for a wallet (e.g., how much is assigned an active vault status 430 and/or how much is assigned an inactive vault status 435 in a wallet). For instance, in some examples, the first blinded data element is a first commitment associated with a first unspent transaction output (UTXO), the second blinded data element is a second commitment associated with a second UTXO, and the blinded result is associated with a total amount of assets without a vault status (unvaulted assets) in a wallet (e.g., total amount of assets available for a transfer 440) (e.g., or a commitment associated therewith). In some examples, the blinded result can indicate, either in its blinded form or unblinded form, whether the total amount of vaulted assets (e.g., assets with active vault status 430) and/or unvaulted assets (e.g., assets with inactive vault status 435) in the wallet is positive, negative, or zero. In some examples, the blinded result can indicate, either in its blinded form or unblinded form, whether the total amount of vaulted assets or unvaulted assets in the wallet is zero or nonzero. In some examples, at least one of the UTXOs (e.g., the first UTXO and/or the second UTXO) is associated an assignment of the vault status (e.g., active vault status 430) to at least one asset in the wallet. In some examples, at least one of the UTXOs (e.g., the first UTXO and/or the second UTXO) is associated with a removal of the vault status (e.g., a transition from active vault status 430 to inactive vault status 435, for instance in response to a request 445 or a time-based expiration of the active vault status 430) from at least one asset in the wallet corresponds to at least one of the first UTXO or the second UTXO. In some examples, at least one of the UTXOs (e.g., the first UTXO and/or the second UTXO) is associated with a transfer of at least one asset relative to the wallet, such as a deposit of the at least one asset into the wallet and/or a withdrawal of at least one asset from the wallet. In some examples, at least one of the UTXOs (e.g., the first UTXO and/or the second UTXO) is associated with a transaction that involves the wallet and at least one asset. In some examples, at least one of the UTXOs (e.g., the first UTXO and/or the second UTXO) is associated with a Pay-to-Taproot (P2TR) UTXO set.

In some examples, the process 2600 can be used to improve privacy for a wallet, a vault, and/or transaction(s) involving the wallet and/or the vault. For instance, in some examples, the first blinded data element is a first commitment associated with a first total amount of assets (or unvaulted assets) in a wallet before the transaction, the second blinded data element is a second commitment associated with an amount of assets to be withdrawn from the wallet to conduct the transaction, and the blinded result is associated with a second total amount of assets (or unvaulted assets) in the wallet after the transaction. In some examples, the blinded result can indicate, either in its blinded form or unblinded form, whether the total amount of assets (or unvaulted assets) in the wallet after the transaction is positive, negative, or zero. In some examples, the blinded result can indicate, either in its blinded form or unblinded form, whether the total amount of assets (or unvaulted assets) in the wallet after the transaction is zero or nonzero. In some examples, the blinded result can indicate, either in its blinded form or unblinded form, whether there are enough assets (or unvaulted assets) in the wallet to conduct the transaction. This can improve security and privacy by providing a way to ensure that users have enough funds to conduct a transaction without revealing how much the users have in total.

Blinded calculations can involve calculations with blinded values, or values that are encrypted using homomorphic encryption. By using blinded computations to verify a validity of the blinded result and ultimately facilitate a transaction, the homomorphic encryption used in the blinded calculation represents an encryption technique that improves network security and computer security. Furthermore, the blinded data elements can represent new kinds of data that enable a computer security system to do things it could not do before, namely verify validity of data without knowing the exact makeup of the data (e.g., without knowing a value in the data), thus improving privacy and security. In some examples, such blinded verification allows verification to be performed in scenarios where verification would otherwise be avoided (to avoid a loss in privacy), thus improving security by enabling addition of verification operations in privacy-sensitive scenarios (e.g., where data includes, or is related to, private key shares, partial signatures, PINs, wallet descriptors, asset amounts in a wallet, vaulted asset amounts, unvaulted asset amounts, other sensitive data, or combinations thereof).

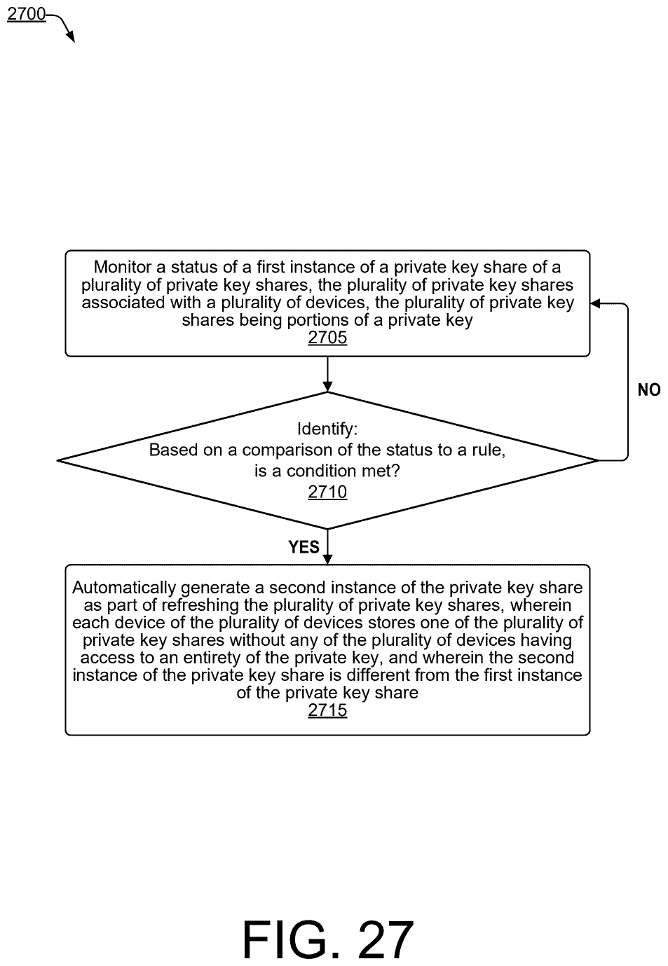

FIG. 27 is a flow diagram illustrating a process for improving security through key share rotation. The process 2700 can be performed by, and/or using, a transaction management system. The transaction management system can include, for instance, the first device 105, the second device 110, the third device 115, the mobile device 305, the server 330, the hardware wallet 340, the mobile device 505, the server 530, the hardware wallet 540, the server 615, the mobile device 630, the cloud backup 535, a mobile device with the app 705, the server 710, a mobile device with the app 805, the server 810, a mobile device with the app 905, the server 910, the WSM 915, a mobile device with the app 1005, the server 1010, the WSM 1015, a mobile device and/or application associated with the customer 1310, the server 1320, a mobile device with the app 1405, the server 1410, the WSM 1415, a mobile device with the app 1505, the server 1510, the WSM 1515, a system that performs the process 1800, a mobile device and/or application associated with the customer 1910, the server 1920, a mobile device and/or application associated with the trusted contact 2030, the transaction management system that performs the process 2200, the transaction management system that performs the process 2300, the transaction management system that performs the process 2400, the transaction management system that performs the process 2500, the transaction management system that performs the process 2600, the environment 2800 for application interface customization, the environment 2900, the system 3000, a system, an apparatus, a point of sale (POS) system or terminal, a transaction instrument reader device, a processor that performs instructions stored in a non-transitory computer-readable storage medium, any subsystems or components of any of the above-listed systems, any other computing systems discussed herein, or a combination thereof.

At operation 2705, the transaction management system (or a subsystem thereof) is configured to, and can, monitor a status of a first instance of a private key share of a plurality of private key shares. The plurality of private key shares are associated with a plurality of devices. For instance, different private key shares correspond to different devices of the plurality of devices. The plurality of private key shares are portions of a private key. None of the plurality of devices have access to an entirety of the private key.

At operation 2710, the transaction management system (or a subsystem thereof) is configured to, and can, identify, based on a comparison of the status to a rule, whether a condition is met (or satisfied). If the condition is met (or satisfied), then the process 2700 proceeds from operation 2710 to operation 2715. If the condition is not met (not satisfied), then the process 2700 proceeds from operation 2710 back to operation 2705, for instance to continue monitoring the status of the first instance of the private key share until the condition is eventually met.

In some examples, the condition (of operation 2710) is associated with a timer reaching a threshold time. The timer measures time since generation of the first instance of the private key shares. For instance, the key shares can be refreshed periodically according to an interval, with the threshold time representing the interval at which the key shares are refreshed periodically. In some examples, the transaction management system (or a subsystem thereof) is configured to, and can, receive an input, and can set the threshold time based on the input. The input can be received via a user interface, for instance of a mobile device (e.g., second device 110, mobile device 305, mobile device 505, mobile device 630, mobile device with app 705, mobile device with app 805, mobile device with app 905, mobile device with app 1005, customer 1310, mobile device with app 1450, mobile device with app 1505, user 1605, customer 1910) or a server (e.g., first device 105, server 330, server 530, server 615, server 710, server 810, server 910, server 1010, server 1320, server 1410, server 1510, server 1920). Setting the threshold time based on the input can refer to initiating the threshold time, modifying the threshold time, increasing the threshold time, and/or decreasing the threshold time. Periodic key refreshes can improve security by increasing the difficulty of an attacker obtaining all key shares from the same period or interval, as the attacker would need to do to access the user's assets.

In some examples, the condition (of operation 2710) is associated with at least one of the plurality of devices being updated, replaced, modified, lost, stolen, compromised, or a combination thereof. Initiating a key refresh upon update, replacement, or modification of a device allows the system to be flexible, for instance allowing users to periodically update their mobile devices (e.g., updating operating system(s)) or replace their mobile devices (e.g., with new hardware) over time. Initiating a key refresh upon the an indication of one of the devices being lost, stolen, and/or compromised can improve security by preventing an attacker from obtaining other key shares that would still be required for the attacker to access the user's assets, even if the attacker is able to obtain one key share from the device that is lost, stolen, and/or compromised.

In some examples, the condition (of operation 2710) is associated with a private key share recovery procedure, such as any of the recovery procedures of FIG. 5A, 5B, 6, 11, 12, 24, or 25, or any other recovery procedures discussed herein.

In some examples, the condition (of operation 2710) is associated with an indication that at least one of the plurality of private key shares is exposed or compromised. Initiating a key refresh upon exposure or compromise of a key share can improve security by preventing an attacker from obtaining other key shares that would still be required for the attacker to access the user's assets.

At operation 2715, the transaction management system (or a subsystem thereof) is configured to, and can, automatically generate a second instance of the private key share as part of refreshing the plurality of private key shares. Each device of the plurality of devices stores one of the plurality of private key shares without any of the plurality of devices having access to an entirety of the private key. The second instance of the private key share is different from the first instance of the private key share.

In some examples, generating the second instance of the private key share (in operation 2715) is based on a multi-round interactive protocol for distributed key generation (DKG) that includes communications between the plurality of devices, for instance as illustrated in FIG. 1. In some examples, the first instance of the private key share is based on a multi-round interactive protocol for distributed key generation (DKG) that includes communications between the plurality of devices, for instance as illustrated in FIG. 1.

In some examples, the transaction management system (or a subsystem thereof) is configured to, and can, generate a random value

$$( e . g . , {a}_{i 1}^{′} ← {ℤ}_{q} ) .$$

In some examples, generating the second instance of the private key share (in operation 2715) is based on the random value.

In some examples, the transaction management system (or a subsystem thereof) is configured to, and can, receive a refresh package

$$( e . g . , 〈 {ϕ}_{i 1}^{′} , {f}_{i}^{′} ( ℓ ) 〉 )$$

associated with a second private key share of the plurality of private key shares, and verify the refresh package. In such examples, generating the second instance of the private key share (in operation 2715) is responsive to verification of the refresh package.

In some examples, the transaction management system (or a subsystem thereof) is configured to, and can, update a first verifiable secret sharing (VSS) commitment in response to generating the second instance of the private key share. The transaction management system can receive a second VSS commitment. The transaction management system can verify that the second VSS commitment corresponds to (e.g., matches) the first VSS commitment, for instance thus:

$$\vec{\hat{C}} ← {P}_{ℓ}$$

$${\vec{C}}^{′} \vec{\hat{C}}$$

In some examples, the transaction management system (or a subsystem thereof) is configured to, and can, send the second instance of the private key share to a backup device to back up the second instance of the private key share (e.g., sending a refreshed variant of the app key share 640 from the mobile device 630 to the cloud backup 635 to back up the refreshed variant of the app key share 640).

In some examples, the transaction management system (or a subsystem thereof) is configured to, and can, invalidate the first instance of the private key share. This improves security because, if an attacker attempts to use the first instance of the private key share with a second instance of another private key share, no valid private key (or signature) could be created.

19. The computer-implemented method of claim 5, the transaction management system (or a subsystem thereof) is configured to, and can, cause the second instance of the private key share to be stored, in encrypted form, in a secure enclave (e.g., storing the refreshed variant of the server key share 645 in the secure enclave of the mobile device 630).

In some examples, refreshing the different private key shares from different devices that would form a private key could be considered a form of updating a multifactor authentication for a transaction to improve security of the multifactor authentication. For instance, refreshing the different private key shares also refreshes the different partial signatures from the different devices, again updating a multifactor authentication for a transaction to improve security of the multifactor authentication. By automating many of the MPC interactions between devices that allow the different partial signatures from different devices (and/or the different private key shares from different devices) to be used and/or updated for multifactor authentication for the transaction, computer security and network security are improved without improving user interface complexity or user experience complexity.

In some examples, the partial signatures and/or private key shares represent new kinds of files that enable a computer security system to do things it could not do before, for instance to authenticate a transaction using partial data from different devices. In some examples, the partial signatures and/or private key shares can be used to detect suspicious activity, for instance if an attacker attempts to initiate a transaction without all of the partial signatures and/or private key shares needed, or with an incorrect partial signature and/or private key share (e.g., from before a previous key refresh). The system can take proactive measures in the event of such suspicious activity, for instance initiating a key refresh, banning the attacking user and/or device, invalidating the private key share(s) and/or partial signature(s) used by the attacker, or a combination thereof.

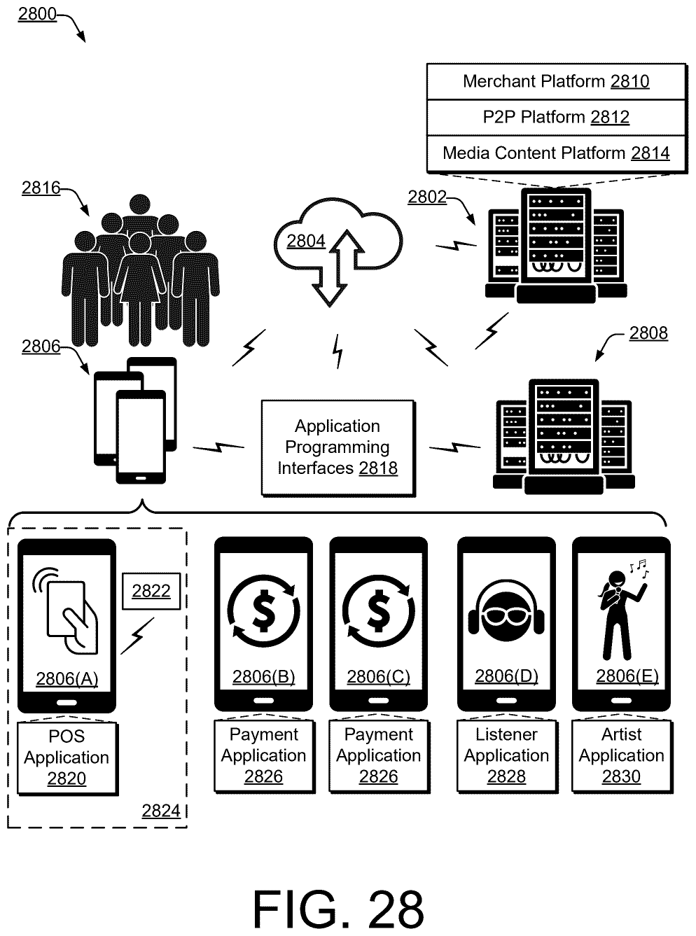

FIG. 28 illustrates an example environment 2800 for application interface customization. The environment 2800 includes server(s) 2802 that can communicate over a network 2804 with end user devices 2806 and/or server(s) 2808 associated with third-party service provider(s). In various examples, the end user devices 2806 may comprise one or more merchant devices 2806(A), one or more user devices 2806(B) and/or 2806(C) in a peer network, one or more content consumption devices 2806(D), one or more artist user devices 2806(E), combinations of these examples, or other categories of user devices. The server(s) 2802 can be associated with one or more service providers that can provide one or more services for the benefit of users 2816, as described below. For example, the server(s) 2802 may enable services of service providers such as in association with a merchant platform 2810 (which may further include a buyer platform), a peer-to-peer (P2P) payment platform 2812, a media content platform 2814, a combination of these platforms, or other platforms associated with other service providers. While services and features are referenced throughout in connection with a particular one of the merchant platform 2810, the P2P payment platform 2812, or the media content platform 2814, it should be understood that any of these platforms may perform the functionality described in relation to any of the other platforms. Actions attributed to the service provider(s) can be performed by the server(s) 2802.

In some examples, the end user devices 2806, merchant platform 2810, P2P platform 2812, and/or media content platform 2814 can be examples of the first device 105, the second device 110, the third device 115, the mobile device 305, the server 330, the hardware wallet 340, the mobile device 505, the server 530, the hardware wallet 540, the server 615, the mobile device 630, the cloud backup 535, a mobile device with the app 705, the server 710, a mobile device with the app 805, the server 810, a mobile device with the app 905, the server 910, the WSM 915, a mobile device with the app 1005, the server 1010, the WSM 1015, a mobile device and/or application associated with the customer 1310, the server 1320, a mobile device with the app 1405, the server 1410, the WSM 1415, a mobile device with the app 1505, the server 1510, the WSM 1515, a system that performs the process 1800, a mobile device and/or application associated with the customer 1910, the server 1920, a mobile device and/or application associated with the trusted contact 2030, the transaction management system that performs the process 2200, the transaction management system that performs the process 2300, the transaction management system that performs the process 2400, the transaction management system that performs the process 2500, the transaction management system that performs the process 2600, the transaction management system that performs the process 2700, or a combination thereof. In some examples, individual ones of the end user devices 2806 can be operable by users 2816 (e.g., user 605, user 1605). The users 2816 (individually referred to herein as “user 2816”) can be referred to as miners, customers, buyers, merchants, sellers, borrowers, employees, employers, payors, payees, couriers, artists, musicians, listeners, fans, supervisors, hosts, audience members, and so on. The users 2816 can interact with the end user devices 2806 via user interfaces presented via the end user devices 2806. In at least one example, a user interface can be presented via a web browser, or the like. Alternatively or additionally, a user interface can be presented via an application, such as a mobile application or desktop application, which can be provided by the merchant platform 2810, the P2P payment platform 2812, and/or the media content platform 2814, or which can be an otherwise dedicated application. In some examples, individual end user devices 2806 can have an instance or versioned instance of an application, which can be downloaded from an application store, for example, which can present the user interface(s) described herein.

In at least one example, the users 2816 can include merchants that can operate the seller device(s) 2806(A) that are configured for use by merchants. For the purpose of this discussion, a “merchant” can be any entity that offers items (e.g., goods or services) for purchase or other means of acquisition (e.g., rent, borrow, barter, etc.). The merchants can offer items for purchase or other means of acquisition via brick-and-mortar stores, mobile stores (e.g., pop-up shops, food trucks, etc.), online stores, event venues, combinations of the foregoing, and so forth. In some examples, at least some of the merchants can be associated with the same entity but can have different merchant locations and/or can have franchise/franchisee relationships.

In additional or alternative examples, the merchants can be different merchants. For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN) s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships—can be referred to as merchants having different merchant locations and/or different commerce channels.

The seller device 2806(A) can have an instance of a point of sale (“POS”) application 2820 stored thereon. The POS application 2820 can configure the seller device 2806(A) as a POS terminal, which enables the merchant to interact with one or more customers. In at least one example, interactions between the customers and the merchants that involve the exchange of funds (from the customers) for items or services (from the merchants) can be referred to as “transactions.” In at least one example, the POS application 2820 can determine transaction data associated with the POS transactions. Transaction data can include payment information, which can be obtained from a reader device 2822 associated with the seller device 2806(A), user authentication data, purchase amount information, point-of-purchase information (e.g., item(s) purchased, date of purchase, time of purchase, subscription type, etc.), etc. The POS application 2820 can send transaction data to the server(s) 2802 such that the server(s) 2802 can track transactions of the customers, merchants, and/or the users 2816 over time. Furthermore, the POS application 2820 can present a UI to enable the merchant to interact with the POS application 2820 and/or the merchant platform 2810 via the POS application 2820.

In at least one example, the seller device 2806(A) can be a special-purpose computing device configured as a POS terminal (via the execution of the POS application 2820). In at least one example, the POS terminal may be connected to a reader device 2822, which is capable of accepting a variety of payment instruments, such as credit cards, debit cards, gift cards, short-range communication based payment instruments, and the like, as described below. In at least one example, the reader device 2822 can plug in to a port in the seller device 2806(A), such as a microphone port, a headphone port, an audio-jack, a data port, or other suitable port. In additional or alternative examples, the reader device 2822 can be coupled to the seller device 2806(A) via another wired or wireless connection, such as via Bluetooth®, BLE, and so on. In some examples, the reader device 2822 can be a software solution executing on the POS terminal, e.g., a mobile phone. In some examples, the reader device 2822 can read information from alternative payment instruments including, but not limited to, wristbands and the like.

In some examples, the reader device 2822 may physically interact with payment instruments such as magnetic stripe payment cards, EMV payment cards, and/or short-range communication (e.g., near field communication (NFC), radio frequency identification (RFID), Bluetooth®, Bluetooth® low energy (BLE), etc.) payment instruments (e.g., cards, hardware wallets, fobs, or devices configured for tapping). The POS terminal may provide a rich user interface, communicate with the reader device 2822, and communicate with the merchant platform 2810, which can provide, among other services, a payment processing service. The server(s) 2802 associated with the merchant platform 2810 can communicate with server(s) 2808, as described below. In this manner, the POS terminal and reader device 2822 may collectively process transaction(s) between the merchants and customers. In some examples, multiple POS terminal(s) may be connected to a number of other devices, such as “secondary” terminals, e.g., back-of-the-house systems, printers, line-buster devices, reader devices, speakers, and the like, to allow for information from the secondary terminal to be shared between the primary POS terminal(s) and secondary terminal(s), for example via short-range communication technology. This kind of arrangement may continue operation in an offline-online scenario to allow one device (e.g., secondary terminal) to continue taking user input, and synchronize data with another device (e.g., primary terminal) when the primary or secondary terminal switches to online mode. In other examples, such data synchronization may happen periodically or at randomly selected time intervals.

While the POS terminal and the reader device 2822 of the POS system 2824 are shown as separate devices, in additional or alternative examples, the POS terminal and the reader device 2822 can be part of a single device. In some examples, the reader device 2822 can have a display integrated therein for presenting information to customers of a merchant. In additional or alternative examples, the POS terminal can have a display integrated therein for presenting information to the customers of the merchant. POS systems, such as the POS system 2824, may be mobile, such that POS terminals and reader devices may process transactions in disparate locations across the world. POS systems can be used for processing card-present transactions and card-not-present (CNP) transactions.

A card-present transaction is a transaction where both a customer and the customer's payment instrument are physically present at the time of the transaction. Card-present transactions may be contact or contactless transactions processed by swipes (e.g., by sliding a magnetic strip through a reader device), dips (e.g., by inserting an embedded microchip into a reader device), taps (e.g., by wirelessly, through Bluetooth, NFC or other short range technology hover or tap a payment instrument into a reader device), or any other interaction between a physical payment instrument (e.g., a card), or otherwise present payment instrument, and a reader device 2822, whereby the reader device 2822 is able to obtain payment data from the payment instrument.

A CNP transaction is a transaction where a card, or other payment instrument, is not physically present at the POS such that payment data is manually keyed in (e.g., by a merchant, customer, etc.), or payment data is required to be recalled from a card-on-file data store, to complete the transaction.

The POS system 2824, the server(s) 2802, and/or the server(s) 2808 may exchange payment information and transaction data to determine whether transactions are authorized. For example, the POS system 2824 may provide encrypted payment data, user authentication data, purchase amount information, point-of-purchase information, etc. (collectively, transaction data) to server(s) 2802 over the network(s) 2804. The server(s) 2802 may send the transaction data to the server(s) 2808.

For the purpose of this discussion, the “payment service providers” can be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). An acquirer can be a registered member of a card association (e.g., Visa®, MasterCard®), and can be part of a card payment network. In at least one example, the service provider can serve as an acquirer and connect directly with the card payment network.

The card payment network (e.g., the server(s) 2808 associated therewith) can forward the fund transfer request to an issuing bank (e.g., “issuer”). The issuer is a bank or financial institution that offers a financial account (e.g., credit or debit card account) to a user. The issuer (e.g., the server(s) 2808 associated therewith) can make a determination as to whether the customer has the capacity to absorb the relevant charge associated with the payment transaction. In at least one example, the merchant platform 2810 can serve as an issuer and/or can partner with an issuer. The transaction is either approved or rejected by the issuer and/or the card payment network (e.g., the server(s) 2808 associated therewith), and a payment authorization message is communicated from the issuer to the POS device via a path opposite of that described above, or via an alternate path.

The server(s) 2808 may send an authorization notification over the network(s) 2804 to the server(s) 2802, which may send the authorization notification to the POS system 2824 over the network(s) 2804 to indicate whether the transaction is authorized. The server(s) 2802 may also transmit additional information such as transaction identifiers to the POS system 2824. In one example, the server(s) 2802 may include a merchant application and/or other functional components for communicating with the POS system 2824 and/or the server(s) 2808 to authorize or decline transactions (e.g., the API 2818). In examples, the merchant platform 2810 can enable the merchants to receive cash payments, payment card payments, and/or electronic payments from customers for POS transactions and the service provider can process transactions on behalf of the merchants.

Based on the authentication notification that is received by the POS system 2824 from server(s) 2802, the merchant may indicate to the customer whether the transaction has been approved. In some examples, approval may be indicated at the POS system 2824, for example, at a display of the POS system 2824. In some cases, such as with a smart phone or watch operating as a short-range communication payment instrument, information about the approved transaction may be provided to the short-range communication payment instrument for presentation via a display of the smart phone or watch. In some examples, additional or alternative information can additionally be presented with the approved transaction notification including, but not limited to, receipts, special offers, coupons, or loyalty program information.

The merchant platform 2810 can provide, among other services, payment processing services, inventory management services, catalog management services, business banking services, financing services, lending services, reservation management services, web-development services, payroll services, employee management services, appointment services, loyalty tracking services, restaurant management services, order management services, fulfillment services, onboarding services, identity verification (IDV) services, media content (e.g., music, videos, etc.) management and/or subscription services, and so on. In some examples, the end user devices 2806 can access all of the services. In some cases, the end user devices 2806 can have gradated access to the services, which can be based on risk tolerance, IDV outputs, subscriptions, and so on. In at least one example, access to such services can be availed to the merchants via the POS application 2820. In additional or alternative examples, each service can be associated with its own access point (e.g., application, web browser, etc.).

As the merchant platform 2810 processes transactions on behalf of the merchants, the merchant platform 2810 can maintain accounts or balances for the merchants in one or more ledgers. For example, the merchant platform 2810 can analyze transaction data received for a transaction to determine an amount of funds owed to a merchant for the transaction and deposit funds into an account of the merchant. The account can have a stored balance, which can be managed by the merchant platform 2810. The account can be different from a conventional bank account at least because the stored balance is managed by a ledger of the merchant platform 2810 and the associated funds are accessible via various withdrawal channels including, but not limited to, scheduled deposit, same-day deposit, instant deposit, and a linked payment instrument.

A scheduled deposit can occur when the merchant platform 2810 transfers funds associated with a stored balance of the merchant to a bank account of the merchant that is held at a bank or other financial institution (e.g., associated with the server(s) 2808). Scheduled deposits can occur at a prearranged time after a POS transaction is funded, which can be a business day after the POS transaction occurred, or sooner or later. In some examples, the merchant can access funds prior to a scheduled deposit (e.g., same-day deposits and/or real-time deposits). Further, in at least one example, the merchant can have a payment instrument that is linked to the stored balance that enables the merchant to access the funds without first transferring the funds from the account managed by the merchant platform 2810 to the bank account of the merchant.

In at least one example, the merchant platform 2810 may provide inventory management services. That is, the merchant platform 2810 may provide inventory tracking and reporting. Inventory management services may enable the merchant to access and manage a database storing data associated with a quantity of each item that the merchant has available (i.e., an inventory). Furthermore, in at least one example, the merchant platform 2810 can provide catalog management services to enable the merchant to maintain a catalog, which can be a database storing data associated with items that the merchant has available for acquisition (i.e., catalog management services). The merchant platform 2810 can offer recommendations related to pricing of the items, placement of items on the catalog, and multi-party fulfillment of the inventory, to name a few examples.

In at least one example, the merchant platform 2810 can provide business banking services, which allow the merchant to track deposits (from payment processing and/or other sources of funds) into an account of the merchant, payroll payments from the account (e.g., payments to employees of the merchant), payments to other merchants (e.g., business-to-business) directly from the account or from a linked debit card, withdrawals made via scheduled deposit and/or real-time deposit, configure allocations among multiple balances or accounts (e.g., spending, saving, taxes, etc.), etc. Furthermore, the business banking services can enable the merchant to obtain a customized payment instrument (e.g., credit card), check how much money the merchant is earning (e.g., via presentation of available earned balance), understand where the money of the merchant is going (e.g., via deposit reports (which can include a breakdown of fees), spend reports, etc.), access/use earned money (e.g., via scheduled deposit, real-time deposit, linked payment instrument, etc.), have improved control of the money of the merchant (e.g., via management of deposit schedule, deposit speed, linked instruments, etc.), etc. Moreover, the business banking services can enable the merchants to visualize their cash flow to track their financial health, set aside money for upcoming obligations (e.g., savings), organize money around goals, etc.

In at least one example, the merchant platform 2810 can provide financing services and products, such as via business loans, consumer loans, fixed term loans, flexible term loans, and the like. In at least one example, the service provider can utilize one or more risk signals to determine whether to extend financing offers and/or terms associated with such financing offers. Such risk signals can be particular to an individual platform or service, as described herein, or can be based on aggregated data associated with multiple of the platforms or services. In at least one example, the merchant platform 2810 can provide financing services for offering and/or lending a loan to a borrower that is to be used for, in some instances, financing the borrower's short-term operational needs (e.g., a capital loan). Additionally or alternatively, the merchant platform 2810 can provide financing services for offering and/or lending a loan to a borrower that is to be used for, in some instances, financing the borrower's consumer purchase (e.g., a consumer loan). In at least one example, a borrower can submit a request for a loan to enable the borrower to purchase an item from a merchant. The merchant platform 2810 can generate the loan based at least in part on determining that the borrower purchased or intends to purchase the item from the merchant. Advances, loans, or other funds provided to a merchant or other user can be repaid via a variety of mechanisms. In some examples, loans can be repaid in installments (e.g., multiple payments over time), at a particular date, from a portion of incoming funds (e.g., payments processed for the merchant, tax refunds, direct deposits, etc.), or the like.

The merchant platform 2810 can provide web-development services, which enable users 2816 who are unfamiliar with HTML, XML, Javascript, CSS, or other web design tools to create and maintain functional websites. Further, in addition to websites, the web-development services can create and maintain other online omni-channel presences, such as social media posts for example. In some examples, the resulting web page(s) and/or other content items can be used for offering item(s) for sale via an online/e-commerce platform. In at least one example, the merchant platform 2810 can recommend and/or generate content items to supplement omni-channel presences of the merchants.

Furthermore, the merchant platform 2810 can provide payroll services to enable employers to pay employees for work performed on behalf of employers. In at least one example, the merchant platform 2810 can receive data that includes time worked by an employee (e.g., through imported timecards and/or POS interactions), sales made by the employee, gratuities received by the employee, and so forth. Based on such data, the merchant platform 2810 can make payroll payments to employee(s) on behalf of an employer via the payroll service. For instance, the merchant platform 2810 can facilitate the transfer of a total amount to be paid out for the payroll of an employee from the bank of the employer to the bank of the merchant platform 2810 to be used to make payroll payments. In at least one example, when the funds have been received at the bank of the merchant platform 2810, the merchant platform 2810 can pay the employee, such as by check or direct deposit.

Moreover, in at least one example, the merchant platform 2810 can provide employee management services for managing schedules of employees. Further, the merchant platform 2810 can provide appointment services for enabling users 2816 to set schedules for scheduling appointments and/or users 2816 to schedule appointments.

In some examples, the merchant platform 2810 can provide restaurant management services to enable users 2816 to make and/or manage reservations, to monitor front-of-house and/or back-of-house operations, and so on. In such examples, the seller device(s) 2806(A) and/or server(s) 2802 can be configured to communicate with one or more other computing devices, which can be located in the front-of-house (e.g., POS device(s)) and/or back-of-house (e.g., kitchen display system(s) (KDS)). In at least one example, the merchant platform 2810 can provide order management services and/or fulfillment services to enable restaurants (or other merchant types) to manage open tickets, split tickets, and so on and/or manage fulfillment services.

In some examples, the merchant platform 2810 can provide omni-channel fulfillment services. A fulfillment service includes item ordering and delivery services, such as via a courier. In some examples, the courier can be an unmanned aerial vehicle (e.g., a drone), an autonomous vehicle, or any other type of vehicle capable of receiving instructions for traveling between locations. For instance, if a customer places an order with a merchant and the merchant cannot fulfill the order because one or more items are out of stock or otherwise unavailable, the merchant platform 2810 can leverage other merchants and/or sales channels that are part of the merchant platform 2810 to fulfill the customer's order. That is, another merchant can provide the one or more items to fulfill the order of the customer. Furthermore, in some examples, another sales channel (e.g., online, brick-and-mortar, etc.) can be used to fulfill the order of the customer.

In some examples, the merchant platform 2810 can enable conversational commerce via conversational commerce services, which can use one or more machine learning mechanisms to analyze messages exchanged between two or more users 2816, voice inputs into a virtual assistant or the like, to determine intents of user(s) 2816. In some examples, the merchant platform 2810 can utilize determined intents to automate customer service, offer promotions, provide recommendations, or otherwise interact with customers in real-time. In at least one example, the merchant platform 2810 can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, a user 2816 may be new to the merchant platform 2810 such that the user 2816 that has not registered (e.g., subscribed to receive access to one or more services offered by the merchant platform 2810) with the merchant platform 2810. The merchant platform 2810 can offer onboarding services for registering a potential user 2816 with the merchant platform 2810. In some examples, onboarding can involve presenting various questions, prompts, and the like to a potential user 2816 to obtain information that can be used to generate a profile for the potential user 2816. In at least one example, the merchant platform 2810 can provide limited or short-term access to its services prior to, or during, onboarding (e.g., a user of a peer-to-peer payment service can transfer and/or receive funds prior to being fully onboarded, a merchant can process payments prior to being fully onboarded, a user of a music streaming service can listen to music having advertisement breaks prior to being fully onboarded, etc.). In response to full or partial completion of onboarding, any limited or short-term access to services of the merchant platform 2810 can be transitioned to more permissive (e.g., less limited) or longer-term access to such services.

The merchant platform 2810 can be associated with IDV services, which can be used by the merchant platform 2810 for compliance purposes and/or can be offered as a service, for instance to third-party service providers (e.g., associated with the server(s) 2808). That is, the merchant platform 2810 can offer IDV services to verify the identity of users 2816 seeking to use or using their services. Identity verification may involve requesting a customer (or potential customer) to provide information that is used by compliance departments to prove that the information is associated with an identity of a real person or entity (e.g., an artist). In at least one example, the merchant platform 2810 can perform services for determining whether identifying information provided by a user 2816 accurately identifies the customer (or potential customer).

Techniques described herein can be configured to operate in both real-time/online and offline modes. “Online” modes refer to modes when devices are capable of communicating with the merchant platform 2810 while offline mode refers to modes when devices are unable to communicate with the server(s) 2808 due to network connectivity issue, for example. In such examples, devices may operate in “offline” mode where at least some payment data is stored (e.g., on the seller device(s) 2806(A)) and/or the server(s) 2802 until connectivity is restored and the payment data can be transmitted to the server(s) 2802 and/or the server(s) 2808 for processing.

In at least one example, the merchant platform 2810 can be associated with a hub, such as an order hub, an inventory hub, a fulfillment hub and so on, which can enable integration with one or more additional service providers (e.g., associated with the additional server(s) 2808). In some examples, such additional service providers can offer additional or alternative services and the service provider can provide an interface or other computer-readable instructions to integrate functionality of the service provider into the one or more additional service providers.

Turning now to the P2P functionality provided by the environment 2800, the P2P platform 2812 can provide a peer-to-peer payment service that enables peer-to-peer payments between two or more of the users 2816. Two or more of the users 2816 may be considered “peers” in a peer-to-peer interaction, such as a payment. In at least one example, the P2P platform 2812 can communicate with instances of a payment application 2826 (or other access point) installed on end user devices 2806 configured for operation by the users 2816. In an example, an instance of the payment application 2826 executing on a first user device 2806(B) operated by a payor (e.g., one of the users 2816) can send a request to the P2P platform 2812 to transfer an asset (e.g., fiat currency, non-fiat currency, digital assets such as non-fungible tokens (NFTs), cryptocurrency, securities, gift cards, and/or related assets) from the payor to a payee (e.g., a different one of the users 2816) via a peer-to-peer payment. In some examples, assets associated with an account of the payor are transferred to an account of the payee. In some examples, assets can be held at least temporarily in an account of the P2P platform 2812 prior to transferring the assets to the account of the payee.

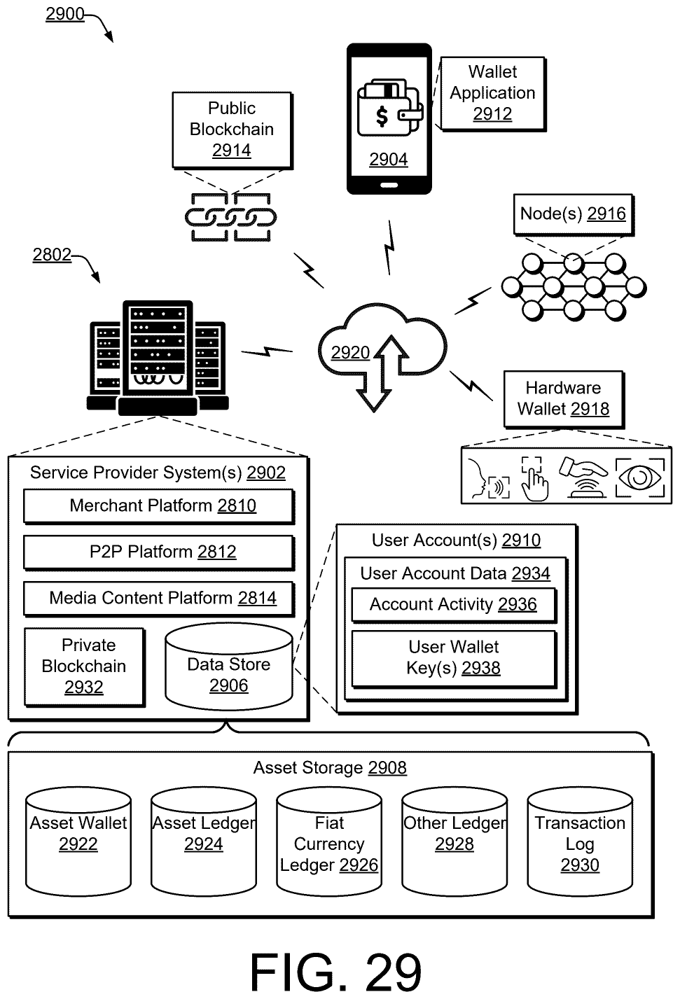

In some examples, the P2P platform 2812 can utilize a ledger system to track transfers of assets between users 2816. FIG. 29, below, provides additional details associated with such a ledger system. The ledger system can enable users 2816 to own fractional shares of assets that are not conventionally available. For instance, a user can own a fraction of a Bitcoin, an NFT, or a stock. Additional details are described herein.

In at least one example, the P2P platform 2812 can facilitate transfers and can send notifications related thereto to instances of the payment application 2826 executing on user device(s) of payee(s). As an example, the P2P platform 2812 can transfer assets from an account of a first user to an account of a second user and can send a notification to the user device 2806(B) of the second user for presentation via a user interface. The notification can indicate that a transfer is in process, a transfer is complete, or the like. In some examples, the P2P platform 2812 can send additional or alternative information to the instances of the payment application 2826 (e.g., low balance to the payor, current balance to the payor or the payee, etc.). In some examples, the payor and/or payee can be identified automatically, e.g., based on context, proximity, prior transaction history, and so on. In other examples, the payee can send a request for funds to the payor prior to the payor initiating the transfer of funds. In some embodiments, the P2P platform 2812 funds the request to payee on behalf of the payor, to speed up the transfer process and compensate for lags that may be attributed to the payor's financial network.

In some examples, the P2P platform 2812 can trigger the peer-to-peer payment process through identification of a “payment proxy” having a particular syntax. The payment proxy is useable in lieu of payment data. That is, payment data and a payment proxy can be linked to, or otherwise associated with, a user account of a user and either can be used for making payments. In an example, the syntax can include a monetary currency indicator prefixing one or more alphanumeric characters (e.g., $Cash). The currency indicator operates as the tagging mechanism that indicates to the server(s) 2802 to treat the inputs as a request from the payor to transfer assets, where detection of the syntax triggers a transfer of assets. The currency indicator can correspond to various currencies including but not limited to, dollar ($), euro (€), pound (£), rupee ( [symbol] ), yuan (¥), etc. Although use of the dollar currency indicator ($) is used herein, it is to be understood that any currency symbol or other symbol could equally be used. In some examples, additional or alternative identifiers can be used to trigger the peer-to-peer payment process. For instance, email, telephone number, social media handles, artist or band names, and/or the like can be used to trigger and/or identify users of a peer-to-peer payment process.

In some examples, the peer-to-peer payment process can be initiated through instances of the payment application 2826 executing on the end user devices 2806. In at least some embodiments, the peer-to-peer process can be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page can be a uniform resource locator (URL), which can include a payment proxy discussed above. The P2P platform 2812 can generate the landing page to enable the recipient to conveniently receive one or more payments from one or more senders.

In some examples, the peer-to-peer payment process can be implemented within a forum. The term “forum,” as used here, refers to a content provider's media channel (e.g., a social networking platform, a microblog, a blog, video sharing platform, a music sharing platform, etc.) that enables user interaction and engagement through streaming of content, comments, posts, messages on electronic bulletin boards, messages on a social networking platform, and/or any other types of messages. In some examples, the content provider can be the service provider as described with reference to FIG. 28 or a third-party service provider associated with the server(s) 2808. In examples where the content provider is a third-party service provider, the server(s) 2808 can be accessible via one or more APIs 2818 or other integrations. In some examples, “forum” may also refer to an application or webpage of an e-commerce or retail organization that offers products and/or services. Such websites can provide an online “form” to complete before or after the products or services are added to a virtual cart. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application, such as a messaging application. The term “messaging application,” as used here, refers to any messaging application that enables communication between users (e.g., sender and recipient of a message) over a wired or wireless communications network, through use of a communication message. The messaging application can be internal to the P2P platform 2812 (e.g., the P2P platform 2812 offers a chat or messaging service that is within the payment application or accessible via the payment application). In some examples, the messaging application can be external to the P2P platform 2812. (e.g., the messaging application is hosted by a third-party service provider associated with the server(s) 2808, which can be accessible via one or more of the APIs 2818 or other integrations). The messaging application can include, for example, a text messaging application for communication between phones (e.g., conventional mobile telephones or smartphones), or a cross-platform instant messaging application for smartphones and phones that use the Internet for communication.

Funds received from payments can be stored in stored balances that are linked to, or otherwise associated with, user accounts. In some examples, the P2P platform 2812 can enable users 2816 to perform banking transactions via instances of the payment application 2826. For example, users can configure direct deposits, recurring deposits, or other deposits (e.g., tax refunds, loans, etc.) for adding assets to their various ledgers/balances. In some examples, users can deposit physical cash via ATMs or other deposit sources, which can include merchants, such as those merchants that utilize the payment processing system described above. In some examples, the P2P platform 2812 can enable users to allocate funds between different accounts, sub-accounts, or balances (e.g., spending, saving, different assets, different currencies), etc. Further, users 2816 can configure bill pay, recurring payments, and/or the like using assets associated with their accounts. In some examples, the P2P platform 2812, with consent of the user, can track individual transactions made using the payment application and can utilize such transaction data to make personalized or customized recommendations, determine creditworthiness, generate tax documentation, and/or the like.

In addition to sending and/or receiving assets via peer-to-peer transactions, the P2P platform 2812 enables users to buy and/or sell assets via asset networks such as cryptocurrency networks, securities networks, and/or the like. In some examples, acquisition of such assets can be in whole or fractional shares. The ledger system described below with reference to FIG. 29 can enable such assets to be acquired in fractional shares and/or in real-time or near real-time (by delaying or omitting the need to buy/sell assets via asset networks or exchanges). In some examples, users can “gift” assets to other users, for example, by transferring cryptocurrency, stocks, or the like to one another.

In some examples, the P2P platform 2812 can enable users to link payment instruments to their user accounts. As a result, users can use their linked payment instruments to access funds in their accounts or balances. In some examples, the payment instrument can be a credit card, debit card, card linked to multiple accounts or balances via software or hardware, a fob or other object having payment data stored thereon, or the like. In some examples, the payment instrument can be a virtual payment instrument or a physical payment instrument. In some examples, the virtual payment instrument can be issued in real-time or for temporary usage. In some examples, the virtual payment instrument can have the same or different payment data as a corresponding physical payment instrument. Payment instruments can be customizable using a design user interface of the payment application. Such customization can enable users to select colors, stamps, images, text, or the like for surface(s) of their payment instruments. In some examples, users can draw or otherwise interact with the design user interface to personalize surface(s) of their payment instruments.

In some examples, users can associate incentives with their payment instruments. Incentives can be recommended to users based on user preferences (inferred or explicitly identified), geolocation, propensity to redeem, value, and/or the like. In some examples, incentives can be particular to individual merchants, types of merchants, types of transactions, and/or the like. In at least one example, when a user uses their payment instrument at a merchant or type of merchant associated with an incentive, or for a transaction type associated with an incentive, the P2P platform 2812 can automatically apply the incentive to the transaction. In some examples, users can gift other users “gift cards” that can be associated with payment instruments. That is, a user can transfer an amount of funds to another user and such funds can be associated with a condition (e.g., merchant, merchant type, transaction type, location, etc.) that, upon satisfaction, enables the amount of funds, or a portion thereof, to be applied to a transaction. In at least one example, when a user uses their payment instrument for a transaction that satisfies the condition, the P2P platform 2812 can automatically apply the amount of funds associated with the gift card to the transaction.

In some examples, users can configure their account such that when they use their payment instruments, the P2P platform 2812 can deposit an amount of funds into a savings account, investing account, bitcoin account, or the like.

In some examples, users can search for or browse other users, merchants, items, or the like via the payment application. In some examples, search results can be personalized and/or customized for the user (e.g., based on user data collected with consent of the user). In some examples, users can shop or otherwise purchase items from other users, merchants, or the like from within the payment application or via a deep link to a merchant application or website.

The P2P platform 2812 can offer primary and secondary accounts, wherein a primary account is a sponsor or other delegate of one or more secondary accounts. Such accounts can be useful for families, wherein a parent or other guardian is a sponsor or delegate to one or more child accounts, or where a child is a sponsor or delegate of an elderly parent's account. In some examples, primary accounts can establish limits on secondary accounts, such as spending limits, or the like. In some examples, the primary account owner is the user legally responsible for the account and their identity may be verifiable for secondary user accounts to perform certain transactions, such as buying/selling cryptocurrency or stocks. In some examples, one or more primary accounts and one or more secondary accounts can form a “group” with shared goals, such as saving, investing, or the like.

The P2P platform 2812 can present activity data via an activity user interface of the payment application. In some examples, activity can be presented by merchant, date, time, amount, or the like. In some examples, interactions between entities can be represented in conversational communications such that each interaction or transaction is represented as a message. In some examples, users can interact with individual messages and/or send/request funds from within such a conversational communication. In some examples, such conversational communications can represent conversations of a group of two or more users. Groups can be used to pool funds, obtain group discounts or incentives, or enable multiple users to participate in financial transactions together (e.g., group investing, group savings, etc.).

The P2P platform 2812 can offer a variety of financial training or learning opportunities. In some examples, such training or learning can be personalized for individual users, for example, based on user data and/or transaction data of the user that is obtained with consent of the user. In some examples, such user data and/or transaction data can be analyzed to make actionable recommendations with respect to optimizing financial health of users of the P2P platform 2812.

In some examples, components of the environment 2800 may be integrated to enable payments at the point-of-sale using assets associated with user accounts of the P2P platform 2812. As illustrated in the environment 2800, the components can communicate with one another via the network 2804, where one or more APIs 2818 or other functional components can be used to facilitate such communication.

In at least one example, an integration can enable a customer to participate in a transaction via their own computing device (e.g., user device 2806(B)) instead of interacting with a merchant device of a merchant, such as the seller device 2806(A). In such an example, the POS application 2820, associated with a payment processing platform and executable by the seller device 2806(A) of the merchant, can present a Quick Response (QR) code, or other code that can be used to identify a transaction (e.g., a transaction code), in association with a transaction between the customer and the merchant. The QR code, or other transaction code, can be provided to the POS application 2820 via an API 2818 associated with the peer-to-peer payment platform. In an example, the customer can utilize their own computing device, such as the user device 2806(B), to capture the QR code, or the other transaction code, and to provide an indication of the captured QR code, or other transaction code, to server(s) 2802.

Based at least in part on the integration of the peer-to-peer payment platform and the payment processing platform (e.g., via the API 2818), the server(s) 2802 of the merchant platform 2810 can exchange communications with a payment application 2826 associated with the P2P platform 2812 and/or the POS application 2820 to process payment for the transaction using a peer-to-peer payment where the customer is a first “peer” and the merchant is a second “peer.”

Based at least in part on receiving an indication of which payment method a user (e.g., customer or merchant) intends to use for a transaction, techniques described herein utilize an integration between the P2P platform 2812 and merchant platform 2810 (which can be a first- or third-party integration) such that a QR code, or other transaction code, specific to the transaction can be used for providing transaction details, location details, customer details, or the like to a computing device of the customer, such as the user device 2806(B), to enable a contactless (peer-to-peer) payment for the transaction, and transferring funds from an account of the customer to an account of the merchant.

In at least one example, techniques described herein can offer improvements to conventional payment technologies at both brick-and-mortar points of sale and online points of sale. For example, at brick-and-mortar points of sale, techniques described herein can enable customers to “scan to pay,” by using their computing devices to scan QR codes, or other transaction codes, encoded with data as described herein, to remit payments for transactions. In such a “scan to pay” example, a customer computing device, such as the user device 2806(B), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc. In another example, merchants can “scan for payment” such that a customer can present a QR code, or other transaction code, that can be linked to a payment instrument or stored balance. Funds associated with the payment instrument or stored balance can be used for payment of a transaction.

As described above, techniques described herein can offer improvements to conventional payment technologies at online points of sale, as well as brick-and-mortar points of sale. For example, multiple applications can be used in combination during checkout. That is, the POS application 2820 and the payment application 2826, as described herein, can process a payment transaction by routing information input via the merchant application to the payment application for completing a “frictionless” payment.

Returning to the “scan to pay” examples described herein, QR codes, or other transaction codes, can be presented in association with a merchant web page or ecommerce web page. In at least one example, techniques described herein can enable customers to “scan to pay,” by using their computing devices to scan or otherwise capture QR codes, or other transaction codes, encoded with data, as described herein, to remit payments for online/ecommerce transactions. A customer computing device, such as the user device 2806(B), can be specially configured as a buyer-facing device having functionality similar to the functionality described above in the brick-and-mortar example.

In some examples, based at least in part on capturing the QR code, or other transaction code, the merchant platform 2810 can provide transaction data to the P2P platform 2812 for presentation via the payment application 2826 on the computing device of the customer, such as the user device 2806(B), to enable the customer to complete the transaction via their own computing device. In some examples, in response to receiving an indication that the QR code, or other transaction code, has been captured or otherwise interacted with via the customer computing device, the P2P platform 2812 can determine that the customer authorizes payment of the transaction using funds associated with a stored balance of the customer that is managed and/or maintained by the P2P platform 2812. Such authorization can be implicit such that the interaction with the transaction code can imply authorization of the customer. Alternatively or additionally, the P2P platform 2812 can request express authorization to process payment for the transaction using the funds associated with the stored balance and the customer can interact with the payment application to expressly authorize the settlement of the transaction. In some examples, such an authorization (implicit or express) can be provided prior to a transaction being complete and/or initialization of a conventional payment flow. That is, in some examples, such an authorization can be provided during cart building (e.g., adding item(s) to a virtual cart) and/or prior to payment selection. In some examples, such an authorization can be provided after payment is complete (e.g., via another payment instrument). Based at least in part on receiving an authorization to use funds associated with the stored balance (e.g., implicitly or explicitly) of the customer, the P2P platform 2812 can transfer funds from the stored balance of the customer to the merchant platform 2810. In at least one example, the merchant platform 2810 can deposit the funds, or a portion thereof, into a stored balance of the merchant that is managed and/or maintained by the merchant platform 2810. In such an example, the merchant platform 2810 can be a “peer” to the customer in a peer-to-peer transaction.

In some examples, techniques described herein can enable the customer to interact with the transaction after payment for the transaction has been settled. For example, in at least one example, the merchant platform 2810 can cause a total amount of a transaction to be presented via a user interface associated with the payment application 2826 such that the customer can provide gratuity, feedback, loyalty information, or the like, via an interaction with the user interface. In another example, the merchant platform 2810 can adjust a total amount of a transaction based on events during a shopping experience, such as adding or removing a charge to the total amount based on whether a media content item requested by the customer to be played during a shopping experience was in fact played. In some examples, because the customer has already authorized payment via the P2P platform 2812, if the customer inputs a tip and/or an event affecting the total amount of the transaction is triggered, the P2P platform 2812 can transfer additional funds, associated with the tip or event, to the merchant platform 2810. This pre-authorization (or maintained authorization) of sorts can enable faster, more efficient payment processing when the tip is received and/or the event initiates the trigger. Further, the customer can provide feedback and/or loyalty information via the user interface presented by the payment application, which can be associated with the transaction. Using the pre-authorization techniques described herein results in fewer data transmissions and thus, techniques described herein can conserve bandwidth and reduce network congestion. Moreover, as described above, funds associated with tips can be received faster and more efficiently than with conventional payment technologies.

In addition to the improvements described above, techniques described herein can provide enhanced security in payment processing. In some examples, if a camera, or other sensor, used to capture a QR code, or other transaction code, is integrated into a payment application 2826 (e.g., instead of a native camera, or other sensor), techniques described herein can utilize an indication of the QR code, or other transaction code, received from the payment application for two-factor authentication to enable more secure payments.

It should be noted that, while techniques described herein are directed to contactless payments using QR codes or other transaction codes, in additional or alternative examples, techniques described herein can be applicable for contact payments. That is, in some examples, a customer can swipe a payment instrument (e.g., a credit card, a debit card, or the like) via a reader device associated with a merchant device, dip a payment instrument into a reader device associated with a merchant computing device, tap a payment instrument with a reader device associated with a merchant computing device, or the like, to initiate the provisioning of transaction data to the customer computing device. In some examples, the payment instrument can be associated with the P2P platform 2812 as described herein (e.g., a debit card linked to a stored balance of a customer) such that when the payment instrument is caused to interact with a payment reader, the merchant platform 2810 can exchange communications with the P2P platform 2812 to authorize payment for a transaction and/or provision associated transaction data to a computing device of the customer associated with the transaction.

Turning now to media content functionality provided by the environment 2800, the media content platform 2814 can provide digital media to a content consumption device 2806(D) where playback may occur using “streaming.” In examples, “streaming” media content involves encoding the media content and transmitting the encoded media content over the network 2804 to a media player or a media application executing on a device (e.g., via a speaker). The device then decodes and plays the media content while data is being received. In some cases, a buffer queues some of the data of the media content (e.g., audio data, video data, etc.) ahead of the media being played. During moments of network congestion, which leads to lower available bandwidth, less media content data is added to the buffer, which drains down as media content is being dequeued during streaming playback. However, during moments of high network bandwidth, the buffer is replenished, adding media content data to the buffer.

In at least one example, the media content platform 2814 can provide a digital media streaming service (e.g., subscription-based, non-subscription-based) that enables a content consumption device 2806(D) to stream and/or download digital media content via a listener application 2828 installed on the content consumption device 2806(D). For instance, the media content platform 2814 may comprise a digital audio streaming service (e.g., for music, podcasts, audiobooks, etc.), a digital video streaming service, and/or a streaming service that provides streaming of various different types of digital media content or multimedia. In such cases where digital media content items are downloaded and stored locally on the content consumption devices 2806(D), the listener application 2828 may verify access rights to the digital media content items at time intervals, for instance intermittently (e.g., when the content consumption device 2806(D) has a network connection with the media content platform 2814 via the network(s) 2804), and/or at regular intervals (e.g., daily, weekly, monthly, etc.). In examples, access rights to the digital media content items may be provided when a subscription to the media content platform 2814 is active, while access rights to the digital media content items may be withheld when the subscription to the media content platform 2814 is terminated. Enabling storage on the end user devices 2806 and subsequent access to digital media content items via the listener application 2828 provides the users 2816 with the ability to access the digital media content items “offline” such as when a connection to the media content platform 2814 via the network(s) 2804 is unavailable or unreliable.

In some examples, the media content platform 2814 may additionally or alternatively provide an artist management service that enables the users 2816 to manage aspects of artist business via an artist application 2830 installed on the artist device 2806(E), such as data analytics and management (e.g., listener data, consumer data, etc.), marketing, regulatory obligations, cash flow management, publishing, customer relationship management (CRM), social media, event coordination, industry communications, digital media content ingestion and storage, and so forth. In some cases, the users 2816 can have graduated access to the services, which can be based on a user type (e.g., artist, group member, personal manager, business manager, attorney, agent, etc.), risk tolerance, artist verification status, listener and/or viewer analytics (e.g., number of streams in a month), and so on. In some cases, multiple users 2816 may have access to a single user account via respective end user devices 2806, with the various users having different access privileges to services provided by the artist management service. In various scenarios, an artist can designate functions provided by the artist management service to different members of the team associated with the artist, thus granting the respective team members access to services suited to the skills of the individual team members.

In some cases, the artist application 2830 and the listener application 2828 may be distinct applications having differing user experiences and verification processes for access, such as illustrated in the environment 2800. For instance, the media content platform 2814 may request additional verification, such as a link to an artist website, a sample of an artist's work, a verified credential supplied by a third party, etc. to grant access to the artist application 2830 in addition to information requested to access the listener application 2828. Further, the artist application 2830 may provide the artist management services described herein, without the subscription-based digital media streaming services described herein, and vice versa. However, examples are also considered in which functionality provided by the artist application 2830 and the listener application 2828 partially or fully overlap, and/or where verification processes for access are substantially similar.

In at least some examples, the media content platform 2814 enables interaction between the users 2816 utilizing the listener application 2828 installed on the content consumption devices 2806(D), and the users 2816 utilizing the artist application 2830 installed on the artist end user devices 2806(E). For example, the media content platform 2814 may provide interconnectivity between the subscription-based digital media streaming service and the artist management service. Functionality provided by the media content platform 2814 in such instances may include a communication channel between one or more of the users 2816 (e.g., a listener, fan, music supervisor, publisher, etc.) utilizing the listener application 2828 and another user (e.g., an artist) of the users 2816 utilizing the artist application 2830. The communication channel may include, for instance, a messaging platform (also referred to as a “messaging application” herein), a live streaming platform, a videoconferencing or teleconferencing platform, and/or a combination of these.

Additionally, in some cases, the media content platform 2814 may facilitate a resource transfer between the listener application 2828 and the artist application 2830. In an example, the media content platform 2814 may direct a resource, such as a portion of a subscription fee paid by one of the users 2816 designated as a listener, to one or more of the users 2816 designated as artists based on a number of instances that the listening user consumed (e.g., streamed, downloaded, etc.) content created by respective ones of the artist users. Alternatively or additionally, the media content platform 2814 may direct a resource, such as funds, from an account associated with a listening user to an account associated with an artist user (or vice versa), in accordance with transfers between accounts as described herein. The media content platform 2814 may facilitate resource transfers in examples such as merchandise purchases, event ticket purchases, “tipping” an artist, payments for royalties or other fees, and so forth.

In some examples, the media content platform 2814 enables interaction between individual ones of the users 2816 with one another via the listener application 2828 installed on the content consumption device 2806(D) and other of the content consumption devices 2806(D) via a communication channel as described above. In an example, the listener application 2828 may provide functionality via a communication channel for a user to stream an individual digital media item, a playlist, or the like to an audience comprising other ones of the content consumption devices 2806(D). Alternatively or additionally, the communication channel may facilitate sharing of individual digital media items, playlists, user and/or artist profiles, and the like between the users 2816 via messages, uniform resource locators (URLs), quick response (QR) codes, and so forth.

In some cases, the media content platform 2814 enables interaction between individual ones of the users 2816 with one another via the artist application 2830 installed on the artist device 2806(E) and other of the artist end user devices 2806 via a communication channel as described above. In some instances, the media content platform 2814 may provide recommendations for a particular user indicating which of the other users 2816 to communicate with. Such a recommendation may be based on a similarity (or dissimilarity) of content created by two or more of the users 2816, an overlap (or lack thereof) of audience members of the users 2816, a geographic location of the users 2816, a coinciding event location of the users 2816, and so forth. In some examples, a user may input parameters for a desired connection via the artist application 2830, and the media content platform 2814 may filter which of the users 2816 to surface for recommendations to the user based on the input parameters. Alternatively or additionally, the media content platform 2814 may implement one or more machine learning models to filter which of the users 2816 to surface for recommendations to the user. The recommendations provided by the media content platform 2814 may be data driven and thus increase relevance of communications presented to the users 2816 and reduce unsolicited communications that may be received by the users 2816.

The media content platform 2814 may interact with the server(s) 2808 associated with the third-party service providers to, for instance, ingest digital media items, report digital media consumption data, pay royalties, and the like. In some examples, the server(s) 2808 may be accessible by the media content platform 2814 via one or more APIs 2818 or other integrations. In some cases, the third-party service provider may be a digital media content provider (e.g., a record label, a performance rights organization (PRO), an independent artist, etc.). In such cases, the media content platform 2814 may receive digital media content items from the server(s) 2808, along with metadata associated with the digital media content items. The metadata, in some instances, may indicate individual contributors to a digital media content item such as an artist or artists, a songwriter (e.g., a composer, lyricist, author, etc.), a producer (which may further include a co-producer, a mastering engineer, a mixing engineer, a recording engineer, an arranger, a programmer, etc.), a musician (e.g., instrumentalist, vocalist, etc.), a visual artist, and so forth, with an indication of the role of the individual contributor. Alternatively or additionally, the metadata may indicate information such as release date, track title, track duration, clean or explicit version, jurisdiction information, and the like. The media content platform 2814 may use the metadata to associate the digital media content item as being created by a particular user, to provide search results to the users 2816, to generate playlists, and so forth. Further, the media content platform 2814 may provide payments (e.g., royalties) to the third-party service provider based on a number of streams and/or downloads of individual digital media content items by the users 2816 via the listener application 2828.

Techniques described herein are directed to services provided via a distributed system of end user devices 2806 that are in communication with server(s) 2802 of the service provider. That is, techniques described herein are directed to a specific implementation—or, a practical application—of utilizing a distributed system of end user devices 2806 that are in communication with server(s) 2802 of the merchant platform 2810, the P2P platform 2812, and/or the media content platform 2814 to perform a variety of services, as described above. The unconventional configuration of the distributed system described herein enables the server(s) 2802 that are remotely-located from end-users (e.g., users 2816) to intelligently offer services based on aggregated data associated with the end-users, such as the users 2816 (e.g., data associated with multiple, different merchants and/or multiple, different buyers; data associated with multiple different listeners and/or multiple different artists, etc.), in some examples, in near-real time. Accordingly, techniques described herein are directed to a particular arrangement of elements that offer technical improvements over conventional techniques for performing payment processing services, P2P payment services, media content services, and the like. For small business owners and artists in particular, the business environment is typically fragmented and relies on unrelated tools and programs, making it difficult for an owner or an artist to manually consolidate and view such data. The techniques described herein constantly or periodically monitor disparate and distinct user accounts, e.g., accounts within the control of the merchant platform 2810, the P2P platform 2812, and/or the media content platform 2814, and those outside of the control of these service providers, to track the standing (payables, receivables, payroll, invoices, appointments, capital, balances, collaborations, etc.) of the users 2816. The techniques herein provide a consolidated view of a user's cash flow, predict needs, preemptively offer recommendations or services, such as capital, coupons, etc., and/or enable money movement between disparate accounts (merchant's, another merchant's, or even payment service's) in a frictionless and transparent manner.

As described herein, artificial intelligence, machine learning, and the like can be used to dynamically make determinations, recommendations, and the like, thereby adding intelligence and context-awareness to an otherwise one-size-fits-all scheme for providing payment processing services, P2P payment services, media content services, and/or additional or alternative services described herein. In some implementations, the distributed system is capable of applying the intelligence derived from an existing user base to a new user, thereby making the onboarding experience for the new user personalized and frictionless when compared to traditional onboarding methods. Further, models or algorithms that are used to implement techniques described herein may be retrained over time to improve outcomes for subsequent scenarios based on outcomes of previous scenarios. Thus, techniques described herein improve existing technological processes.

As described above, various graphical user interfaces (GUIs) can be presented to facilitate techniques described herein. Some of the techniques described herein are directed to user interface features presented via GUIs to improve interaction between users 2816 and end user devices 2806. Furthermore, such features are changed dynamically based on the profiles of the users involved interacting with the GUIs. As such, techniques described herein are directed to improvements to computing systems.

The merchant platform 2810, the P2P platform 2812, and/or the media content platform 2814 are capable of providing additional or alternative services, and the services described above are offered as a sampling of services. In at least one example, the merchant platform 2810, the P2P platform 2812, and/or the media content platform 2814 can exchange data with the server(s) 2808 associated with third-party service providers. Such third-party service providers can provide information that enables the merchant platform 2810, the P2P platform 2812, and/or the media content platform 2814 to provide services, such as those described above. In additional or alternative examples, such third-party service providers can access services of the merchant platform 2810, the P2P platform 2812, and/or the media content platform 2814. That is, in some examples, the third-party service providers can be subscribers, or otherwise access, services of the merchant platform 2810, the P2P platform 2812, and/or the media content platform 2814.

FIG. 29 illustrates an example environment 2900 including a service provider system 2902 which may be associated with the server(s) 2802 of FIG. 28. The environment 2900 may also include a user device 2904, which may correspond to any of the end user devices 2806 described in relation to FIG. 28. In examples, the service provider system 2902 may include one or a combination of the merchant platform 2810, the P2P platform 2812, or the media content platform 2814, as well as one or more data store(s) 2906 that can store assets in an asset storage 2908, as well as data in user account(s) 2910. In some examples, the environment 2900 may also include a public blockchain 2914, one or more nodes 2916, and/or a hardware wallet 2918. The service provider system 2902, the user device 2904, public blockchain 2914, the node(s) 2916, and the hardware wallet 2918 may be connected and able to communicate via one or more networks 2920, which may have the same or similar functionality described in relation to the network 2804 of FIG. 28.

In some examples, user account(s) 2910 can include merchant account(s), customer account(s), media content subscriber account(s), artist account(s), and so forth. In at least one example, the asset storage 2908 can be used to record whether individual assets are registered to a user account 2910. For example, the asset storage 2908 can include asset wallet(s) 2922 for storing records of assets owned by the service provider system 2902, such as cryptocurrency, securities, NFTs, or the like, and communicating with one or more asset networks, such as cryptocurrency networks, NFT networks, securities networks, or the like. In some examples, the asset network can be a first-party network or a third-party network, such as a cryptocurrency exchange or the stock market. In examples where the asset network is a third-party network, the server(s) 2808 of FIG. 28 can be associated therewith.

The asset wallet 2922 can be associated with one or more addresses and can vary addresses used to acquire assets (e.g., from the asset network(s)) so that its holdings are represented under a variety of addresses on the asset network. In examples where the service provider system 2902 has holdings of cryptocurrency (e.g., in the asset wallet 2922), a user can acquire cryptocurrency directly from the service provider system 2902. In some examples, the service provider system 2902 can include logic for buying and selling cryptocurrency to maintain a desired level of cryptocurrency. In some examples, the desired level can be based on a volume of transactions over a period of time, balances of collective cryptocurrency ledgers, exchange rates, or trends in changing of exchange rates such that the cryptocurrency is trending towards gaining or losing value with respect to the fiat currency. In some scenarios, the buying and selling of cryptocurrency, and therefore the associated updating of the public ledger of an asset network can be separate from a customer-merchant transaction or a peer-to-peer transaction, and therefore not necessarily time-sensitive. This can enable batching transactions to reduce computational resources and/or costs. The service provider system 2902 can provide the same or similar functionality for securities or other assets.

The asset storage 2908 may contain ledgers that store records of assignments of assets to users 2816. Specifically, the asset storage 2908 may include asset ledger 2924, fiat currency ledger 2926, and/or other ledger(s) 2928, which can be used to record transfers of assets between users 2816 and/or one or more third-parties (e.g., merchant network(s), payment card network(s), ACH network(s), equities network(s), the asset network, securities networks, etc.). In doing so, the asset storage 2908 can maintain a running balance of assets managed by the service provider system 2902. The ledger(s) of the asset storage 2908 can further indicate some of the running balance for individual ledger(s) stored in the asset storage 2908 are assigned or registered to one or more user account(s) 2910.

In at least one example, the asset storage 2908 can include transaction logs 2930, which can include, as transaction data, records of past transactions involving the service provider system 2902 and/or the user account 2910. In some examples, the data store(s) 2906 can store a private blockchain 2932. A private blockchain 2932 can function to record sender addresses, recipient addresses, public keys, values of cryptocurrency transferred, and/or can be used to verify ownership of cryptocurrency tokens to be transferred. In some examples, the service provider system 2902 can record transactions involving cryptocurrency until the number of transactions has exceeded a determined limit (e.g., number of transactions, storage space allocation, etc.). Based at least in part on determining that the limit has been reached, the service provider system 2902 can publish the transactions in the private blockchain 2932 to the public blockchain 2914 (e.g., associated with the asset network), where miners can verify the transactions and record the transactions to blocks on the public blockchain 2914. In at least one example, the service provider system 2902 can participate as miner(s) at least for transactions to which the respective platform is a party to, to be posted to the public blockchain 2914.

In some cases, the data store(s) 2906 can store and/or manage multiple user accounts, an example of which is described in relation to the user account 2910. In at least one example, the user account 2910 can include user account data 2934, which can include, but is not limited to, data associated with user identifying information (e.g., name, phone number, address, artist or band name, verified credentials, etc.), user identifier(s) (e.g., alphanumeric identifiers, etc.), user preferences (e.g., learned or user-specified), purchase history data (e.g., identifying one or more items purchased (and respective item information), subscription tier information, etc.), linked payment sources (e.g., bank account(s), stored balance(s), etc.), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the user account data 2934 can include account activity 2936 and user wallet key(s) 2938. In some examples, the user wallet key(s) 2938 can include a public-private key-pair and a respective address associated with the asset network or other asset networks. In some examples, the user wallet key(s) 2938 may include one or more key pairs, which can be unique to the asset network or other asset networks.

In addition to the user account data 2934, the user account 2910 can include ledger(s) for account(s) managed by the service provider system 2902, for the user. For example, the user account 2910 may include an asset ledger 2924, a fiat currency ledger 2926, and/or one or more other ledgers 2928. The ledger(s) can indicate that a corresponding user utilizes the service provider system 2902 to manage corresponding accounts (e.g., a cryptocurrency account, a securities account, a fiat currency account, an artist account, etc.). It should be noted that in some examples, the ledger(s) can be logical ledger(s) and the data can be represented in a single database. In some examples, individual ones of the ledger(s), or portions thereof, can be maintained by the service provider system 2902.

In some examples, the asset ledger 2924 can store a balance for each of one or more cryptocurrencies (e.g., Bitcoin, Ethereum, Litecoin, etc.) registered to the user account 2910. In at least one example, the asset ledger 2924 can further record transactions of cryptocurrency assets associated with the user account 2910. For example, the user account 2910 can receive cryptocurrency from the asset network using the user wallet key(s) 2938. In some examples, the user wallet key(s) 2938 may be generated for the user upon request. User wallet key(s) 2938 can be requested by the user in order to send, exchange, or otherwise control the balance of cryptocurrency held by the service provider system 2902 (e.g., in the asset wallet 2922) and registered to the user. In some examples, the user wallet key(s) 2938 may not be generated until a user account requires such. This on-the-fly wallet key generation provides enhanced security features for users, reducing the number of access points to a user account's balance and, therefore, limiting exposure to external threats.

Each account ledger can reflect a positive balance when funds are added to the corresponding account. An account can be funded by transferring currency in the form associated with the account from an external account (e.g., transferring a value of cryptocurrency to the service provider system 2902 and the value is credited as a balance in asset ledger 2924), by purchasing currency in the form associated with the account using currency in a different form (e.g., buying a value of cryptocurrency from the service provider system 2902 using a value of fiat currency reflected in fiat currency ledger 12391226, and crediting the value of cryptocurrency in asset ledger 2924), or by conducting a transaction with another user (customer or merchant) of the service provider system 2902 wherein the account receives incoming currency (which can be in the form associated with the account or a different form, in which the incoming currency may be converted to the form associated with the account).

With specific reference to funding a cryptocurrency account, a user may have a balance of cryptocurrency stored in another cryptocurrency wallet. In some examples, the other cryptocurrency wallet can be associated with a third-party unrelated to the service provider system 2902 (i.e., an external account). Such a transaction can request that the user to transfer an amount of the cryptocurrency in a message signed by user's private key to an address provided by the service provider system 2902. In at least one example, the transaction can be sent to miners to bundle the transaction into a block of transactions and to verify the authenticity of the transactions in the block. Once a miner has verified the block, the block is written to the public blockchain 2914 where the service provider system 2902 can then verify that the transaction has been confirmed and can credit the user's asset ledger 2924 with the transferred amount. When an account is funded by transferring cryptocurrency from a third-party cryptocurrency wallet, an update can be made to the public blockchain 2914. In some cases, this update of the public blockchain 2914 need not take place at a time-critical moment, such as when a transaction is being processed by a merchant in store or online.

In some examples, a user can purchase cryptocurrency to fund their cryptocurrency account. In some examples, the user can purchase cryptocurrency through services offered by the service provider system 2902. As described above, in some examples, the service provider system 2902 can acquire cryptocurrency from a third-party source. In examples where the service provider system 2902 has its own cryptocurrency assets, cryptocurrency transferred in a transaction (e.g., data with address provided for receipt of transaction and a balance of cryptocurrency transferred in the transaction) can be stored in an asset wallet 2922 associated with the service provider system 2902. In at least one example, the service provider system 2902 can credit the asset ledger 2924 of the user. Additionally, while the service provider system 2902 recognizes that the user retains the value of the transferred cryptocurrency through crediting the asset ledger 2924, an inspection of the blockchain shows the cryptocurrency as having been transferred to the service provider system 2902. In some examples, the asset wallet 2922 can be associated with many different addresses. In such examples, an inspection of the blockchain may not necessarily associate all cryptocurrency stored in asset wallet 2922 as belonging to the same entity. The presence of a private ledger used for real-time transactions and maintained by the service provider system 2902, combined with updates to the public ledger at other times, allows for extremely fast transactions using cryptocurrency to be achieved. In some examples, the “private ledger” can refer to the asset ledger 2924, which in some examples, can utilize the private blockchain 2932, as described herein. The “public ledger” can correspond to the public blockchain 2914 associated with the asset network.

In at least one example, an asset ledger 2924, fiat currency ledger 2926, or the like associated with the user account 2910 can be credited when conducting a transaction with another user (customer or merchant) wherein the user receives incoming currency. In some examples, a user can receive cryptocurrency in the form of payment for a transaction with another user. In at least one example, such cryptocurrency can be used to fund the asset ledger 2924. In some examples, a user can receive fiat currency or another currency in the form of payment for a transaction with another user. In at least one example, at least a portion of such funds can be converted into cryptocurrency by the service provider system 2902 and used to fund the asset ledger 2924 of the user.

In examples, a user can also have an account in U.S. dollars, which can be tracked, for example, via the fiat currency ledger 2926. Such an account can be funded by transferring money from a bank account at a third-party bank to an account maintained by the service provider system 2902 as is conventionally known. In some examples, a user can receive fiat currency in the form of payment for a transaction with another user. In such examples, at least a portion of such funds can be used to fund the fiat currency ledger 2926.

In some examples, a user can have one or more internal payment cards registered with the service provider system 2902. Internal payment cards can be linked to one or more of the accounts associated with the user account 2910. In some embodiments, options with respect to internal payment cards can be adjusted and managed using an application (e.g., the payment application 2826, a wallet application 2912, etc.).

In at least one example, the user account 2910 can be associated with the asset wallet accessible via a wallet application 2912 of the user device 2904, or a stored balance for use in payment transactions, peer-to-peer transactions, payroll payments, etc. In at least one example, the asset wallet 2922 can store data indicating an address provided for receipt of a cryptocurrency transaction. In at least one example, the balance of the asset wallet 2922 can be based at least in part on a balance of the asset ledger 2924. In at least one example, funds availed via the asset wallet 2922 can be stored in the asset wallet 2922. Funds availed via the asset wallet 2922 can be tracked via the asset ledger 2924. The asset wallet 2922, however, can be associated with additional cryptocurrency funds.

In at least one example, when the service provider system 2902 includes a private blockchain 2932 for recording and validating cryptocurrency transactions, the asset wallet 2922 can be used instead of, or in addition to, the asset ledger 2924. For example, a merchant can provide the address of the asset wallet 2922 for receiving payments. In an example where a customer is paying in cryptocurrency and the customer has their own cryptocurrency wallet account associated with the service provider system 2902, the customer can send a message signed by its private key including its wallet address (i.e., of the customer) and identifying the cryptocurrency and value to be transferred to the merchant's asset wallet 2922. The service provider system 2902 can complete the transaction by reducing the cryptocurrency balance in the customer's cryptocurrency wallet and increasing the cryptocurrency balance in the merchant's asset wallet 2922. In addition to recording the transaction in the respective cryptocurrency wallets, the transaction can be recorded in the private blockchain 2932 and the transaction can be confirmed. A user can perform a similar transaction with cryptocurrency in a peer-to-peer transaction as described above.

While the asset ledger 2924 and/or asset wallet 2922 are each described above with reference to cryptocurrency, the asset ledger 2924 and/or asset wallet 2922 can alternatively be used in association with securities. In some examples, different ledgers and/or wallets can be used for different types of assets. That is, in some examples, a user can have multiple asset ledgers and/or asset wallets for tracking cryptocurrency, securities, or the like.

It should be noted that user(s) having accounts managed by the service provider system 2902 is an aspect of the technology disclosed that enables technical advantages of increased processing speed and improved security.

The description of the environment 2900 above generally relates to a centralized service provider system 2902 that at least partially facilitates storing and managing assets in the data store 2906. However, the environment 2900 may also facilitate decentralized storage and management of assets alternatively or in addition to centralized storage and management as described above. For instance, the environment 2900 may include a decentralized platform implemented using a plurality of nodes (e.g., web nodes), an example of which is illustrated as node 2916. The node 2916 is representative of a computer or other device tasked with validating transactions and/or maintaining a copy of a blockchain ledger, such as a ledger associated with the public blockchain 2914. The decentralized platform may be implemented via the environment 2900 through use of decentralized identifiers and verifiable credentials that are stored and managed by user devices 2904. A decentralized identifier is configured as a self-owned identifier that supports decentralized authentication and routing. A self-owned identifier in a blockchain network is a unique identifier that is owned and controlled by an individual entity on the blockchain, as contrasted with an entity controlled by a centralized authority (e.g., the service provider system 2902). The decentralized identity referenced by a decentralized identifier gives an entity control over what data can be accessed, stored, modified, and so forth by other entities, such as the service provider system 2902.

The node 2916, as representative of one of a plurality of decentralized nodes (e.g., decentralized web nodes), supports data storage and relays that allows entities, service provider systems, individuals, organizations and so forth to send, store, and receive encrypted or public messages and data. The node 2916 is universally addressable and is “crawlable” using data addressing in relation to the decentralized identifiers. The node 2916 is also configured to support decentralized replication of data across the nodes that is consistent across multiple nodes over time through continued data communication between the nodes in the decentralized platform. The node 2916 is configurable to support secure encryption through use of a cryptographic key associated with an individual's decentralized identifier and support semantic discovery to discover different forms of published data.

Verifiable credentials are an open standard for digital credentials, and employ a data format for cryptographic presentation and verification of claims. A verifiable credential represents an indication of trust of a piece of information related to an entity. For example, a verifiable credential indicates that the issuer of the verifiable credential trusts the holder of the verifiable credential; the holder trusts a verifier of the verifiable credential; and that the verifier trusts the issuer. Verifiable credentials may be issued by anyone, about anything, and can be presented to and verified by everyone granted access to the verifiable credential. Accordingly, a user of the user device 2904 may be an issuer, a holder, and/or a verifier, as can the service provider system 2902.

In some examples, the user device 2904 may implement a wallet application 2912 configured to manage decentralized identifiers and/or verifiable credentials. For instance, the wallet application 2912 may provide a user interface for implementation of access controls to various data associated with the decentralized identifier by the service provider system 2902, to other user devices, and so forth. Additionally, the wallet application 2912 may be configured to provide functionality for resource transfers (e.g., cryptocurrency, fiat currency, etc.) with the service provider system 2902, other user devices, and the like, based on techniques described herein.

In some examples, the hardware wallet 2918 may store cryptocurrency assets in combination with the wallet application 2912 and the service provider system 2902. For instance, the hardware wallet 2918, the wallet application 2912, and the service provider system 2902 may each store a respective, different private key, where a transaction with the cryptocurrency assets is signed by at least two of the three private keys. The user interface provided by the wallet application 2912 may allow a user to request a transaction. The wallet application 2912 may then sign the transaction with the private key of the wallet application 2912, have either the hardware wallet 2918 or the service provider system 2902 use a second of the three private keys to sign the transaction, and then provide the transaction with two signatures to the public blockchain 2914 for processing.

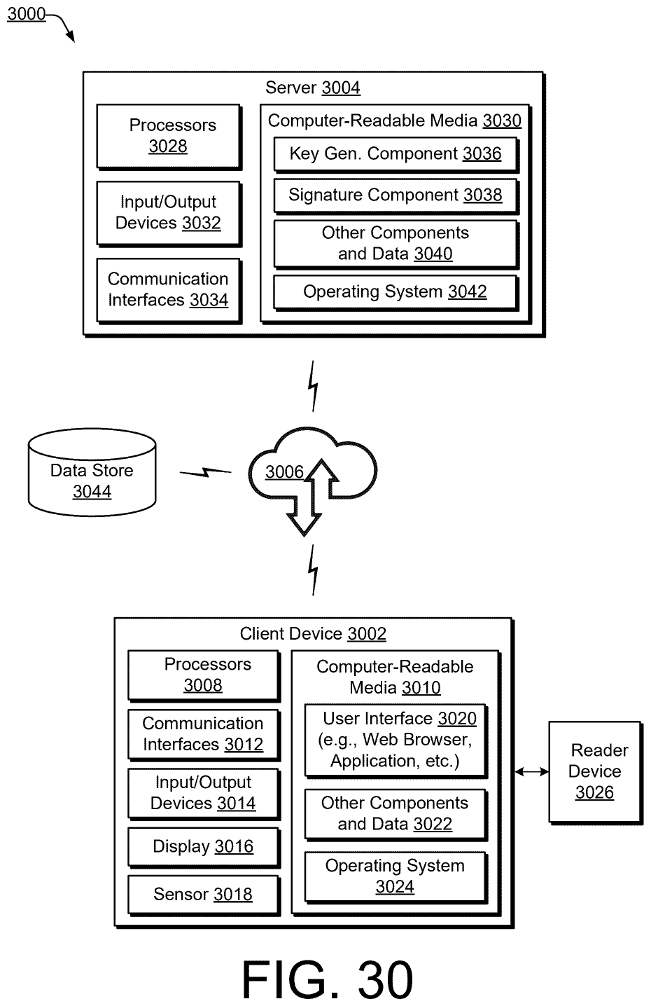

FIG. 30 depicts an illustrative block diagram illustrating a system 3000 for performing techniques described herein. The system 3000 includes a user device 3002, that communicates with server computing device(s) (e.g., server(s) 3004) via network(s) 3006 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 3002 is illustrated, in additional or alternate examples, the system 3000 can have multiple user devices, as described above with reference to FIG. 28.

In some examples, the client device 3002 and/or the server 3004 can include the of the first device 105, the second device 110, the third device 115, the mobile device 305, the server 330, the hardware wallet 340, the mobile device 505, the server 530, the hardware wallet 540, the server 615, the mobile device 630, the cloud backup 535, a mobile device with the app 705, the server 710, a mobile device with the app 805, the server 810, a mobile device with the app 905, the server 910, the WSM 915, a mobile device with the app 1005, the server 1010, the WSM 1015, a mobile device and/or application associated with the customer 1310, the server 1320, a mobile device with the app 1405, the server 1410, the WSM 1415, a mobile device with the app 1505, the server 1510, the WSM 1515, a mobile device and/or application associated with the customer 1910, the server 1920, a mobile device and/or application associated with the trusted contact 2030, the transaction management system that performs the process 2200, the transaction management system that performs the process 2300, the transaction management system that performs the process 2400, the transaction management system that performs the process 2500, the transaction management system that performs the process 2600, the transaction management system that performs the process 2700, or a combination thereof. The user interface 3020 can be associated with the user interface 310, the user interface 360, the user interface 510, the user interface 560, or any other user interface discussed herein.

In at least one example, the user device 3002 can be any suitable type of computing device, e.g., portable, semi-portable, semi-stationary, or stationary. Some examples of the user device 3002 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, a speaker device, an automobile or other vehicle type, an Internet of Things (IoT) device, etc. That is, the user device 3002 can be any computing device capable of sending communications and performing the functions according to the techniques described herein. The user device 3002 can include devices, e.g., payment card readers, or components capable of accepting payments, as described below. The user device 3002 may be representative of, and provide functionality for, the user devices 2806 described in relation to FIG. 28.

In the illustrated example, the user device 3002 includes one or more processors 3008, one or more computer-readable media 3010, one or more communication interface(s) 3012, one or more input/output (I/O) devices 3014, a display 3016, sensor(s) 3018, one or more encoders 3046, and one or more decoders 3048.

In at least one example, each processor 3008 can itself comprise one or more processors or processing cores. For example, the processor(s) 3008 can be implemented as one or more microprocessors, microcomputers, microcontrollers, digital signal processors, central processing units, state machines, logic circuitries, and/or any devices that manipulate signals based on operational instructions. In some examples, the processor(s) 3008 can be one or more hardware processors and/or logic circuits of any suitable type specifically programmed or configured to execute the algorithms and processes described herein. The processor(s) 3008 can be configured to fetch and execute computer-readable processor-executable instructions stored in the computer-readable media 3010.

Depending on the configuration of the user device 3002, the computer-readable media 3010 can be an example of tangible non-transitory computer storage media and can include volatile and nonvolatile memory and/or removable and non-removable media implemented in any type of technology for storage of information such as computer-readable processor-executable instructions, data structures, program components or other data. The computer-readable media 3010 can include, but is not limited to, RAM, ROM, EEPROM, flash memory, solid-state storage, magnetic disk storage, optical storage, and/or other computer-readable media technology. Further, in some examples, the user device 3002 can access external storage, such as RAID storage systems, storage arrays, network attached storage, storage area networks, cloud storage, or any other medium that can be used to store information and that can be accessed by the processor(s) 3008 directly or through another computing device or network. Accordingly, the computer-readable media 3010 can be computer storage media able to store instructions, components or components that can be executed by the processor(s) 3008. Further, when mentioned, non-transitory computer-readable media exclude media such as energy, carrier signals, electromagnetic waves, and signals per se.

The computer-readable media 3010 can be used to store and maintain any number of functional components that are executable by the processor(s) 3008. In some implementations, these functional components comprise instructions or programs that are executable by the processor(s) 3008 and that, when executed, implement operational logic for performing the actions and services attributed above to the user device 3002. Functional components stored in the computer-readable media 3010 can include a user interface 3020 to enable users to interact with the user device 3002, and thus the server(s) 3004 and/or other networked devices. In some examples, the user interface 3020 can include a UI associated with a mining application used to perform, control, and/or monitor the mining operations discussed herein, as performed using the mining ASIC(s) of the hashboard(s) discussed herein. In at least one example, a user can interact with the user interface via touch input, spoken input, gesture, or any other type of input. The word “input” is also used to describe “contextual” input that may not be directly provided by the user via the user interface 3020. For example, user's interactions with the user interface 3020 are analyzed using, e.g., natural language processing techniques, user movement tracking techniques, eye tracking techniques, etc. to determine context or intent of the user, which may be treated in a manner similar to “direct” user input.

Depending on the type of the user device 3002, the computer-readable media 3010 can also optionally include other functional components and data, such as other components and data 3022, which can include programs, drivers, etc., and the data used or generated by the functional components. In addition, the computer-readable media 3010 can also store data, data structures and the like, that are used by the functional components. Further, the user device 3002 can include many other logical, programmatic and physical components, of which those described are merely examples that are related to the discussion herein.

In at least one example, the computer-readable media 3010 can include additional functional components, such as an operating system 3024 for controlling and managing various functions of the user device 3002 and for enabling user interactions.

The communication interface(s) 3012 can include one or more interfaces and hardware components for enabling communication with various other devices, such as over the network(s) 3006 or directly. For example, communication interface(s) 3012 can enable communication through one or more network(s) 3006, which can include, but are not limited any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 3006 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

Embodiments of the disclosure may be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 3002 can further include one or more input/output (I/O) devices 3014. The I/O devices 3014 can include speakers, a microphone, a camera, and various user controls (e.g., buttons, a joystick, a keyboard, a keypad, etc.), a haptic output device, and so forth. The I/O devices 3014 can also include attachments that leverage the accessories (audio-jack, USB-C, Bluetooth, etc.) to connect with the user device 3002.

In at least one example, user device 3002 can include a display 3016. Depending on the type of computing device(s) used as the user device 3002, the display 3016 can employ any suitable display technology. For example, the display 3016 can be a liquid crystal display, a plasma display, a light emitting diode display, an OLED (organic light-emitting diode) display, an electronic paper display, or any other suitable type of display able to present digital content thereon. In at least one example, the display 3016 can be an augmented reality display, a virtual reality display, or any other display able to present and/or project digital content. In some examples, the display 3016 can have a touch sensor associated with the display 3016 to provide a touchscreen display configured to receive touch inputs for enabling interaction with a graphic interface presented on the display 3016. Accordingly, implementations herein are not limited to any particular display technology. In some examples, the user device 3002 may not include the display 3016, and information can be presented by other means, such as aurally, haptically, etc.

In addition, the user device 3002 can include sensor(s) 3018. The sensor(s) 3018 can include a global positioning system (“GPS”) device able to indicate location information. Further, the sensor(s) 3018 can include, but are not limited to, an accelerometer, gyroscope, compass, proximity sensor, camera, microphone, and/or a switch.

In some examples, the GPS device can be used to identify a location of a user. In at least one example, the location of the user can be used by the merchant platform 2810, the P2P platform 2812, and/or the media content platform 2814, described above, to provide one or more services. That is, in some examples, the service provider can implement geofencing to provide particular services to users by the merchant platform 2810, the P2P platform 2812, and/or the media content platform 2814.

In examples, the user device 3002 includes a codec system, which may comprise an encoder 3046 and/or a decoder 3048. The encoder 3046 is configured to encode a data stream or signal from an analog signal (e.g., an analog audio signal, an analog video signal, etc.) to a digital signal for transmission or storage. The decoder 3048 is configured to convert the digital signal back to an analog signal, such as for playback or editing. In some cases, the encoder 3046 may be configured to encode the data stream or analog signal in an encrypted format, and the decoder 3048 may accordingly be configured to decrypt the digital signal as part of the decoding process (e.g., using a cryptographic key). Additionally, in some examples, the encoder 3046 may compress data to reduce transmission bandwidth and/or storage space for the digital signal. One example of a compression codec system is a lossless codec, in which the digital data stream is a compressed format of the original data stream, but retains the information present in the original data stream. Another example of a compression codec system is a lossy codec which reduces the quality of the digital data stream but can increase the compression of the data stream relative to lossless codec systems. The codec system comprising the encoder 3046 and/or the decoder 3048 may be specialized to accomplish various different objectives, such as to preserve motion, preserve color, minimize latency, maintain fidelity, minimize bit-rate, optimize for different output device types, maintain synchronization of audio and video (e.g., using a metadata synchronization data stream), and so on. Although not explicitly illustrated in the example system 3000, the server 3004 may include an encoder 3046 and/or a decoder 3048 as well.

Additionally, the user device 3002 can include various other components that are not shown, examples of which include removable storage, a power source, such as a battery and power control unit, a barcode scanner, a printer, a cash drawer, and so forth.

In addition, as described in relation to FIG. 28, the user device 3002 can include, be connectable to, or otherwise be coupled to a reader device 3026, for reading payment instruments and/or identifiers associated with payment objects. The reader device 3026 can include a read head for reading a magnetic strip of a payment card, and further can include encryption technology for encrypting the information read from the magnetic strip. Additionally or alternatively, the reader device 3026 can be an EMV payment reader, which in some examples, can be embedded in the user device 3002. Moreover, numerous other types of readers can be employed with the user device 3002 herein, depending on the type and configuration of the user device 3002.

The reader device 3026 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data from various types of payment instruments. Accordingly, the reader device 3026 may include hardware implementation, such as slots, magnetic tracks, and rails with one or more sensors or electrical contacts to facilitate detection and acceptance of a payment instrument. That is, the reader device 3026 may include hardware implementations to enable the reader device 3026 to interact with a payment instrument via a swipe, a dip, or a tap to obtain payment data associated with a customer. Additionally or optionally, the reader device 3026 may also include a biometric sensor to receive and process biometric characteristics and process them as payment instruments, given that such biometric characteristics are registered with the payment service and connected to a financial account with a bank server. The reader device 3026 may include processing unit(s), computer-readable media, a reader chip, a transaction chip, a timer, a clock, a network interface, a power supply, and so on. That is, the reader device 3026 may include any of the computing components described herein with reference to the user device 3002 to implement the functionality provided by the reader device 3026.

In examples, the reader device 3026 includes a reader chip, which may perform functionality to control the power supply, among other functionality of the reader device 3026. The power supply may include one or more power supplies such as a physical connection to AC power or a battery. Power supply may include power conversion circuitry for converting AC power and generating a plurality of DC voltages for use by components of reader device 3026. When power supply includes a battery, the battery may be charged via a physical power connection, via inductive charging, or via any other suitable method.

The reader device 3026 may also include a transaction chip that may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. The transaction chip may encrypt the payment data upon receiving the payment data.

It should be understood that in some examples, the reader chip may have its own processing unit(s) and computer-readable media and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While the user device 3002, which can be a POS terminal, and the reader device 3026 are shown as separate devices, in additional or alternative examples, the user device 3002 and the reader device 3026 can be part of a single device, which may be a battery-operated device. In some examples, the reader device 3026 can have a display integrated therewith, which can be in addition to (or as an alternative of) the display 3016 associated with the user device 3002.

The server(s) 3004 can include one or more servers or other types of computing devices that can be embodied in any number of ways. For example, in the example of a server, the components, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 3004 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) 3004 can be located together or separately, and organized, for example, as virtual servers, server banks and/or server farms. The described functionality can be provided by the servers of a single merchant or enterprise, or can be provided by the servers and/or services of multiple different customers or enterprises.

In the illustrated example, the server(s) 3004 can include one or more processors 3028, one or more computer-readable media 3030, one or more I/O devices 3032, and one or more communication interfaces 3034. Each processor 3028 can be a single processing unit or a number of processing units, and can include single or multiple computing units or multiple processing cores. The processor(s) 3028 can be implemented as one or more microprocessors, microcomputers, microcontrollers, digital signal processors, central processing units, state machines, logic circuitries, and/or any devices that manipulate signals based on operational instructions. For example, the processor(s) 3028 can be one or more hardware processors and/or logic circuits of any suitable type specifically programmed or configured to execute the algorithms and processes described herein. The processor(s) 3028 can be configured to fetch and execute computer-readable instructions stored in the computer-readable media 3030, which can program the processor(s) 3028 to perform the functions described herein.

The computer-readable media 3030 can include volatile and nonvolatile memory and/or removable and non-removable media implemented in any type of technology for storage of information, such as computer-readable instructions, data structures, program components, or other data. Such computer-readable media 3030 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 3004, the computer-readable media 3030 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 3030 can be used to store any number of functional components that are executable by the processor(s) 3028. In many implementations, these functional components comprise instructions or programs that are executable by the processors 3028 and that, when executed, specifically configure the one or more processors 3028 to perform the actions attributed above to the merchant platform 2810, the P2P platform 2812, and/or the media content platform 2814. Functional components stored in the computer-readable media 3030 can optionally include a key generation component 3036, a signature component 3038, and one or more other components and data 3040. The computer-readable media 3030 can additionally include an operating system 3042 for controlling and managing various functions of the server(s) 3004.

The key generation component 3036 can manage aspect(s) of distributed key generation, for instance as in FIG. 1. The signature component 3038 can manage aspect(s) of partial signature generation (e.g., as in FIG. 2), partial signature aggregation (e.g., as in FIG. 2), and/or signing of transaction(s) using a signature aggregated from multiple partial signatures (e.g., as in FIG. 3).

The payment component can be configured to receive transaction data from POS systems. The payment component can transmit requests (e.g., authorization, capture, settlement, etc.) to payment service server computing device(s) to facilitate POS transactions between merchants and customers. The payment component can communicate the successes or failures of the POS transactions to the POS systems.

The training component can be configured to train models using machine-learning mechanisms, as well as retrain the models to improve outputs provided by the models based on feedback received over time. For example, a machine-learning mechanism can analyze training data to train a data model that generates an output, which can be a recommendation, a score, and/or another indication. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in a datastore associated with the user device(s) 3002 and/or the server(s) 3004 for use at a time after the data models have been trained (e.g., at runtime).

The one or more “components” referenced herein may be implemented as more components or as fewer components, and functions described for the components may be redistributed depending on the details of the implementation. The term “component,” as used herein, refers broadly to software stored on non-transitory storage medium (e.g., volatile or non-volatile memory for a computing device), hardware, or firmware (or any combination thereof) components. Modules are typically functional such that they may generate useful data or other output using specified input(s). A component may or may not be self-contained. An application program (also called an “application”) may include one or more components, or a component may include one or more application programs that can be accessed over a network or downloaded as software onto a device (e.g., executable code causing the device to perform an action). An application program (also called an “application”) may include one or more components, or a component may include one or more application programs. In additional and/or alternative examples, the component(s) may be implemented as computer-readable instructions, various data structures, and so forth via at least one processing unit to configure the computing device(s) described herein to execute instructions and to perform operations as described herein.

In some examples, a component may include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally or alternatively, in some examples, the service provider can utilize a SDK to integrate third-party service provider functionality into its applications. That is, API(s) and/or SDK(s) can enable third-party developers to customize how their respective third-party applications interact with the service provider or vice versa.

The communication interface(s) 3034 can include one or more interfaces and hardware components for enabling communication with various other devices, such as over the network(s) 3006 or directly. For example, communication interface(s) 3034 can enable communication through one or more network(s) 3006, which can include, but are not limited any type of network known in the art, as described herein.

The server(s) 3004 can further be equipped with various I/O devices 3032. Such I/O devices 3032 can include a display, various user interface controls (e.g., buttons, joystick, keyboard, mouse, touch screen, biometric or sensory input devices, etc.), audio speakers, connection ports and so forth.

In at least one example, the system 3000 can include a datastore 3044 that can be configured to store data that is accessible, manageable, and updatable. In some examples, the datastore 3044 can be integrated with the user device 3002 and/or the server(s) 3004. In other examples, as shown in FIG. 30, the datastore 3044 can be located remotely from the server(s) 3004 and can be accessible to the server(s) 3004. The datastore 3044 can comprise multiple databases and/or servers connected locally and/or remotely via the network(s) 3006. In at least one example, the datastore 3044 can store user profiles, which can include merchant profiles, customer profiles, artist profiles, and so on.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a stored balance of the merchant, such as a stored balance maintained in a ledger by the service provider.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, media content consumption data (e.g., number of streams of media content and by which artists, direct artist payouts, playlists generated or “favorited,” durations of listening and/or watching individual media content items, actions performed while consuming media content (e.g., skips, repeats, volume changes, etc.), locations at which media content is consumed, devices used to consume media content, activities during which media content is consumed, etc.), etc.

Artist profiles can store data including, but not limited to, artist information (e.g., artist's performance or stage name, band name, artist's legal name, record label, phone number, address, social media handles, website address, banking information, etc.), artist preferences (e.g., learned or artist-specified), media content (and/or associated data) at least partially attributed to the artist (e.g., songs, videos, artists in a same genre or having shared listeners, etc.), event data (e.g., tour dates, appearance dates, appointments, etc.), financial data (e.g., advance data, recoupment data, royalty data, payouts data, etc.), payroll data (e.g., employees, contractors, venues, payroll frequency, etc.), listening data (e.g., number of streams on media content platform(s), listening trends, etc.), fan data (number of followers on media content platform(s), number of followers on social media platform(s), etc.), reservations data (e.g., venue reservations, studio recording reservations, previous reservations, upcoming (scheduled) reservations, reservation duration, interactions associated with such reservations, etc.), inventory data (e.g., merchandise inventory), customer service data, and so forth.

Furthermore, in at least one example, the datastore 3044 can store inventory database(s) and/or catalog database(s). As described above, an inventory can store data associated with a quantity of each item that a merchant has available to the merchant. Furthermore, a catalog can store data associated with items that a merchant has available for acquisition. The datastore 3044 can store additional or alternative types of data as described herein.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and case of understanding. However, the methods illustrated are not limited to being performed using components described in the figures and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

The following clauses are provided as examples of the disclosure:

Clause 1. A computer-implemented method for secure transaction authorization based on multi-party computation (MPC), the computer-implemented method comprising: generating, at a server and using a server private key share corresponding to the server, a server partial signature associated with a transaction, wherein a plurality of private key shares includes the server private key share, wherein the plurality of private key shares each correspond to different devices of a plurality of devices, wherein the plurality of devices includes the server; receiving, from one or more additional devices of the plurality of devices, one or more additional partial signatures associated with the transaction, the one or more additional partial signatures having been generated using one or more additional private key shares of the plurality of private key shares; identifying that a total amount of partial signatures associated with the transaction is greater than or equal to a minimum threshold amount of partial signatures, wherein the total amount of partial signatures includes the server partial signature and the one or more additional partial signatures; aggregating the server partial signature and the one or more additional partial signatures to generate a signature associated with the transaction; and facilitating processing of the transaction using the signature and a distributed ledger.

Clause 2. The computer-implemented method of clause 1, further comprising: generating, through a multi-round interactive protocol for distributed key generation (DKG) that includes communications between the plurality of devices, a public key and the plurality of private key shares of a private key corresponding to the public key, wherein each device of the plurality of devices stores one of the plurality of private key shares without any of the plurality of devices having access to an entirety of the private key.

Clause 3. The computer-implemented method of any one of clauses 1 or 2, further comprising: causing the server private key share to be stored in encrypted form in a secure enclave of a mobile device of the one or more additional devices, wherein the mobile device stores an application private key share, and wherein the plurality of private key shares includes the application private key share.

Clause 4. A computer-implemented method comprising: generating, at a first device and using a first private key share corresponding to the first device, a first partial signature associated with a transaction, wherein a plurality of private key shares includes the first private key share, wherein the plurality of private key shares each correspond to different devices of a plurality of devices, wherein the plurality of devices includes the first device; receiving, from one or more additional devices of the plurality of devices, one or more additional partial signatures associated with the transaction, the one or more additional partial signatures having been generated using one or more additional private key shares of the plurality of private key shares; identifying that a total amount of partial signatures associated with the transaction is greater than or equal to a minimum threshold amount of partial signatures, wherein the total amount of partial signatures includes the first partial signature and the one or more additional partial signatures; aggregating the first partial signature and the one or more additional partial signatures to generate a signature associated with the transaction; and facilitating processing of the transaction using the signature and a distributed ledger.

Clause 5. The computer-implemented method of clause 4, further comprising: generating, through a multi-round interactive protocol for distributed key generation (DKG) that includes communications between the plurality of devices, a public key and the plurality of private key shares of a private key corresponding to the public key, wherein each device of the plurality of devices stores one of the plurality of private key shares without any of the plurality of devices having access to an entirety of the private key.

Clause 6. The computer-implemented method of any one of clauses 4 or 5, wherein the plurality of devices includes a mobile device and a server.

Clause 7. The computer-implemented method of any one of clauses 4 to 7, wherein the plurality of devices includes a mobile device, a server, and a hardware wallet device, wherein the one or more additional partial signatures include a hardware wallet partial signature generated by the hardware wallet device.

Clause 8. The computer-implemented method of any one of clauses 4 to 7, further comprising: setting the minimum threshold amount based on an input.

Clause 9. The computer-implemented method of any one of clauses 4 to 8, further comprising: causing the first private key share to be stored in encrypted form in a secure enclave of a second device of the one or more additional devices, wherein the second device stores a second private key share, and wherein the plurality of private key shares includes the second private key share.

Clause 10. The computer-implemented method of clause 9, wherein causing the first private key share to be stored in encrypted form in the secure enclave of the second device includes sending the first private key share from the first device to the second device.

Clause 11. The computer-implemented method of any one of clauses 9 to 10, wherein a combination of the first private key share and the second private key share is usable to authorize a transfer of an asset.

Clause 12. The computer-implemented method of clause 11, further comprising: receiving a request associated with decryption of the first private key share from the secure enclave; initiating a timer; and providing, to the second device, an interactive alert indicative of receipt of the request, wherein the interactive alert includes an option to cancel the request until the timer reaches a threshold time, wherein, in response to the timer reaching the threshold time, the second device is configured to decrypt the first private key share, to combine the first private key share and the second private key share to generate the combination, and to use the combination to authorize the transfer of the asset.

Clause 13. The computer-implemented method of any one of clauses 4 to 13, further comprising: storing the first private key share in the first device; and storing a second private key share in encrypted form in a secure enclave of the first device, wherein the second private key share is associated with a second device of the one or more additional devices, and wherein the plurality of private key shares includes the second private key share.

Clause 14. The computer-implemented method of clause 13, further comprising: receiving the second private key share at the first device from the second device, the second private key share having been generated by the second device.

Clause 15. The computer-implemented method of any one of clauses 13 to 14, further comprising: retrieving the second private key share from the secure enclave; combining the first private key share with the second private key share to generate a private key share combination; and using the private key share combination to authorize a transfer of an asset.

Clause 16. The computer-implemented method of clause 15, further comprising: receiving a request associated with decryption of the second private key share from the secure enclave; initiating a timer; and providing an interactive alert indicative of receipt of the request, wherein the interactive alert includes an option to cancel the request until the timer reaches a threshold time, wherein the second device is configured to decrypt the first private key share and combine the first private key share and the second private key share in response to the timer reaching the threshold time.

Clause 17. The computer-implemented method of any one of clauses 4 to 16, further comprising: assigning a vault status to an amount of an asset, wherein the amount of the asset is unusable in the transaction while the vault status is assigned to the amount of the asset and until the vault status is unassigned from the amount of the asset.

Clause 18. The computer-implemented method of clause 17, wherein facilitating the processing of the transaction includes using a second amount of the asset for the transaction, wherein the vault status is not assigned to the second amount of the asset.

Clause 19. The computer-implemented method of any one of clauses 17 to 18, further comprising: receiving a request to unassign the vault status from the amount of the asset; initiating a timer; providing an interactive alert indicative of receipt of the request to a mobile device, wherein the interactive alert includes an option to cancel the request until the timer reaches a threshold time; and unassigning the vault status from the amount of the asset in response to the timer reaching the threshold time.

Clause 20. A system comprising: at least one memory storing instructions; and at least one processor, wherein execution of the instructions by the at least one processor causes the at least one processor to: generate, at a first device and using a first private key share corresponding to the first device, a first partial signature associated with a transaction, wherein a plurality of private key shares includes the first private key share, wherein the plurality of private key shares each correspond to different devices of a plurality of devices, wherein the plurality of devices includes the first device; receive, from one or more additional devices of the plurality of devices, one or more additional partial signatures associated with the transaction, the one or more additional partial signatures having been generated using one or more additional private key shares of the plurality of private key shares; identify that a total amount of partial signatures associated with the transaction is greater than or equal to a minimum threshold amount of partial signatures, wherein the total amount of partial signatures includes the first partial signature and the one or more additional partial signatures; aggrege the first partial signature and the one or more additional partial signatures to generate a signature associated with the transaction; and facilitate processing of the transaction using the signature and a distributed ledger.

Clause 21. The system of clause 20, wherein the execution of the instructions by the at least one processor causes the at least one processor to perform operations according to any one of clauses 5 to 19.

Clause 22. A computer-implemented method for time-delayed secure recovery, further comprising: receiving, at a server and through a first communication channel, a request for initiation of a recovery procedure; initiating a timer that is scheduled to count from a request time to an end time, wherein the request time is associated with the request; providing, from the server and through a second communication channel, a communication indicative of the request and the end time, wherein the communication includes an interactive element that is configured to send a response to the communication to cancel the initiation of the recovery procedure; and initiating the recovery procedure based on the response not being received as of the end time.

Clause 23. The computer-implemented method of clause 22, wherein initiating the recovery procedure includes permitting a mobile device to decrypt an encrypted variant of a server private key share from a secure enclave of the mobile device, the server private key share having been generated by the server.

Clause 24. The computer-implemented method of any one of clauses 22 to 23, wherein initiating the recovery procedure includes permitting communication of an application private key share between a mobile device and a cloud backup system.

Clause 25. The computer-implemented method of any one of clauses 22 to 24, wherein initiating the recovery procedure includes facilitating derivation of a social recovery key based on a personal identification number (PIN) using an oblivious pseudorandom function (OPRF) and authenticating a token, wherein the token is based on data from a trusted contact device.

Clause 26. A computer-implemented method for time-delayed recovery, further comprising: initiating a timer that is scheduled to count from a request time to an end time, wherein the request time is associated with communication of a request for initiation of a recovery procedure; providing a notification indicative of the request and the end time, wherein the notification includes an interactive element that is configured to trigger sending of a response to cancel the initiation of the recovery procedure; and initiating the recovery procedure based on the response not being communicated as of the end time.

Clause 27. The computer-implemented method of clause 26, wherein initiating the recovery procedure includes permitting a first device to decrypt an encrypted variant of a second device private key share from a secure enclave of the first device, the second device private key share having been generated by a second device.

Clause 28. The computer-implemented method of any one of clauses 26 to 27, wherein initiating the recovery procedure includes decrypting an encrypted variant of a second device private key share from a secure enclave of a first device, the second device private key share having been generated by a second device.

Clause 29. The computer-implemented method of any one of clauses 26 to 28, wherein initiating the recovery procedure includes permitting communication of a first device private key share between a first device and a second device, the first device private key share having been generated by the first device.

Clause 30. The computer-implemented method of any one of clauses 26 to 29, wherein initiating the recovery procedure includes sending a first device private key share from a first device to a second device, the first device private key share having been generated by the first device.

Clause 31. The computer-implemented method of any one of clauses 26 to 30, wherein initiating the recovery procedure includes receiving a first device private key share at a first device and from a second device, the first device private key share associated with the first device.

Clause 32. The computer-implemented method of any one of clauses 26 to 31, wherein initiating the recovery procedure includes facilitating derivation of a social recovery key based on a personal identification number (PIN) using an oblivious pseudorandom function (OPRF) and authenticating a token, wherein the token is based on data from a trusted contact device.

Clause 33. The computer-implemented method of any one of clauses 26 to 32, wherein initiating the recovery procedure includes facilitating derivation of a social recovery key using a personal identification number (PIN) and based on an oblivious pseudorandom function (OPRF), sending the social recovery key to a device, receiving a seed and nonce from the device in response to a verification of the social recovery key by the device, derives a token and an encryption key based on the seed and the nonce, provides the token for authentication to a second device to receive a ciphertext and an integrity tag, and decrypts the ciphertext in response to verifying an integrity of the ciphertext using the integrity tag.

Clause 34. The computer-implemented method of any one of clauses 26 to 33, wherein the request for initiation of the recovery procedure is communicated through a first communication channel, and wherein the notification is communicated through a second communication channel that is different from the first communication channel.

Clause 35. The computer-implemented method of clause 34, wherein an email communication channel is one of the first communication channel or the second communication channel.

Clause 36. The computer-implemented method of any one of clauses 34 to 35, wherein a text message communication channel is one of the first communication channel or the second communication channel.

Clause 37. The computer-implemented method of any one of clauses 34 to 36, wherein an application communication channel associated with an application is one of the first communication channel or the second communication channel.

Clause 38. The computer-implemented method of any one of clauses 26 to 37, wherein the communication of the request includes receiving the request, and wherein providing the notification includes sending the notification.

Clause 39. The computer-implemented method of any one of clauses 26 to 38, wherein the communication of the request includes sending the request, and wherein providing the notification is responsive to receiving the notification.

Clause 40. The computer-implemented method of any one of clauses 26 to 39, wherein a duration of time between the request time and the end time is at least one day.

Clause 41. A system comprising: at least one memory storing instructions; and at least one processor, wherein execution of the instructions by the at least one processor causes the at least one processor to: initiate a timer that is scheduled to count from a request time to an end time, wherein the request time is associated with communication of a request for initiation of a recovery procedure; provide a notification indicative of the request and the end time, wherein the notification includes an interactive element that is configured to trigger sending of a response to cancel the initiation of the recovery procedure; and initiate the recovery procedure based on the response not being communicated as of the end time.

Clause 42. The system of clause 41, wherein the execution of the instructions by the at least one processor causes the at least one processor to perform operations according to any one of clauses 27 to 40.

Clause 43. A computer-implemented method for improved privacy in multi-party computation (MPC) system through blinded computations, the computer-implemented method comprising: receiving a first blinded data element, the first blinded data element generated through application of homomorphic encryption a data element; combining the first blinded data element with at least a second blinded data element to compute a blinded result; verifying a validity of the blinded result to verify a validity of the first blinded data element and the second blinded data element; and facilitating a transaction based on the validity of the blinded result.

Clause 44. The computer-implemented method of clause 43, wherein the first blinded data element is associated with a key, wherein the second blinded data element is a key tweak, wherein the key tweak is one of a Bitcoin Improvement Proposal 32 (BIP32) tweak or a Taproot tweak.

Clause 45. The computer-implemented method of any one of clauses 43 to 44, further comprising: receiving the second blinded data element, wherein the first blinded data element is a blinded nonce commitment, wherein the second blinded data element is a blinded challenge hash, and wherein the blinded result is a blinded signature.

Clause 46. The computer-implemented method of any one of clauses 43 to 45, wherein the first blinded data element is a first commitment associated with a first unspent transaction output (UTXO), wherein the second blinded data element is a second commitment associated with a second unspent transaction output (UTXO), and wherein the blinded result is associated with a total amount of assets without a vault status in a wallet.

Clause 47. A computer-implemented method comprising: receiving a first blinded data element; combining the first blinded data element with at least a second blinded data element to compute a blinded result; verifying a validity of the blinded result; and facilitating a transaction based on the validity of the blinded result.

Clause 48. The computer-implemented method of clause 47, wherein the first blinded data element is a variant of a data element that is encrypted using homomorphic encryption, wherein the second blinded data element is a variant of a second data element that is encrypted using homomorphic encryption.

Clause 49. The computer-implemented method of any one of clauses 47 to 48, wherein verifying the validity of the blinded result is configured to verify a validity of the first blinded data element and the second blinded data element.

Clause 50. The computer-implemented method of any one of clauses 47 to 49, further comprising: sending the blinded result to a device; and receiving a confirmation of the validity of the blinded result from the device based on the device unblinding the blinded result, wherein verifying the validity of the blinded result is based on the confirmation received from the device.

Clause 51. The computer-implemented method of any one of clauses 47 to 50, wherein the first blinded data element is associated with a key, wherein the second blinded data element is a key tweak, wherein the key tweak is one of a Bitcoin Improvement Proposal 32 (BIP32) tweak or a Taproot tweak.

Clause 52. The computer-implemented method of any one of clauses 47 to 51, further comprising: receiving the second blinded data element, wherein the first blinded data element is a blinded nonce commitment, wherein the second blinded data element is a blinded challenge hash, and wherein the blinded result is a blinded signature.

Clause 53. The computer-implemented method of clause 52, further comprising: sending a nonce commitment to a device, wherein the blinded nonce commitment is received from the device and is a blinded variant of the nonce commitment; sending the blinded signature to the device; and receiving a confirmation of the validity of the blinded signature from the device based on the device unblinding the blinded signature, wherein verifying the validity of the blinded result is based on the confirmation.

Clause 54. The computer-implemented method of any one of clauses 47 to 53, wherein the first blinded data element is a first commitment associated with a first unspent transaction output (UTXO), wherein the second blinded data element is a second commitment associated with a second UTXO, and wherein the blinded result is associated with a total amount of assets in a wallet.

Clause 55. The computer-implemented method of clause 54, wherein a transfer of at least one asset relative to the wallet corresponds to at least one of the first UTXO or the second UTXO, wherein the transfer is at least one of a deposit of the at least one asset into the wallet or a withdrawal of at least one asset from the wallet.

Clause 56. The computer-implemented method of any one of clauses 54 to 55, wherein a second transaction corresponds to at least one of the first UTXO or the second UTXO, wherein the transaction involves the wallet and at least one asset.

Clause 57. The computer-implemented method of any one of clauses 54 to 56, wherein the first UTXO and the second UTXO are associated with a Pay-to-Taproot (P2TR) UTXO set.

Clause 58. The computer-implemented method of any one of clauses 47 to 57, wherein the first blinded data element is a first commitment associated with a first unspent transaction output (UTXO), wherein the second blinded data element is a second commitment associated with a second UTXO, and wherein the blinded result is associated with a total amount of assets without a vault status in a wallet.

Clause 59. The computer-implemented method of clause 58, wherein an assignment of the vault status to at least one asset in the wallet corresponds to at least one of the first UTXO or the second UTXO.

Clause 60. The computer-implemented method of any one of clauses 58 to 59, wherein a removal of the vault status from at least one asset in the wallet corresponds to at least one of the first UTXO or the second UTXO.

Clause 61. The computer-implemented method of any one of clauses 47 to 60, wherein the first blinded data element is a first commitment associated with a first total amount of assets in a wallet before the transaction, wherein the second blinded data element is a second commitment associated with an amount of assets to be withdrawn from the wallet to conduct the transaction, and wherein the blinded result is associated with a second total amount of assets in the wallet after the transaction.

Clause 62. A system comprising: at least one memory storing instructions; and at least one processor, wherein execution of the instructions by the at least one processor causes the at least one processor to: receive a first blinded data element; combine the first blinded data element with at least a second blinded data element to compute a blinded result; verify a validity of the blinded result; and facilitate a transaction based on the validity of the blinded result.

Clause 63. The system of clause 62, wherein the execution of the instructions by the at least one processor causes the at least one processor to perform operations according to any one of clauses 48 to 61.

Clause 64. A computer-implemented method for secure key share rotation using multi-party computation (MPC), the computer-implemented method comprising: monitoring a status of first instances of a plurality of private key shares associated with a plurality of devices over time; identifying, based on a comparison of the status to a rule, a condition; and in response to identifying the condition, automatically generating, through a multi-round interactive protocol for distributed key generation (DKG) that includes communications between the plurality of devices, a public key and second instances of the plurality of private key shares of a private key corresponding to the public key, wherein each device of the plurality of devices stores one of the second instances of the plurality of private key shares without any of the plurality of devices having access to an entirety of the private key, and wherein the second instances of the plurality of private key shares are different from the first instances of the plurality of private key shares.

Clause 65. The computer-implemented method of clause 64, wherein the condition is associated with a timer reaching a threshold time, wherein the timer measures time since generation of the first instances of the plurality of private key shares.

Clause 66. The computer-implemented method of any one of clauses 64 to 65, wherein the condition is associated with at least one of the plurality of devices being updated or replaced.

Clause 67. The computer-implemented method of any one of clauses 64 to 66, wherein the condition is associated with a private key share recovery procedure.

Clause 68. A computer-implemented method comprising: monitoring a status of a first instance of a private key share of a plurality of private key shares, the plurality of private key shares associated with a plurality of devices, the plurality of private key shares being portions of a private key; identifying, based on a comparison of the status to a rule, a condition; and in response to identifying the condition, automatically generating a second instance of the private key share as part of refreshing the plurality of private key shares, wherein each device of the plurality of devices stores one of the plurality of private key shares without any of the plurality of devices having access to an entirety of the private key, and wherein the second instance of the private key share is different from the first instance of the private key share.

Clause 69. The computer-implemented method of clause 68, wherein generating the second instance of the private key share is based on a multi-round interactive protocol for distributed key generation (DKG) that includes communications between the plurality of devices.

Clause 70. The computer-implemented method of any one of clauses 68 to 69, wherein the condition is associated with a timer reaching a threshold time, wherein the timer measures time since generation of the first instance of the private key shares.

Clause 71. The computer-implemented method of clause 70, further comprising: receiving an input; and setting the threshold time based on the input.

Clause 72. The computer-implemented method of any one of clauses 68 to 71, wherein the condition is associated with at least one of the plurality of devices being updated.

Clause 73. The computer-implemented method of any one of clauses 68 to 72, wherein the condition is associated with at least one of the plurality of devices being replaced.

Clause 74. The computer-implemented method of any one of clauses 68 to 73, wherein the condition is associated with a private key share recovery procedure.

Clause 75. The computer-implemented method of any one of clauses 68 to 74, wherein the condition is associated with an indication that at least one of the plurality of private key shares is exposed or compromised.

Clause 76. The computer-implemented method of any one of clauses 68 to 75, wherein the first instance of the private key share is based on a multi-round interactive protocol for distributed key generation (DKG) that includes communications between the plurality of devices.

Clause 77. The computer-implemented method of any one of clauses 68 to 76, further comprising: generating a random value, wherein generating the second instance of the private key share is based on the random value.

Clause 78. The computer-implemented method of any one of clauses 68 to 77, further comprising: receiving a refresh package associated with a second private key share of the plurality of private key shares; and verifying the refresh package, wherein generating the second instance of the private key share is responsive to verification of the refresh package.

Clause 79. The computer-implemented method of any one of clauses 68 to 78, further comprising: updating a first verifiable secret sharing (VSS) commitment in response to generating the second instance of the private key share; receiving a second VSS commitment; and verifying that the second VSS commitment corresponds to the first VSS commitment.

Clause 80. The computer-implemented method of any one of clauses 68 to 79, further comprising: sending the second instance of the private key share to a backup device to back up the second instance of the private key share.

Clause 81. The computer-implemented method of any one of clauses 68 to 80, further comprising: invalidating the first instance of the private key share.

Clause 82. The computer-implemented method of any one of clauses 68 to 81, further comprising: causing the second instance of the private key share to be stored, in encrypted form, in a secure enclave.

Clause 83. A system comprising: at least one memory storing instructions; and at least one processor, wherein execution of the instructions by the at least one processor causes the at least one processor to: monitor a status of a first instance of a private key share of a plurality of private key shares, the plurality of private key shares associated with a plurality of devices, the plurality of private key shares being portions of a private key; identify, based on a comparison of the status to a rule, a condition; and in response to identifying the condition, automatically generate a second instance of the private key share as part of refreshing the plurality of private key shares, wherein each device of the plurality of devices stores one of the plurality of private key shares without any of the plurality of devices having access to an entirety of the private key, and wherein the second instance of the private key share is different from the first instance of the private key share.

Clause 84. The system of clause 83, wherein the execution of the instructions by the at least one processor causes the at least one processor to perform operations according to any one of clauses 69 to 82.

Clause 85. A computer-implemented method comprising: generating, through a multi-round interactive protocol for distributed key generation (DKG) that includes communications between N devices, a public key and N private key shares of a private key corresponding to the public key, wherein each device of the N devices stores one of the N private key shares without any of the N devices having access to an entirety of the private key; generating, at a first device of the N devices and using a first private key share of the N private key shares, a first partial signature associated with a transaction; receiving, from one or more devices of the N devices, one or more additional partial signatures associated with the transaction, the one or more additional partial signatures having been generated using one or more additional private key shares of the N private key shares, the one or more additional private key shares being distinct from the first private key share, wherein the first partial signature and the one or more additional partial signatures represent X partial signatures; identifying that T≤X≤N, wherein T is a minimum threshold number of partial signatures; aggregating the first partial signature and the one or more additional partial signatures to generate a signature associated with the transaction; and facilitate processing of the transaction using the signature and a distributed ledger.

Clause 86. The computer-implemented method of clause 85, wherein the N devices include a server, a mobile device, and a cryptocurrency wallet device.

Clause 87. The computer-implemented method of clause 86, wherein the first device is the server, and wherein the one or more devices include at least one of the mobile device or the cryptocurrency wallet device.

Clause 88. The computer-implemented method of any one of clauses 86 to 87, wherein the first device is the mobile device, and wherein the one or more devices include at least one of the server or the cryptocurrency wallet device.

Clause 89. The computer-implemented method of any one of clauses 86 to 88, wherein the first device is the cryptocurrency wallet device, and wherein the one or more devices include at least one of the server or the mobile device.

Clause 90. The computer-implemented method of any one of clauses 85 to 89, wherein T≤X<N.

Clause 91. The computer-implemented method of any one of clauses 85 to 90, wherein N=3 and wherein T=2.

Clause 92. The computer-implemented method of any one of clauses 85 to 91, wherein the X partial signatures include at least one Flexible Round-Optimized Schnorr Threshold (FROST) signature.

Clause 93. The computer-implemented method of any one of clauses 85 to 92, wherein the X partial signatures include at least one of a Scnorr signature or a Elliptic Curve Digital Signature Algorithm (ECDSA) signature.

Clause 94. The computer-implemented method of any one of clauses 85 to 93, wherein the distributed ledger is a blockchain ledger.

Clause 95. The computer-implemented method of any one of clauses 85 to 94, wherein the distributed ledger is associated with a Lightning network.

Clause 96. The computer-implemented method of any one of clauses 85 to 95, further comprising: assigning a vault status to an amount of an asset with a vault status, wherein the amount of the asset is unusable in the transaction while the vault status is assigned to the amount of the asset and until the vault status is unassigned from the amount of the asset.

Clause 97. The computer-implemented method of clause 96, wherein facilitating processing of the transaction includes using a second amount of the asset for the transaction, wherein the vault status is not assigned to the second amount of the asset.

Clause 98. The computer-implemented method of any one of clauses 96 to 97, further comprising: receiving a request to unassign the vault status from the amount of the asset; initiating a timer; providing an interactive alert indicative of receipt of the request to a mobile device, wherein the interactive alert includes an option to cancel the request until the timer reaches a threshold time; and unassigning the vault status from the amount of the asset in response to the timer reaching the threshold time.

Clause 99. The computer-implemented method of clause 98, wherein the mobile device is one of the N devices.

Clause 100. The computer-implemented method of any one of clauses 85 to 99, further comprising: receiving a request to initiate an emergency wallet recovery; initiating a timer; providing an interactive alert indicative of receipt of the request to a mobile device, wherein the interactive alert includes an option to cancel the request until the timer reaches a threshold time, wherein the mobile device is one of the N devices; and initiating the emergency wallet recovery in response to the timer reaching the threshold time.

Clause 101. The computer-implemented method of clause 100, wherein initiating the emergency wallet recovery includes decrypting an emergency access kit that includes the first private key share, wherein the first device is a server.

Clause 102. The computer-implemented method of any one of clauses 85 to 101, further comprising: receiving a processed personal identification number from a mobile device, the mobile device having processed a personal identification number using a homomorphic function to generate the processed personal identification number, wherein the mobile device is one of the N devices; combining the processed personal identification number with a second value to generate a combined value; and sending the combined value to the mobile device to use for an access control.

Clause 103. The computer-implemented method of clause 102, wherein the homomorphic function is an oblivious pseudorandom function (OPRF).

Clause 104. The computer-implemented method of any one of clauses 85 to 103, further comprising: performing a key rotation periodically based on a predetermined time interval, wherein performing a key rotation includes generating, through a new instance of the multi-round interactive protocol for DKG, a new public key and N new private key shares of a new private key corresponding to the new public key, wherein each device of the N devices stores one of the N new private key shares without any of the N devices having access to an entirety of the new private key.

Clause 105. The computer-implemented method of any one of clauses 85 to 104, further comprising: performing a key rotation in response to an indication of a transition condition, wherein performing a key rotation includes generating, through a new instance of the multi-round interactive protocol for DKG, a new public key and N new private key shares of a new private key corresponding to the new public key, wherein each device of the N devices stores one of the N new private key shares without any of the N devices having access to an entirety of the new private key, wherein the transition condition includes at least one of a transition from a first iteration of the first device to a second iteration of the first device, a transition from a first iteration of a second device of the one or more devices to a second iteration of the second device, an indication that the first device is inaccessible, an indication that the second device is inaccessible, or an indication that the first device and the second device are both inaccessible.

Clause 106. The computer-implemented method of any one of clauses 85 to 105, further comprising: storing, in a secure enclave of the first device, the first private key share and a second private key share, wherein the second private key share is associated with a second device of the one or more devices.

Clause 107. The computer-implemented method of clause 106, further comprising: retrieving the second private key share from the secure enclave of the first device in response to an indication that the second device has been lost, stolen, or disabled.

Clause 108. The computer-implemented method of any one of clauses 85 to 107, further comprising: causing a second device of the one or more devices to store, in a secure enclave of the second device, the first private key share and a second private key share, wherein the second private key share is associated with the second device.

Clause 109. The computer-implemented method of clause 108, further comprising: retrieving the first private key share from the secure enclave of the second device in response to an indication that the first device has been lost, stolen, or disabled.

Clause 110. The computer-implemented method of any one of clauses 85 to 109, further comprising: causing a second device of the one or more devices to store, at a cloud server associated with the second device, a second private key share that is associated with the second device.

Clause 111. The computer-implemented method of any one of clauses 85 to 110, further comprising: changing a quorum rule, wherein changing the quorum rule includes at least one of changing N, changing T, or changing at least one of the N devices.

Clause 112. A system, the system comprising: at least one memory; and at least one processor coupled to the at least one memory, the at least one processor configured to: generate, through a multi-round interactive protocol for distributed key generation (DKG) that includes communications between N devices, a public key and N private key shares of a private key corresponding to the public key, wherein each device of the N devices stores one of the N private key shares without any of the N devices having access to an entirety of the private key; generate, at a first device of the N devices and using a first private key share of the N private key shares, a first partial signature associated with a transaction; receive, from one or more devices of the N devices, one or more additional partial signatures associated with the transaction, the one or more additional partial signatures having been generated using one or more additional private key shares of the N private key shares, the one or more additional private key shares being distinct from the first private key share, wherein the first partial signature and the one or more additional partial signatures represent X partial signatures; identify that T≤X≤N, wherein T is a minimum threshold number of partial signatures; aggregate the first partial signature and the one or more additional partial signatures to generate a signature associated with the transaction; and facilitate processing of the transaction using the signature and a distributed ledger.

Clause 113. The system of clause 112, wherein the execution of the instructions by the at least one processor causes the at least one processor to perform operations according to any one of clauses 86 to 111.

Clause 114. A computer-implemented method comprising: receiving a request to initiate a wallet recovery procedure associated with an amount of an asset; initiating a timer; providing an interactive alert indicative of receipt of the request, wherein the interactive alert includes an option to cancel the request until the timer reaches a threshold time; and initiating the wallet recovery procedure in response to the timer reaching the threshold time.

Clause 115. The computer-implemented method of clause 114, wherein the wallet recovery procedure includes a mobile device retrieving a private key share from a cloud server.

Clause 116. The computer-implemented method of any one of clauses 114 to 115, wherein the wallet recovery procedure includes a cloud server retrieving a private key share from a mobile device.

Clause 117. The computer-implemented method of any one of clauses 114 to 116, wherein the wallet recovery procedure includes use of a dual oblivious pseudo-random function (D-OPRF) to decrypt a pre-signed transaction (PST) from a trusted contact device.

Clause 118. The computer-implemented method of any one of clauses 114 to 117, wherein the wallet recovery procedure includes retrieval of a first private key share from a hardware wallet device and a second private key share from a server.

Clause 119. The computer-implemented method of any one of clauses 114 to 118, wherein the wallet recovery procedure includes a personal identification number (PIN) update process.

Clause 120. The computer-implemented method of any one of clauses 114 to 119, wherein the wallet recovery procedure includes decryption of a server key share in a secure enclave of a mobile device and combination of the server key share with an app key share of the mobile device.

Clause 121. A system comprising: at least one memory storing instructions; and at least one processor, wherein execution of the instructions by the at least one processor causes the at least one processor to: receiving a request to initiate a wallet recovery procedure associated with an amount of an asset; initiate a timer; provide an interactive alert indicative of receipt of the request, wherein the interactive alert includes an option to cancel the request until the timer reaches a threshold time; and initiate the wallet recovery procedure in response to the timer reaching the threshold time.

Clause 122. The system of clause 121, wherein the execution of the instructions by the at least one processor causes the at least one processor to perform operations according to any one of clauses 115 to 120.

Clause 123. A non-transitory computer-readable medium having stored thereon instructions that, when executed by one or more processors, cause the one or more processors to perform operations according to any one of Clauses 1 to 122.

Clause 124. An apparatus comprising one or more means for performing operations according to any one of Clauses 1 to 122.

What is claimed is:

1. A computer-implemented method for secure transaction authorization based on multi-party computation (MPC), the computer-implemented method comprising:
generating, at a server and using a server private key share corresponding to the server, a server partial signature associated with a transaction, wherein a plurality of private key shares includes the server private key share, wherein the plurality of private key shares each correspond to different devices of a plurality of devices, wherein the plurality of devices includes the server;
receiving, from one or more additional devices of the plurality of devices, one or more additional partial signatures associated with the transaction, the one or more additional partial signatures having been generated using one or more additional private key shares of the plurality of private key shares;
identifying that a total amount of partial signatures associated with the transaction is greater than or equal to a minimum threshold amount of partial signatures, wherein the total amount of partial signatures includes the server partial signature and the one or more additional partial signatures;
aggregating the server partial signature and the one or more additional partial signatures to generate a signature associated with the transaction; and
facilitating processing of the transaction using the signature and a distributed ledger.

2. The computer-implemented method of claim 1, further comprising:
generating, through a multi-round interactive protocol for distributed key generation (DKG) that includes communications between the plurality of devices, a public key and the plurality of private key shares of a private key corresponding to the public key, wherein each device of the plurality of devices stores one of the plurality of private key shares without any of the plurality of devices having access to an entirety of the private key.

3. The computer-implemented method of claim 1, further comprising:
causing the server private key share to be stored in encrypted form in a secure enclave of a mobile device of the one or more additional devices, wherein the mobile device stores an application private key share, and wherein the plurality of private key shares includes the application private key share.

4. A computer-implemented method comprising:
generating, at a first device and using a first private key share corresponding to the first device, a first partial signature associated with a transaction, wherein a plurality of private key shares includes the first private key share, wherein the plurality of private key shares each correspond to different devices of a plurality of devices, wherein the plurality of devices includes the first device;
receiving, from one or more additional devices of the plurality of devices, one or more additional partial signatures associated with the transaction, the one or more additional partial signatures having been generated using one or more additional private key shares of the plurality of private key shares;
identifying that a total amount of partial signatures associated with the transaction is greater than or equal to a minimum threshold amount of partial signatures, wherein the total amount of partial signatures includes the first partial signature and the one or more additional partial signatures;
aggregating the first partial signature and the one or more additional partial signatures to generate a signature associated with the transaction; and
facilitating processing of the transaction using the signature and a distributed ledger.

5. The computer-implemented method of claim 4, further comprising:
generating, through a multi-round interactive protocol for distributed key generation (DKG) that includes communications between the plurality of devices, a public key and the plurality of private key shares of a private key corresponding to the public key, wherein each device of the plurality of devices stores one of the plurality of private key shares without any of the plurality of devices having access to an entirety of the private key.

6. The computer-implemented method of claim 4, wherein the plurality of devices includes a mobile device and a server.

7. The computer-implemented method of claim 4, wherein the plurality of devices includes a mobile device, a server, and a hardware wallet device, wherein the one or more additional partial signatures include a hardware wallet partial signature generated by the hardware wallet device.

8. The computer-implemented method of claim 4, further comprising:
setting the minimum threshold amount based on an input.

9. The computer-implemented method of claim 4, further comprising:
causing the first private key share to be stored in encrypted form in a secure enclave of a second device of the one or more additional devices, wherein the second device stores a second private key share, and wherein the plurality of private key shares includes the second private key share.

10. The computer-implemented method of claim 9, wherein causing the first private key share to be stored in encrypted form in the secure enclave of the second device includes sending the first private key share from the first device to the second device.

11. The computer-implemented method of claim 9, wherein a combination of the first private key share and the second private key share is usable to authorize a transfer of an asset.

12. The computer-implemented method of claim 11, further comprising:
receiving a request associated with decryption of the first private key share from the secure enclave;
initiating a timer; and
providing, to the second device, an interactive alert indicative of receipt of the request, wherein the interactive alert includes an option to cancel the request until the timer reaches a threshold time, wherein, in response to the timer reaching the threshold time, the second device is configured to decrypt the first private key share, to combine the first private key share and the second private key share to generate the combination, and to use the combination to authorize the transfer of the asset.

13. The computer-implemented method of claim 4, further comprising:
storing the first private key share in the first device; and
storing a second private key share in encrypted form in a secure enclave of the first device, wherein the second private key share is associated with a second device of the one or more additional devices, and wherein the plurality of private key shares includes the second private key share.

14. The computer-implemented method of claim 13, further comprising:
receiving the second private key share at the first device from the second device, the second private key share having been generated by the second device.

15. The computer-implemented method of claim 13, further comprising:
retrieving the second private key share from the secure enclave;
combining the first private key share with the second private key share to generate a private key share combination; and
using the private key share combination to authorize a transfer of an asset.

16. The computer-implemented method of claim 15, further comprising:
receiving a request associated with decryption of the second private key share from the secure enclave;
initiating a timer; and
providing an interactive alert indicative of receipt of the request, wherein the interactive alert includes an option to cancel the request until the timer reaches a threshold time, wherein the second device is configured to decrypt the first private key share and combine the first private key share and the second private key share in response to the timer reaching the threshold time.

17. The computer-implemented method of claim 4, further comprising:
assigning a vault status to an amount of an asset, wherein the amount of the asset is unusable in the transaction while the vault status is assigned to the amount of the asset and until the vault status is unassigned from the amount of the asset.

18. The computer-implemented method of claim 17, wherein facilitating the processing of the transaction includes using a second amount of the asset for the transaction, wherein the vault status is not assigned to the second amount of the asset.

19. The computer-implemented method of claim 17, further comprising:
receiving a request to unassign the vault status from the amount of the asset;
initiating a timer;
providing an interactive alert indicative of receipt of the request to a mobile device, wherein the interactive alert includes an option to cancel the request until the timer reaches a threshold time; and
unassigning the vault status from the amount of the asset in response to the timer reaching the threshold time.

20. A system comprising:
at least one memory storing instructions; and
at least one processor, wherein execution of the instructions by the at least one processor causes the at least one processor to:
generate, at a first device and using a first private key share corresponding to the first device, a first partial signature associated with a transaction, wherein a plurality of private key shares includes the first private key share, wherein the plurality of private key shares each correspond to different devices of a plurality of devices, wherein the plurality of devices includes the first device;
receive, from one or more additional devices of the plurality of devices, one or more additional partial signatures associated with the transaction, the one or more additional partial signatures having been generated using one or more additional private key shares of the plurality of private key shares;
identify that a total amount of partial signatures associated with the transaction is greater than or equal to a minimum threshold amount of partial signatures, wherein the total amount of partial signatures includes the first partial signature and the one or more additional partial signatures;
aggrege the first partial signature and the one or more additional partial signatures to generate a signature associated with the transaction; and
facilitate processing of the transaction using the signature and a distributed ledger.
